(19) United States
(12) Patent Application Publication
(10) Pub. No.: US 2005/0221210 A1
(43) Pub. Date: Oct. 6, 2005

(54) Electrophotographic photoconductor and image formation method, image formation apparatus, and process cartridge for image formation apparatus using the electrophotographic photoconductor

(76) Inventors: Tetsuro Suzuki, Shizuoka (JP); Hiroshi Tamura, Shizuoka (JP); Hiroshi Ikuno, Kanagawa (JP); Yoshiki Yanagawa, Shizuoka (JP); Kazukiyo Nagai, Shizuoka (JP); Hongguo Li, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/082,833

(22) Filed: Mar. 18, 2005

(30) Foreign Application Priority Data
Mar. 19, 2004 (JP) 2004-080851

(51) Int. Cl. G03G 5/147; G03G 5/047

(52) U.S. Cl. 430/58.15; 430/66; 430/132; 430/133; 430/130; 430/56

(57) ABSTRACT

An electrophotographic photoconductor having at least a photoconductive layer on an electrically conductive support, wherein a surface layer of the photoconductive layer is a crosslinked layer obtainable by curing at least a three or more-functional radical-polymerizable monomer having no charge transporting structure and a charge transportation compound having a radical-polymerizable functional group by using an acylphosphine oxide compound as a photo-polymerization initiator under light energy irradiation.

### BACKGROUND OF THE INVENTION

1. Field of the Invention

The present invention relates to an electrophotographic photoconductor which has high durability and can realize high quality image formation for a long period, using a photoconductive layer with high abrasive resistance, a smooth surface, and good electrical characteristics. Also, the present invention relates to an image formation method, an image formation apparatus and a process cartridge for image formation apparatus using the aforementioned photoconductor with high performance and a long operating life.

2. Description of the Related Art

Recently, an organic photoconductor (OPC) is frequently used in a copying machine, a facsimile machine, a laser printer, and a complex machine thereof, due to good performance and various advantages of it, instead of an inorganic photoconductor. As the reasons, for example, (1) excellent optical properties such as a wider wavelength range for light absorption and higher rate of absorption, (2) excellent electrical characteristics such as high photosensitivity and stable charging property, (3) a wide scope of material selection, (4) easier manufacturing, (5) lower cost, and (6) no toxicity can be listed.

On the other hand, recently, the attainment of high durability of a photoconductor has been desired for the miniaturization of a photoconductor promoted in accordance with the miniaturization of an image formation apparatus, the speeding up of a machine, and the tendency of maintenance-free. From this viewpoint, since a surface layer of the organic photoconductor is based on a low-molecular-weight charge transportation material and an inactive polymer, the organic photoconductor is generally soft, and, therefore, has a disadvantage of abrasion caused easily by mechanical load from a development system or a cleaning system, when the organic photoconductor is used repeatedly in an electrophotographic process. In addition, with the miniaturization of the particle diameters of toner particles for the requirement of attaining a high quality image, the increase of the rubber hardness and the contact pressure of a cleaning blade has to be made for improving a cleaning property, which increase is a factor of accelerating the abrasion of the photoconductor. Such abrasion of the photoconductor lowers the photosensitivity and degrades electric characteristics such as the charging property, so as to cause the lowering in image density and improper imaging such as background contamination. Also, the damage caused by local abrasion results in insufficient cleaning, and, therefore, leads to an image with stripe-like contamination. In the present circumstances, the operating life of the photoconductor and, therefore, the replacement of the photoconductor, are regulated by the abrasion and the damage.

Accordingly, it is necessary to reduce the aforementioned abrasion for attaining the high durability of an organic photoconductor and the solution of this problem is required in this technical field.

As techniques for improving abrasive resistance of a photoconductive layer, (1) the use of a curable binder in a surface layer (ex. see Japanese Laid-Open Patent Application No. 56-48637), (2) the use of a polymeric charge transportation material (ex. see Japanese Laid-Open Patent Application No. 64-1728), (3) dispersion of an inorganic filler in a surface layer (ex. see Japanese Laid-Open Patent Application No. 4-281461) can be provided. Among these techniques, (1) the use of a curable binder tends to reduce image density caused by the elevation of a residual electric potential due to a low compatibility with a charge transportation material and impurities such as a polymerization initiator and an unreacted residue. Also, (2) the use of a polymeric charge transportation material can improve abrasive resistance to some extent, but have not sufficiently satisfied durability required for an organic photoconductor. Further, since the polymerization and purification of the material for a polymeric charge transportation material are difficult, it is difficult to obtain a polymeric charge transportation material with high purity and the electric characteristics of the polymeric charge transportation material tends to be unstable. Moreover, a problem such that coating liquid for it has high viscosity in the manufacturing process may occur. (3) The dispersion of an inorganic filler contributes to high abrasive resistance compared to a photoconductor in which a normal lower-molecular-weight charge transportation material is dispersed in an inactive polymeric molecules but elevates a residual electric potential due to a trap existing on the surface of the inorganic filler and tends to reduce image density. Also, when the irregularity of the surface of a photoconductor containing an inorganic filler and a binder resin is large, improper cleaning occurs, which may cause toner filming or image deletion. These techniques denoted by (1), (2), and (3) have not satisfied sufficiently the overall durability that includes electric durability and mechanical durability required for an organic photoconductor. As a technique for improving the electric characteristics, abrasive resistance, and surface smoothness of a photoconductor, a technique of the use of a curable resin made from a polymerized monomer containing a charge transporting structure is known. As examples of the technique, a charge transportation layer formed from coating liquid that contains a monomer having a carbon-carbon double bond, a charge transportation material having a carbon-carbon double bond and a binder resin (ex. see Japanese Patent No. 3194392), and a photoconductive layer that contains a compound obtained by curing hole transportation compounds having more than one chain-polymerizable functional group in the molecule thereof (ex. see Japanese Laid-Open Patent Application No. 2000-66425) are provided. With respect to the former technique, since much of the binder resin is contained and a specifically used monomer having a carbon-carbon double bond is two-functional, the crosslink density of the charge transportation layer cannot be high and the drastically high abrasive resistance is not obtained. Also, for the latter example, a charge transportation layer obtained by the electron-beam curing of a hole transportation compound having a two-functional acryloyloxy group and a three-functional acrylic monomer is provided and, thereby, the improvement of the crosslink density of the layer can be expected. However, since the bulky hole transportation compound is fixed in the crosslinkage of the layer using plural bonds so as to cause large distortion, there are the problems of creating irregularities or a crack of the surface layer or film peeling easily. For avoiding these problems, the fine control of the material composition, the ratio of materials, and curing conditions is required. Accordingly, the freedom of the material and the conditions is limited and the stable production of the photoconductors having identical quality is difficult.

Also, as a technique for improving the slipping property, abrasive resistance, and damage resistance of a photoconductor with a photo-set protective layer, the use of photo-polymerization initiator having a morpholino group or a dialkylamino group is provided (ex. see Japanese Patent No. 3126889). The photo-polymerization initiator provides a high curing speed and a smooth cured film. However, when the photo-polymerization initiator is used for a charge transportation layer, the elevation of residual electric potential occurs in repeated use since it contains a tertiary amine structure substituted with an alkyl group in the structure thereof and the structure causes charge trap.

The conventional photoconductors having a crosslinked photoconductive layer in which a charge transporting structure is chemically bonded do not have sufficient overall characteristics in the present circumstances, and the employment of a photo-polymerization initiator for improving the curing property of a film causes degradation of the electric characteristics.

### SUMMARY OF THE INVENTION

One of the objects of the present invention is to provide an electrophotographic photoconductor which has high abrasive resistance, a surface with excellent smoothness, and a good electric characteristic, particularly a lower electric potential on a light-exposed portion thereof, and is stable for a long period.

Another object of the present invention is to provide an image formation method, an image formation apparatus and a process cartridge for image formation apparatus using the aforementioned photoconductor with high performance and a long operating life.

One of the objects of the present invention described above is achieved by an electrophotographic photoconductor having at least a photoconductive layer on an electrically conductive support, wherein a surface layer of the photoconductive layer is a crosslinked layer obtainable by curing at least a three or more-functional radical-polymerizable monomer having no charge transporting structure and a charge transportation compound having a radical-polymerizable functional group by using an acylphosphine oxide compound as a photo-polymerization initiator under light energy irradiation.

One of the objects of the present invention is achieved by an image formation method, wherein at least charging, image exposure, developing, and transcription are repeated using the electrophotographic photoconductor as described above.

One of the objects of the present invention is achieved by an image formation apparatus including the electrophotographic photoconductor as described above.

One of the objects of the present invention is achieved by a process cartridge for image formation apparatus attachable to and detachable from a body of an image formation apparatus, including the electrophotographic photoconductor as described above and at least one device selected from the group including a charging device, a development device, a transcription device, a cleaning device and a charge elimination device.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are cross-sectional diagrams illustrating two examples of an electrophotographic photoconductor according to the present invention;

FIGS. 2A and 2B are cross-sectional diagrams illustrating other examples of an electrophotographic photoconductor according to the present invention;

FIG. 3 is a schematic diagram illustrating an example of an image formation apparatus according to the present invention; and

FIG. 4 is a schematic diagram illustrating an example of a process cartridge for image formation apparatus according to the present invention.

### DETAILED DESCRIPTION OF THE PREFERRED EMBODIMENTS

The preferred embodiments [1] through [15] of the present invention are as follows.

[1] An electrophotographic photoconductor having at least a photoconductive layer on an electrically conductive support, wherein a surface layer of the photoconductive layer is a crosslinked layer obtainable by curing at least a three or more-functional radical-polymerizable monomer having no charge transporting structure and a charge transportation compound having a radical-polymerizable functional group by using an acylphosphine oxide compound as a photo-polymerization initiator under light energy irradiation.

[2] The electrophotographic photoconductor as described in [1] above, wherein a number of the radical-polymerizable functional group(s) of the charge transportation compound used for the surface layer is one.

[3] The electrophotographic photoconductor as described in [1] or [2] above, wherein each of the radical-polymerizable functional group(s) of the charge transportation compound used for the surface layer is an acryloyloxy group or a methacryloyloxy group.

[4] The electrophotographic photoconductor as described in any of [1] through [3] above, wherein functional groups of the three or more-functional radical-polymerizable monomer having no charge transporting structure used for the surface layer are an acryloyloxy group(s) and/or a methacryloyloxy group(s).

[5] The electrophotographic photoconductor as described in any of [1] through [4] above, wherein a ratio of a molecular weight to a functional group number (molecular weight/functional group number) for the three or more-functional radical-polymerizable monomer having no charge transporting structure used for the surface layer is equal to or less than 250.

[6] The electrophotographic photoconductor as described in any of [1] through [5] above, wherein a charge transporting structure of the charge transportation compound having a radical-polymerizable functional group used for the surface layer is a triarylamine structure.

[7] The electrophotographic photoconductor as described in any of [1] through [6] above, wherein the charge transportation compound(s) having a radical-polymerizable functional group used for the surface layer is/are at least one of compounds represented by general formula (1) 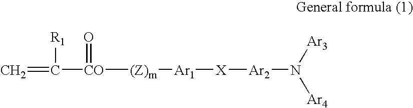
and general formula (2) 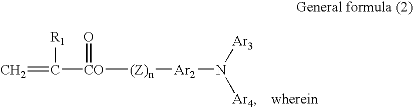
R₁ is a hydrogen atom, a halogen atom, an alkyl group which may have a substituent, an aralkyl group which may have a substituent, an aryl group which may have a substituent, a cyano group, a nitro group, an alkoxy group, —COOR₇, a carbonyl halide group, or CONR₈R₉,
R₇ is a hydrogen atom, an alkyl group which may have a substituent, an aralkyl group which may have a substituent, or an aryl group which may have a substituent,
each of R₈ and R₉ is a hydrogen atom, a halogen atom, an alkyl group which may have a substituent, an aralkyl group which may have a substituent, or an aryl group which may have a substituent, which may be identical to or different from each other,
each of Ar₁ and Ar₂ is a substituted or non-substituted arylene group, which may be identical to or different from each other,
each of Ar₃ and Ar₄ is a substituted or non-substituted aryl group, which may be identical to or different from each other,
X is a single bond, a substituted or non-substituted alkylene group, a substituted or non-substituted cycloalkylene group, a substituted or non-substituted alkylene ether group, an oxygen atom, a sulfur atom, or a vinylene group,
Z is a substituted or non-substituted alkylene group, a substituted or non-substituted alkylene ether group, or an alkyleneoxycarbonyl group, and
each of m and n is an integer of 0 through 3.

[8] The electrophotographic photoconductor as described in any of [1] through [7] above, wherein the charge transportation compound(s) having a radical-polymerizable functional group used for the surface layer is/are at least one of compounds represented by general formula (3) 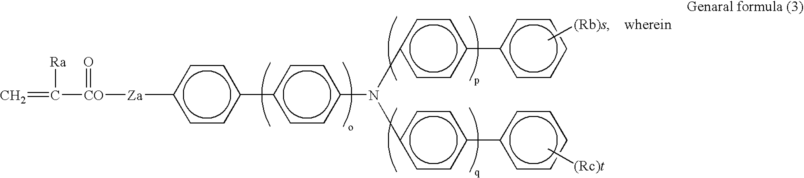
each of o, p, and q is an integer of 0 or 1,
Ra is a hydrogen atom or a methyl group,
each of Rb and Rc is a alkyl group in which the number of carbons is 1 through 6, where if the number of Rb or Rc is a plural number, the plural Rbs or Rcs may be different from each other,
each of s and t is an integer of 0 through 3, and
Za is a single bond, a methylene group, an ethylene group,

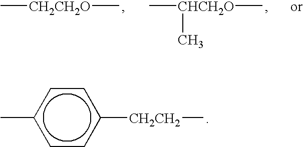

[9] The electrophotographic photoconductor as described in any of [1] through [8] above, wherein the acylphosphine oxide compound used for the surface layer is a compound represented by the following formula (P-1)

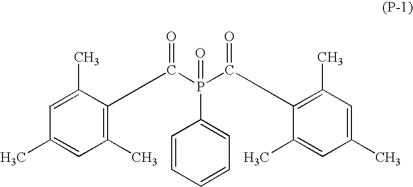

[10] The electrophotographic photoconductor as described in any of [1] through [8] above, wherein the acylphosphine oxide compound used for the surface layer is a compound represented by the following formula (P-2)

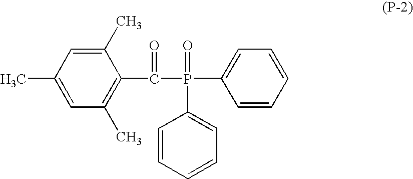

[11] The electrophotographic photoconductor as described in any of [1] through [8] above, wherein the acylphosphine oxide compound used for the surface layer is a compound represented by the following formula (P-3)

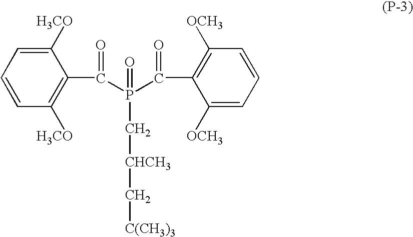

[12] The electrophotographic photoconductor as described in any of [1] through [11] above, wherein the photoconductive layer has a structure such that a charge generation layer, a charge transportation layer, and the charge transporting crosslinked surface layer are stacked in order from the side of an electrically conductive support.

[13] An image formation method, wherein at least charging, image exposure, developing, and transcription are repeated using the electrophotographic photoconductor as described in any of [1] through [12] above.

[14] An image formation apparatus comprising the electrophotographic photoconductor as described in any of [1] through [12] above.

[15] A process cartridge for image formation apparatus attachable to and detachable from a body of an image formation apparatus, comprising the electrophotographic photoconductor as described in any of [1] through [12] above and at least one device selected from the group consisting of a charging device, a development device, a transcription device, a cleaning device and a charge elimination device.

Then, an electrophotographic photoconductor which has a surface with excellent smoothness, an excellent electric characteristic, high abrasive resistance, and a long operating life can be obtained by providing a crosslinked surface layer obtainable by curing at least a three or more-functional radical-polymerizable monomer having no charge transporting structure and a charge transportation compound having a radical-polymerizable functional group by using an acylphosphine oxide compound as a photo-polymerization initiator under light energy irradiation. Also, an image formation method, an image formation apparatus and a process cartridge for image formation apparatus, with high reliability and high performance, which can constantly provide a good image for a long period, can be provided by using the photoconductor as described above.

It is considered that the effect of the present invention is based on a principle described below.

According to the present invention, a three-dimensional network structure can be also improved by the three or more-functional radical-polymerizable monomer, so that a highly hard surface layer with significantly high crosslink density can be obtained. Thus, the high abrasive resistance can be attained. On the other hand, when only a one or two-functional radical-polymerizable monomer(s) is/are employed, fewer crosslinkage in a crosslinked surface layer is made and, therefore, drastic improvement of the abrasive resistance is not attained. Furthermore, when much polymer material is contained in the crosslinked surface layer, the improvement of the three-dimensional network structure is disturbed or fewer crosslinkage in a crosslinked surface layer is made, so that sufficient abrasive resistance cannot be obtained in contrast to the present invention. Also, since the compatibility of the contained polymer material with a cured material produced by a reaction of a radical-polymerizable composition (a radical-polymerizable monomer and a charge transportation compound having a radical-polymerizable functional group) is low, the degradation of surface smoothness and local abrasion and damage easily occurs due to phase separation. In the present invention, for forming the top surface layer, the charge transportation compound having a radical-polymerizable functional group as well as three or more-functional radical-polymerizable monomer are used and the charge transportation compound is incorporated into a crosslinkage at the time of curing of the three or more-functional radical-polymerizable monomers. On the other hand, when a lower-molecular-weight charge transportation material having no functional group is contained in the crosslinked surface layer, the precipitation of the low-molecular-weight charge transportation material or white turbidity occurs due to the low compatibility and the mechanical strength of the crosslinked surface layer lowers.

Furthermore, a photoconductor according to the present invention has good electric characteristic and, therefore, the attainment of high quality image for a long period can be realized. This is caused by fixing the employed charge transportation compound having a radical-polymerizable functional group in the crosslinkage. However, the use of the charge transportation material having no functional group as described above causes the precipitation or white turbidity, and, therefore, the degradation of the photosensitivity or the elevation of the residual electric potential occurs. Then, the lowering in image density or background contamination of an output image is observed.

Also, the surface smoothness can be improved and the electric potential at a light-exposed portion can be stabilized to be low for a long period by using an acylphosphine oxide compound as a polymerization initiator at the time of photo-setting the three or more-functional radical polymerizable monomer having no charge transporting structure and the charge transportation compound having a radical-polymerizable functional group in the present invention. The reason is considered as follows. Since the charge transportation compound having a radical-polymerizable functional group is contained as a component for forming the crosslinked surface layer, the quantity of absorbed light in the case of using a photo-polymerization initiator is drastically reduced due to the absorption of the charge transportation site of the charge transportation compound and, accordingly, the quantity of generated radicals is also reduced. Therefore, since the irradiation of light with high intensity for a ling period of time is needed at the time of curing the surface layer, the decomposition of the charge transportation site and the degradation of characteristics are caused. Also, it is possible to increase the content of the photo-polymerization initiator for increasing the quantity of generated radicals. However, the content of the radical-polymerizable monomer and/or the charge transportaion compound in the crosslinked surface layer is substantially redueced and the degradation of the abrasive resistance and the elevation of the residual electric potential are caused. On the other hand, since an acylphosphine oxide compound absorbs light in a visible region equal to or longer than 400 nm, it absorbs light transmitting through the charge transportation compound having a radical-polymerizable functional group and generates radicals. Also, since the acylphosphine oxide compound may be decomposed to absorb no light according to light bleaching effect, it is excellent in internal curing of the photoconductive layer. Accordingly, curing is promoted uniformly and instantaneously along a direction in a film surface and a film thickness direction without the influence of the ununiformity of light irradiation along a direction in the surface and the ununiformity of light transmission through the inside of a film. Therefore, no irregularity caused by the difference of hardness or volume contraction between a cured portion and an uncured portion is created and a corsslinked film with excellent smoothness can be obtained. Also, the reason for causing no degradation of the electric characteristics such as the elevation of residual electric potential is that a tertiary amino group such as a dialkylamino group and a morpholino group, used as a structure for enhancing the radical generation of a photo-polymerization initiator, is not contained. Additionally, it is also considered that since the decomposition of the acylphosphine oxide compound causes no light absorption thereof, the decomposition occurs even in a film and it is incorporated in a ploymerized structure as an electrically inactive group.

Next, components of coating liquid for a surface layer used in the present invention are described below.

A three or more-functional radical-polymerizable monomer having no charge transporting structure used for the present invention is a monomer having neither a hole transporting structure such as triarylamine, hydrazone, pyrazoline, and carbazole nor an electron transporting structure such as a condensed polycyclic quinone, diphenoquinone, and an electron-withdrawing aromatic ring with a cyano group or a nitro group, and having three or more radical-polymerizable functional groups. The radical-polymerizable functional group is not particularly limited if the radical-polymerizable functional group has a carbon-carbon double bond and is a radical-polymerizable group.

As the radical-porymerizable functional group, for example, a 1-substituted ethylene functional group and a 1,1-substituted ethylene functional group described below are provided.

(1) As the 1-substituted ethylene functional group, for example, a functional group represented by the following formula 10:
CH₂═CH—X₁— formula 10
can be provided. In formula 10, X₁ is an arylene group such as phenylene group and naphthylene group which may have a substituent, an alkenylene group which may have a substituent, —CO— group, —COO— group, —CON(R₁₀)— group, or —S— group, wherein R₁₀ is hydrogen, an alkyl group such as methyl group and ethyl group, an aralkyl group such as benzyl group, naphthylmethyl group, and phenethyl group, and an aryl group such as phenyl group and naphthyl group.

As specific examples of these substituents, vinyl group, styryl group, 2-methyl-1,3-butadienyl group, vinylcarbonyl group, acryloyloxy group, acryloylamide group, and vinylthioethr group can be provided.

(2) As the 1,1-substituted ethylene functional group, for example, a functional group represented by the following formula 11:
CH₂═C(Y)—X₂— formula 11
can be provided.

In formula 11, Y is an alkyl group which may have a substituent, an aralkyl group which may have a substituent, an aryl group such as phenyl group and naphthyl group which may have a substituent, a halogen atom, cyano group, nitro group, an alkoxy group such as methoxy group and ethoxy group, —COOR₁₁ group, or —CONR₁₂R₁₃, wherein R₁₁ is a hydrogen atom, an alkyl group such as methyl group and ethyl group which may have a substituent, an aralkyl group such as benzyl group and phenethyl group which may have a substituent or an aryl group such as phenyl group and naphthyl group which may have a substituent, each of R₁₂ and R₁₃ is an hydrogen atom, an alkyl group such as methyl group and ethyl group which may have a substituent, an aralkyl group such as benzyl group, naphthylmethyl group, and phenethyl group which may have a substituent, or an aryl group such as phenyl group and naphthyl group which may have a substituent, and R₁₂ and R₁₃ may be identical to or different from each other. Also, X₂ is the same substitutent as X₁ in formula 10, a single bond, or an alkylene group. Herein, at least one of Y and X₂ is oxycarbonyl group, cyano group, an alkenylene group or an aromatic ring.

As specific examples of these substituents, α-acryloyloxy chloride group, methacryloyloxy group, α-cyanoethylene group, α-cyanoacryloyloxy group, α-cyanophenylene group, and methacryloylamino group can be provided.

Herein, as a substituent for substituting these substituents X₁, X₂, and Y, for example, a halogen atom, nitro group, cyano group, an alkyl group such as methyl group and ethyl group, an alkoxy group such as methoxy group and ethoxy group, an aryloxy group such as phenoxy group, an aryl group such as phenyl group and naphthyl group, and an aralkyl group such as benzyl group and phenethyl group can be provided.

Among these radical-polymerizable functional groups, particularly, acryloyloxy group and methacryloyloxy group are useful, and a compound having three or more acryloyloxy groups can be obtained, for example, by esterification reaction or transesterification reaction using a compound having three or more hydroxyl groups in the molecule thereof and an acrylic acid, an acrylate salt, an acryloyl halide, or an acrylate ester. Also, a compound having three or more methacryloyloxy groups can be similarly obtained. Additionally, radical-porymerizable functional groups in a monomer having three or more radical-porymerizable functional group may be identical to or different from each other.

As a three or more-functional radical-porymerizable monomer having no charge transporting structure, the following compounds are provided as examples but the monomer is not limited to these compounds. That is, as the aforementioned radical-porymerizable monomer used for the present invention, for example, trimethylolpropane triacrylate (TMPTA), trimethylolpropane trimethacrylate, trimethylolpropane alkylene-modified triacrylate, trimethylolpropane ethyleneoxy-modified (referred to as “EO-modified” below) triacrylate, trimethylolpropane propyleneoxy-modified (referred to as “PO-modified” below) triacrylate, trimethylolpropane caprolactone-modified triacrylate, trimethylolpropane alkylene-modified trimethacrylate, penta-erythritol triacrylate, penta-erythritol tetraacrylate (PETTA), glycerol triacrylate, glycerol epichlorohydrin-modified (referred to as “ECH-modified” below) triacrylate, glycerol EO-modified triacrylate, glycerol PO-modified triacrylate, tris(acryloxyethyl)isocyanurate, di-penta-erythritol hexaacrylate (DPHA), di-penta-erythritol caprolactone-modified hexaacrylate, di-penta-erythritol hydroxypentaacrylate, alkylated di-penta-erythritol pentaacrylate, alkylated di-penta-erythritol tetraacrylate, alkylated di-penta-erythritol triacrylate, dimethylolpropane tetraacrylate (DTMPTA), penta-erythritol ethoxytetraacrylate, phosphoric acid EO-modified triacrylate, and 2,2,5,5-tetrahydroxymethylcyclopentanone tetraacrylate, etc. can be provided and these compounds can be used singularly or in combination.

Also, it is desired that the ratio of a molecular weight to the number of a functional group (molecular weight/number of functional groups) in the three or more-functional radical-porymerizable monomer having no charge transporting structure used for the present invention is equal to or less than 250, in order to form a dense crosslinkage in the crosslinked surface layer. Herein, if the ratio is greater than 250, the crosslinked surface layer is soft and the abrasive resistance slightly degrades. Therefore, for the monomer having an EO-, PO-, caprolactone-modified group or the like among the aforementioned monomers, it is not preferable to use the monomer having an extremely long modified group singularly. Also, the content of the three or more-functional radical-porymerizable monomer component having no charge transporting structure used for the surface layer in a solid content of coating liquid is adjusted so that the content of it is 20-80% by weight, preferably 30-70% by weight, of the total weight of the crosslinked surface layer. When the content of the monomer component is less than 20% by weight, the density of a three dimensional crosslinkage in the crosslinked surface layer is low and the drastic improvement of the abrasive resistance may not be attained compared to the case of using a conventional thermoplastic binder resin. Also, When the content of the monomer component is greater than 80% by weight, the content of the charge transportation compound is low and the degradation of the electrostatic characteristics occurs. Although required abrasive resistance and electrostatic characteristics depend on a used process, the content is most preferably in a range of 30-70% by weight, in view of the balance of the abrasive resistance and the electrostatic characteristics.

The charge transportation compound having a radical-polymerizable functional group used for the present invention is a compound having a hole transporting structure such as triarylamine, hydrazone, pyrazoline, and carbazole or an electron transporting structure such as condensed polycyclic quinone, diphenoquinone, and an electron-withdrawing aromatic ring with a cyano group or a nitro group, and having a radical-polymerizable functional group. As this radical-polymerizable functional group, the radical-polymerizable functional group described above can be provided and, particularly, acryloyloxy group and methacryloyloxy group are useful. The number of radical-polymeizable functional group(s) is one or plural but the number of radical-polymeizable functional group(s) is preferably one in order to obtain a smooth surface by suppressing the internal stress of the crosslinked surface layer and to retain good electric characteristics. Although a crosslinked surface layer with good smoothness and good electric characteristics can be obtained using an acylphosphine oxide compound as a photo-polymerization initiator according to the present invention, when the charge transportation compound has two or more radical-polymerizable functional groups, large distortion may be caused by fixing a bulky hole transportation compound in the crosslinkage by plural bonds, and the creation of a crack or film peeling may occur due to the charge transporting structure and the number of functional group(s). Also, the large distortion does not stabilize an intermediate structure (cationic radical) of the charge transportation compound and the degradation of photosensitivity caused by charge trap and the elevation of residual electric potential easily occur. As a charge transporting structure of the charge transportation compound having a radical-polymerizable functional group, triarylamine structures is preferable from the viewpoint of high mobility and, among these, when a compound having a structure represented by general formula (1): 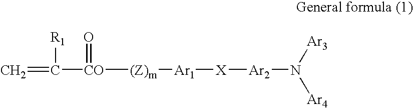
or general formula (2): 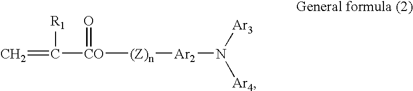
the electrostatic characteristics such as the photosensitivity and the residual electric potential are maintained well.

In general formulas (1) and (2), R₁ is a hydrogen atom, a halogen atom, an alkyl group which may have a substituent, an aralkyl group which may have a substituent, an aryl group which may have a substituent, cyano group, nitro group, an alkoxy group, —COOR₇, a carbonyl halide group, or —CONR₈R₉, wherein R₇ is a hydrogen atom, an alkyl group which may have a substituent, an aralkyl group which may have a substituent, or an aryl group which may have a substituent, each of R₈ and R₉ is a hydrogen atom, a halogen atom, an alkyl group which may have a substituent, an aralkyl group which may have a substituent, or an aryl group which may have a substituent, and R₈ and R₉ may be identical to or different from each other. Each of Ar₁ and Ar₂ is a substituted or non-substituted arylene group, and Ar₁ and Ar₂ may be identical to or different from each other. Each of Ar₃ and Ar₄ is a substituted or non-substituted aryl group, and Ar₃ and Ar₄ may be identical to or different from each other. X is a single bond, a substituted or non-substituted alkylene group, a substituted or non-substituted cycloalkylene group, a substituted or non-substituted alkylene ether group, oxygen atom, sulfur atom, or vinylene group. Z is a substituted or non-substituted alkylene group, a substituted or non-substituted alkylene ether group, or alkyleneoxycarbonyl group. Each of m and n is an integer of 0 through 3.

Specific examples of the substituents in general formulas (1) and (2) are shown below.

With respect to a substituent for R₁ in general formulas (1) and (2), for example, as the alkyl group, methyl group, ethyl group, propyl group, butyl group, etc. can be provided. As the aryl group, phenyl group and naphthyl group, etc. can be provided. As the aralkyl group, benzyl group, phenethyl group, naphthylmethyl group, etc. can be provided. As the alkoxy group, methoxy group, ethoxy group, propoxy group, etc. can be provided. The substituents for R₁ may be further substituted with a halogen atom, nitro group, cyano group, an alkyl group such as methyl group and ethyl group, an alkoxy group such as methoxy group and ethoxy group, an aryloxy group such as phenoxy group, an aryl group such as phenyl group and naphthyl group, or an aralkyl group such as benzyl group and phenethyl group.

Among substituents R₁, a hydrogen atom and a methyl group are particularly preferable.

Ar₃ and Ar₄ are substituted or non-substituted aryl groups and, as the aryl group, a condensed polycyclic hydrocarbon group, a not-condensed cyclic hydrocarbon group, and a heterocyclic group can be provided.

As the condensed polycyclic hydrocarbon group, the number of carbons that form a ring thereof is preferably equal to or less than 18, and, for example, pentanyl group, indenyl group, naphthyl group, azulenyl group, heptalenyl group, biphenylenyl group, as(asym)-indacenyl group, s(sym)-indacenyl group, fluorenyl group, acenaphthylenyl group, pleiadenyl group, acenaphthenyl group, phenalenyl group, phenanthryl group, anthryl group, fluoranthenyl group, acephenanthrylenyl group, aceanthrylenyl group, triphenylenyl group, pyrenyl group, chrysenyl group, and naphthacenyl group can be provided.

As the not-condensed cyclic hydrocarbon group, monovalent groups of a monocyclic hydrocarbon compound such as benzene, diphenyl ether, poly(ethylene-diphenyl ether), diphenyl thioether, and diphenylsulfone, monovalent groups of a not-condensed polycyclic hydrocarbon compound such as biphenyl, polyphenyl, a diphenylalkane, a diphenylalkene, a diphenylalkyne, triphenylmethane, distyrylbenzene, a 1,1-diphenylcycloalkane, a polyphenylalkane, and a polyphenylalkene, and monovalent groups of a ring assembly hydrocarbon compound such as 9,9-diphenylfluorene can be provided.

As the heterocyclic group, monovalent groups of carbazole, dibenzofuran, dibenzothiophene, oxadiazole, and thiadiazole can be provided.

The aryl group represented by Ar₃ and Ar₄ may have a substituent, for example, as shown below.

(1) A halogen atom, cyano group, nitro group, etc.

(2) An alkyl group.

The alkyl group is preferably C₁-C₁₂, more preferably C₁-C₈, most preferably C₁-C₄ straight or branched alkyl group, and the alkyl group may have a fluorine atom, hydroxyl group, cyano group, a C₁-C₄ alkoxy group, phenyl group, or a phenyl group substituted with a halogen atom, a C₁-C₄ alkyl group, or a C₁-C₄ alkoxy group. Specifically, methyl group, ethyl group, n-butyl group, i-propyl group, t-butyl group, s-butyl group, n-propyl group, trifluoromethyl group, 2-hydroxyethyl group, 2-ethoxyethyl group, 2-cyanoethyl group, 2-methoxyethyl group, benzyl group, 4-chlorobenzyl group, 4-methylbenzyl group, and 4-phenylbenzyl group can be provided.

(3) An alkoxy groups (—OR₂),
wherein R₂ is an alkyl group defined in (2) above.

Specifically, methoxy group, ethoxy group, n-propoxy group, i-propoxy group, t-butoxy group, n-butoxy group, s-butoxy group, i-butoxy group, 2 -hydroxyethoxy group, benzyloxy group, and trifluoromethoxy group can be provided.

(4) An aryloxy group.

As the aryl group, phenyl group and naphthyl group can be provided. The aryloxy group may contain a C₁-C₄ alkoxy group, a C₁-C₄ alkyl group, or a halogen atom as a substituent. Specifically, phenoxy group, 1-naphthyloxy-group, 2-naphthyloxy group, 4-methoxyphenoxy group, and 4-methylphenoxy group can be provided.

(5) An alkylmercapto group or an arylmercapto group.

Specifically, methylthio group, ethylthio group, phenylthio group, and p-methylphenylthio group can be provided.

(6) A substituent represented by the following formula: 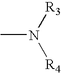
, wherein each of R₃ and R₄ is independently a hydrogen atom, an alkyl group defined in (2) above, or an aryl group. As the aryl group, for example, phenyl group, biphenyl group, and naphthyl group can be provided and the aryl group may contain a C₁-C₄ alkoxy group, a C₁-C₄ alkyl group, or a halogen atom as a substituent. R₃ and R₄ may collectively form a ring.

Specifically, amino group, diethylamino group, N-methyl-N-phenylamino group, N,N-diphenylamino group, N,N-di(tolyl)amino group, dibenzylamino group, piperidino group, morpholino group, and pyrrolidino group can be provided.

(7) An alkylenedioxy group and an alkylenedithio group such as methylenedioxy group and methylenedithio group can be provided.

(8) A substituted or non-substituted styryl group, a substituted or non-substituted β-phenylstyryl group, diphenylaminophenyl group, ditolylaminophenyl group, etc.

The arylene group represented by Ar₁ and Ar₂ are divalent groups derived from the aryl groups represented by Ar₃ and Ar₄.

X is a single bond, a substituted or non-substituted alkylene group, a substituted or non-substituted cycloalkylene group, a substituted or non-substituted alkylene ether group, an oxygen atom, a sulfur atom, or vinylene group.

The substituted or non-substituted alkylene group is C₁-C₁₂, preferably C₁-C₈, more preferably C₁-C₄ straight or branched alkylene group and, further, the alkylene group may have a fluorine atom, hydroxyl group, cyano group, a C₁-C₄ alkoxy group, a phenyl group, or a phenyl group substituted with a halogen atom, a C₁-C₄ alkyl group, or a C₁-C₄ alkoxy group. Specifically, methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-methoxyethylene group, benzylidene group, phenylethylene group, 4-chlorophenylethylene group, 4-methylphenylethylene group, and 4-biphenylethylene group can be provided.

The substituted or non-substituted cycloalkylene group is a C₅-C₇ cyclic alkylene group and the cyclic alkylene group may have a fluorine atom, hydroxyl group, a C₁-C₄ alkyl group, or a C₁-C₄ alkoxy group. Specifically, cyclohexylidene group, cyclohexylene group, and 3,3-dimethylcyclohexylidene group can be provided.

As the substituted or non-substituted alkylene ether group, an alkyleneoxy group such as ethyleneoxy group and propyleneoxy group, an alkylenedioxy group derived from ethylene glycol or propyleneglycol, and a di- or poly-(oxyalkylene)oxy group derived from diethylene glycol, tetraethylene glycol, or tripropylene glycol can be provided and an alkylene group of the alkylene ether group may have a substituent such as hydroxyl group, methyl group, or ethyl group.

As the vinylene group, a substituent represented by the following general formula 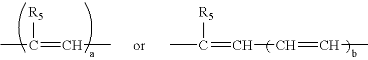
can be provided, wherein R₅ is hydrogen, an alkyl group (being the same alkyl group as that defined in (2) above), an aryl group (being the same aryl group as that represented by Ar₃ or Ar₄ above), a is 1 or 2, and b is 1 through 3.

Z is a substituted or non-substituted alkylene group, a substituted or non-substituted alkylene ether group, or alkyleneoxycarbonyl group.

As the substituted or non-substituted alkylene group, the alkylene group as X above can be provided.

As the substituted or non-substituted alkylene ether group, the alkylene ether group as X above can be provided.

As the alkyleneoxycarbonyl group, a caprolactone-modified divalent group can be provided.

Also, as the charge transportation compound having a radical-polymerizable functional group in the present invention, more preferably, a compound represented by general formula (3): 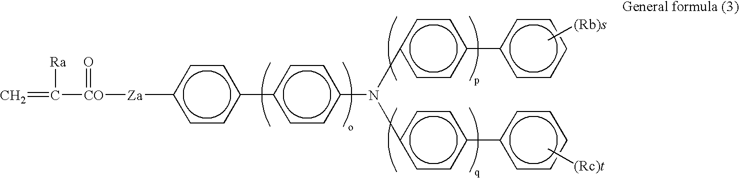
can be provide, wherein each of o, p, and q is an integer of 0 or 1, Ra is a hydrogen atom or a methyl group, each of Rb and Rc is a alkyl group in which the number of carbons is 1 through 6, where if the number of Rb or Rc is a plural number, the plural Rbs or Rcs may be different from each other, each of s and t is an integer of 0 through 3, and Za is a single bond, a methylene group, an ethylene group,

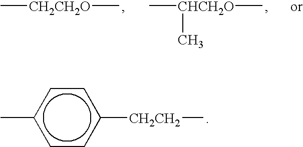

In the compound represented by general formula (3), a compound in which substituents Rb and Rc are independently methyl group or ethyl group is particularly preferable.

The charge transportation compound having a radical-polymerizable functional group represented by general formula (1), (2), or (3) (especially (3)) used for the present invention does not become a terminal structure and is incorporated in a chaining polymer since the carbon-carbon double bond opens toward both sides thereof for polymerization. In the crosslinked polymer by the polymerization with the three or more-functional radical-polymerizable monomer, the charge transportation compound having a radical-polymerizable functional group is incorporated in a main chain of the polymer or a crosslinking chain between main chains. Herein, the crosslinking chain includes an intermolecular crosslinking chain between a main chain of one polymer molecule and a main chain of another polymer molecule and an intramolecular crosslinking chain between the first portion of a main chain of a folded polymer molecule and the second portion of it, which is away from the first portion. Whether the charge transportation compound is incorporated in the main chain or the crosslinking chain, a triarylamine structure bonding to the chain has at least three aryl groups extending toward three radial directions from a nitrogen atom and is bulky but bonds to the chain indirectly via a carbonyl group, etc. Accordingly, the triarylamine structures are secured flexibly in regard to the configuration and can be located spatially adjacent to each other in moderation in the polymer, so that structural distortion of the molecule is low. Then, the polymer is used as a material for a surface layer of an electrophotographic photoconductor, it is considered that the molecular structure of the polymer can be comparatively free from breaking of a route for charge transportation.

Specific examples of the charge transportation compound having a radical-polymerizable functional group for the present invention are shown below but the compound is not limited to these examples.

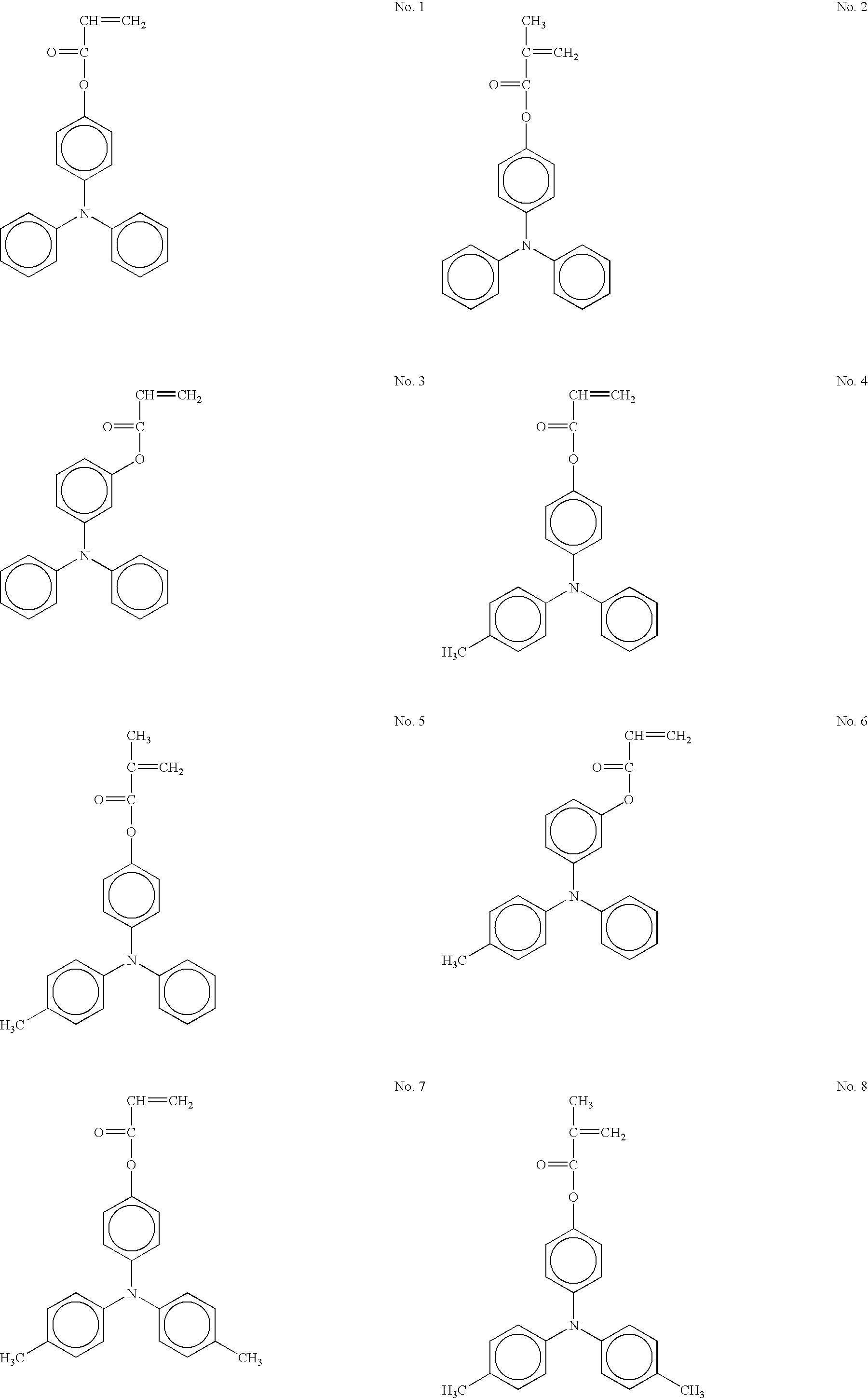

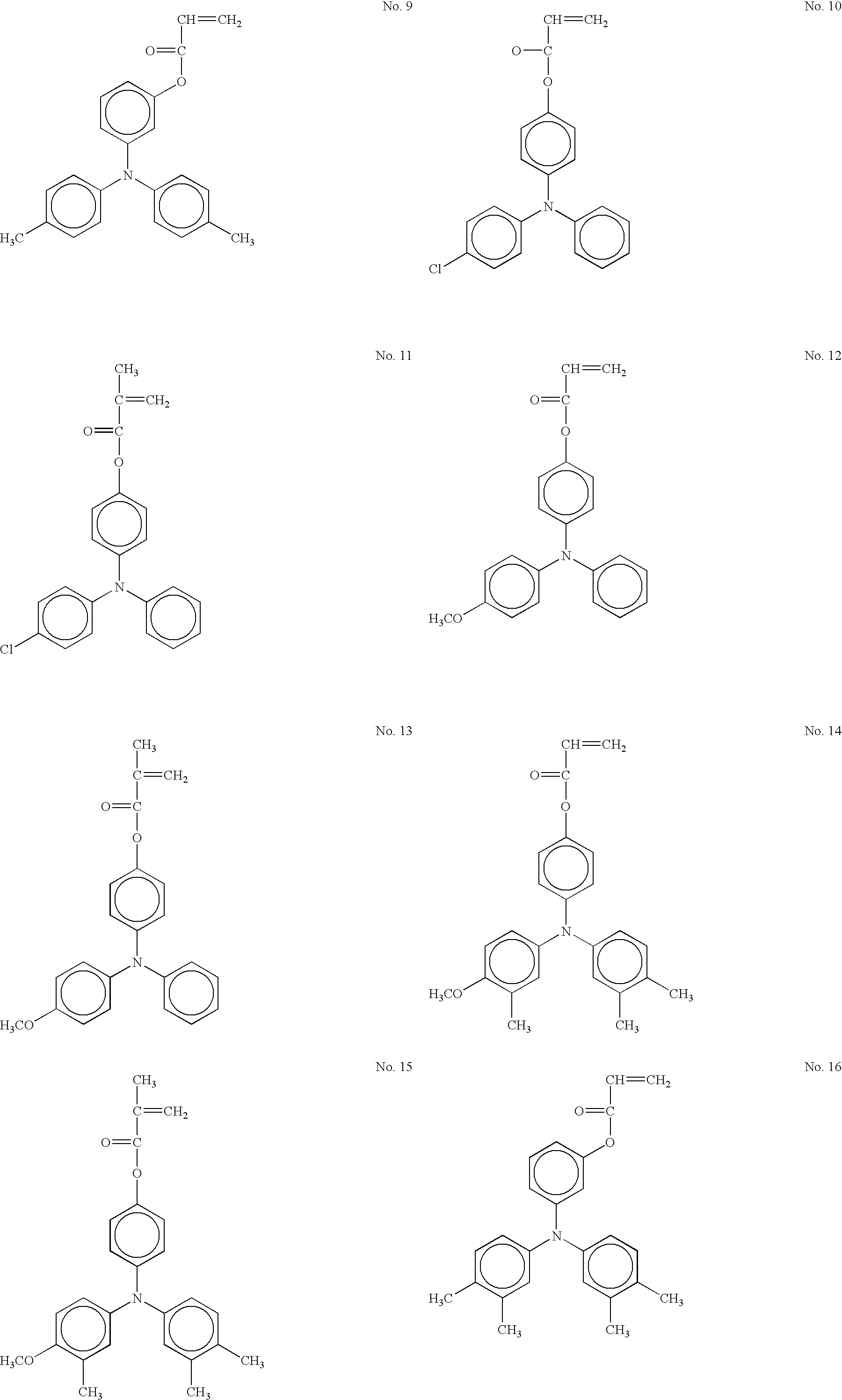

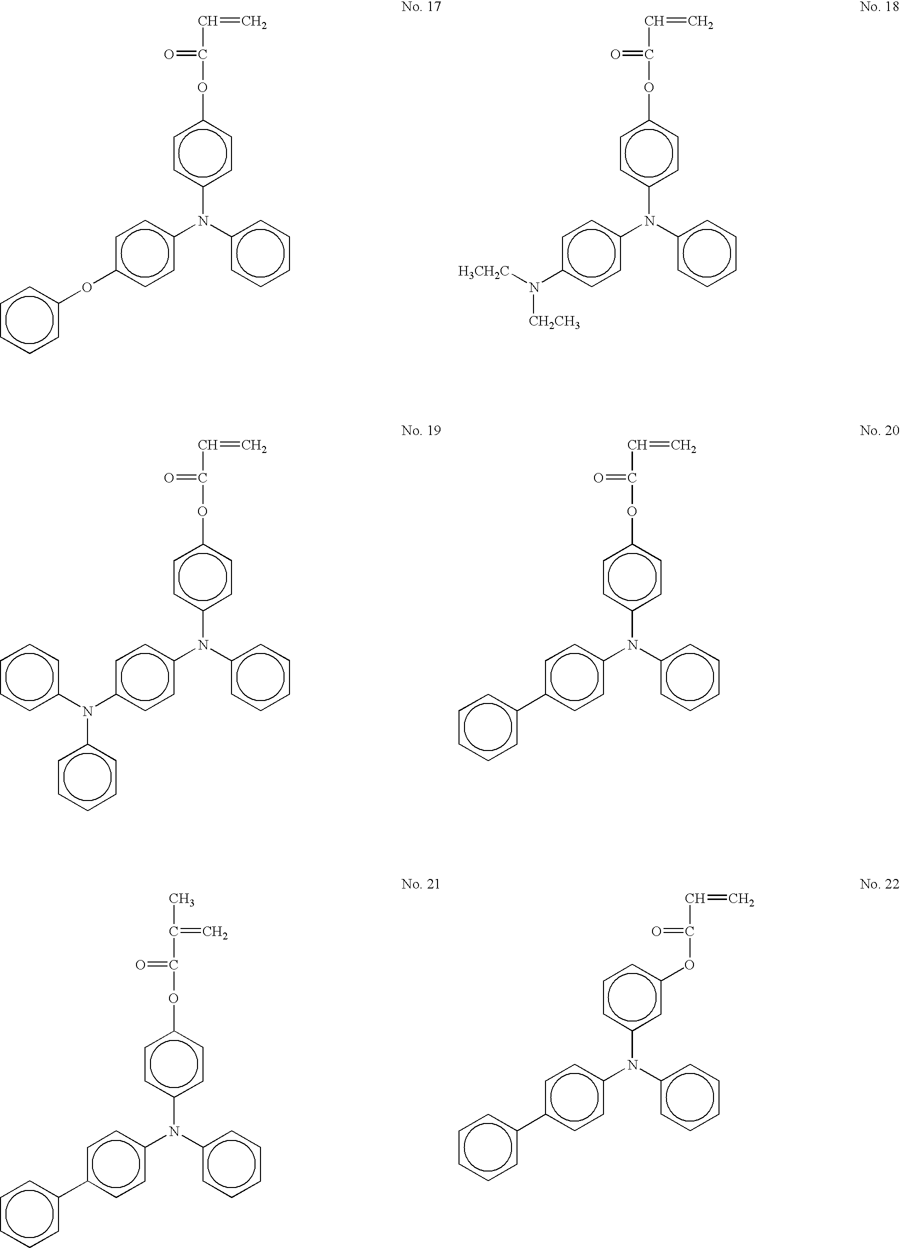

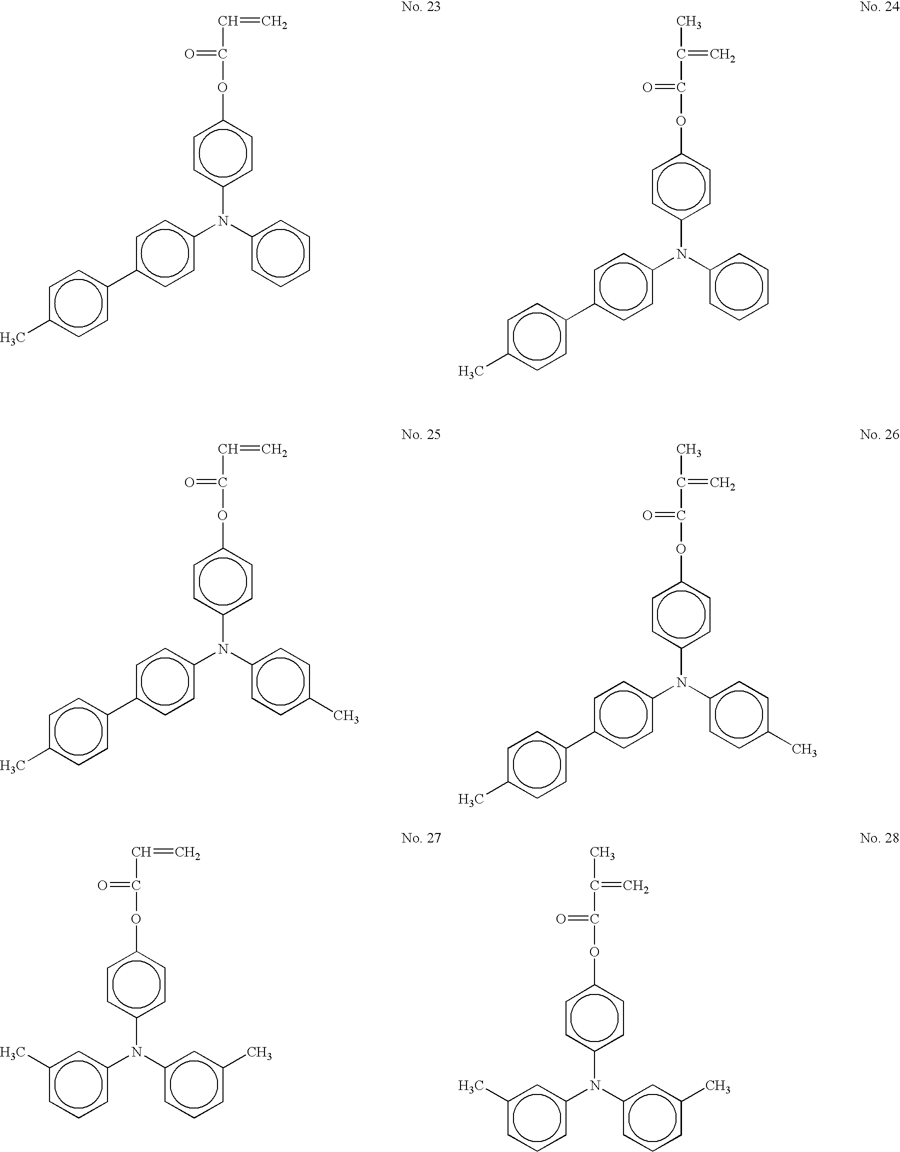

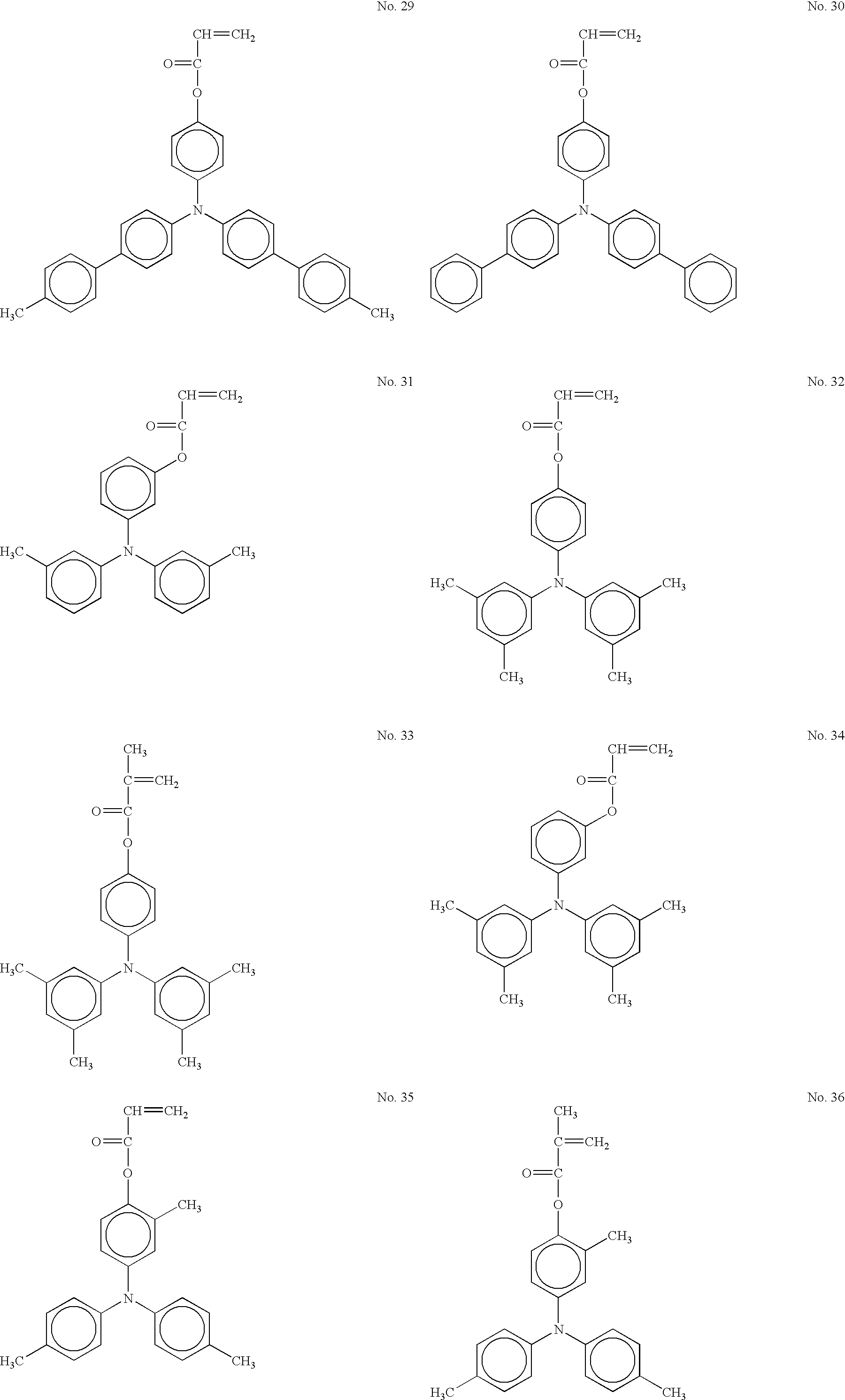

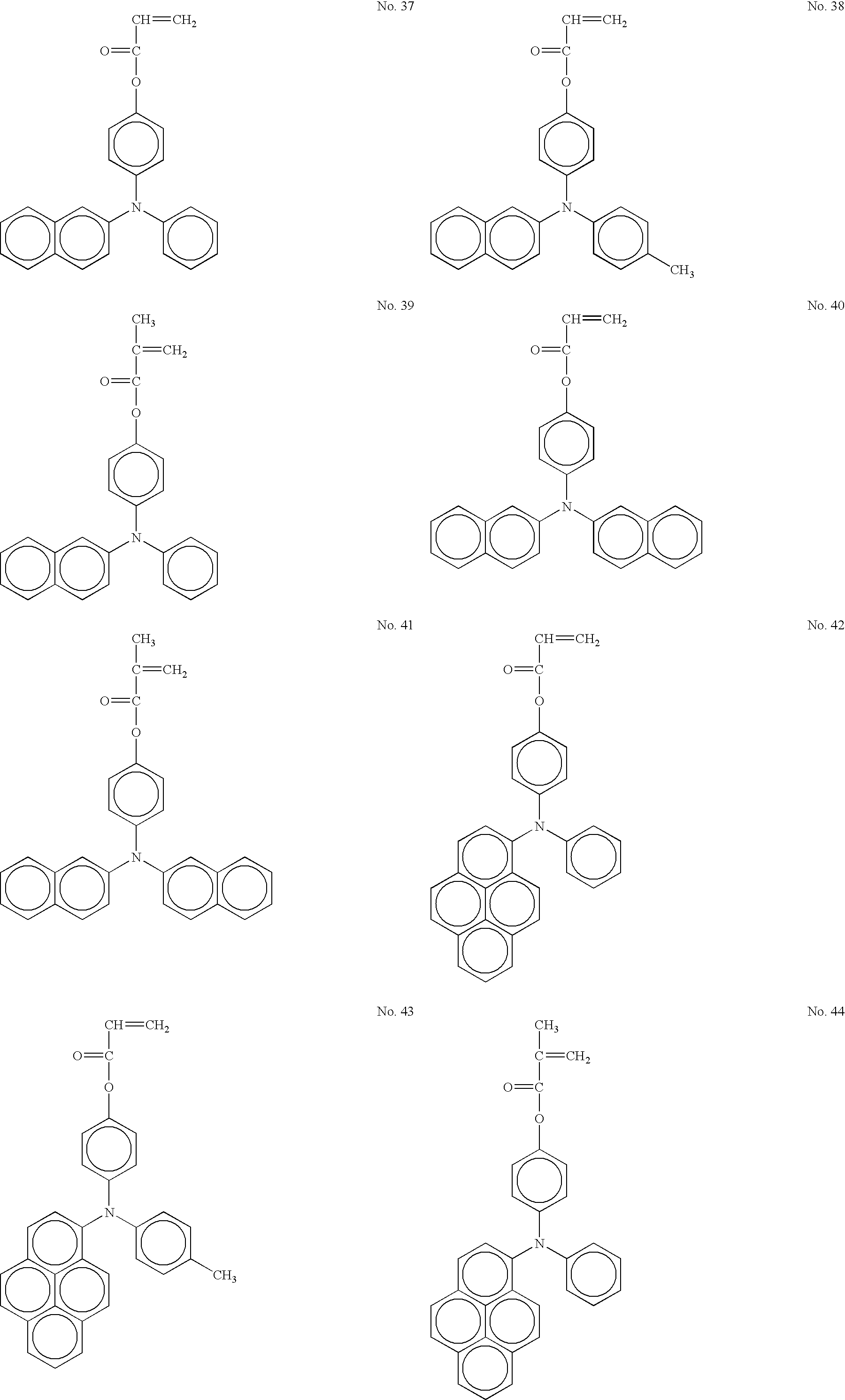

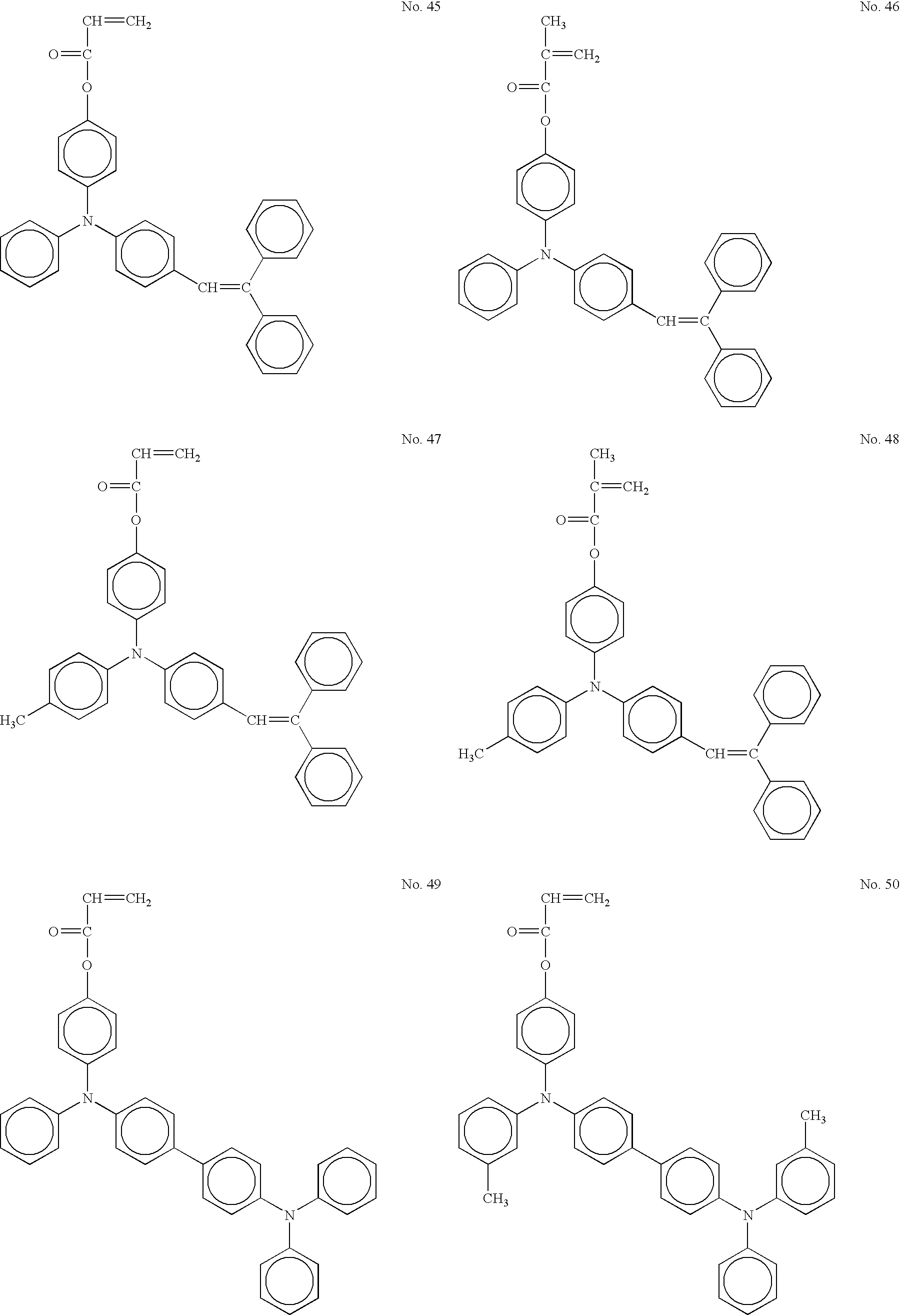

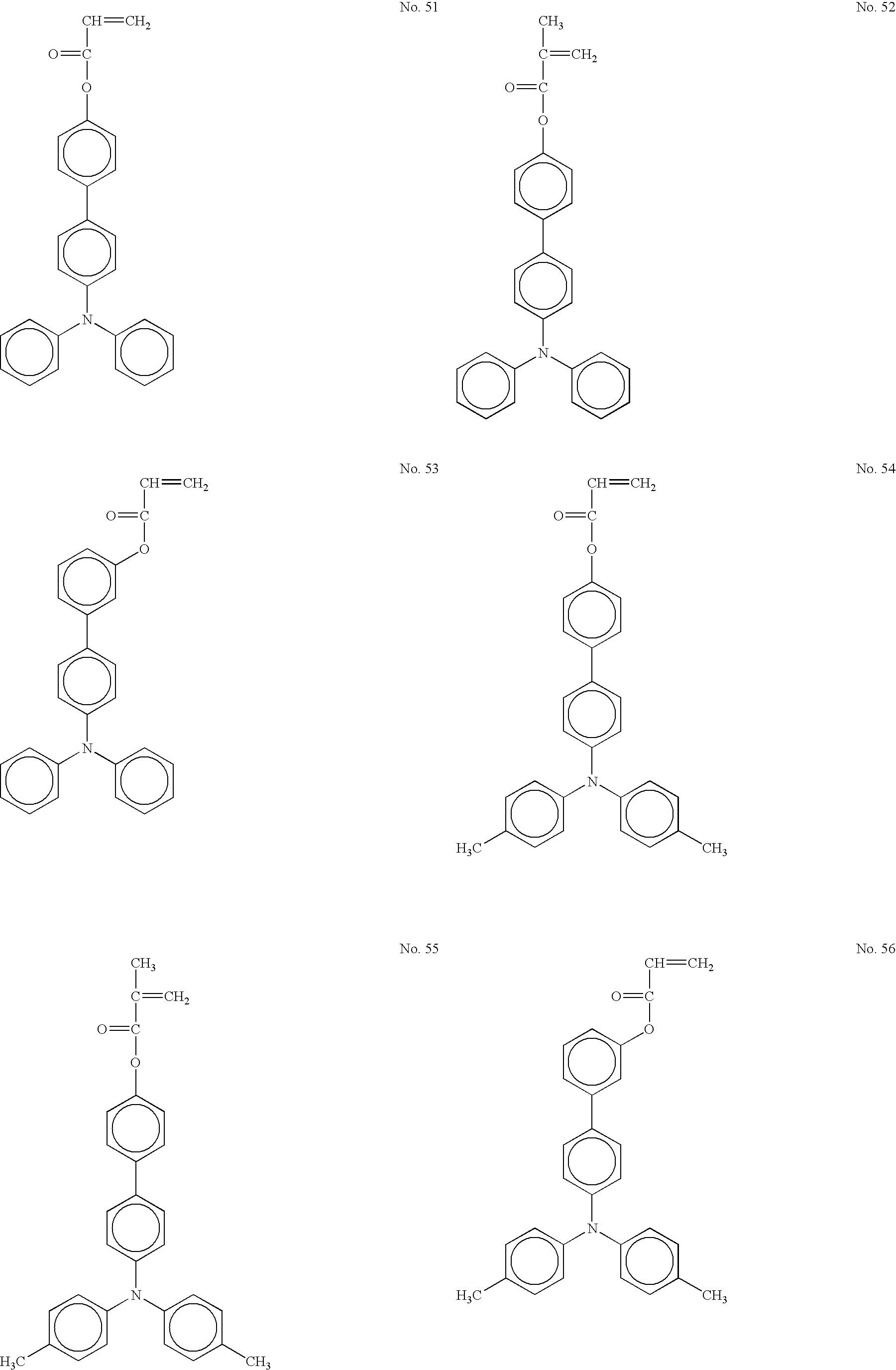

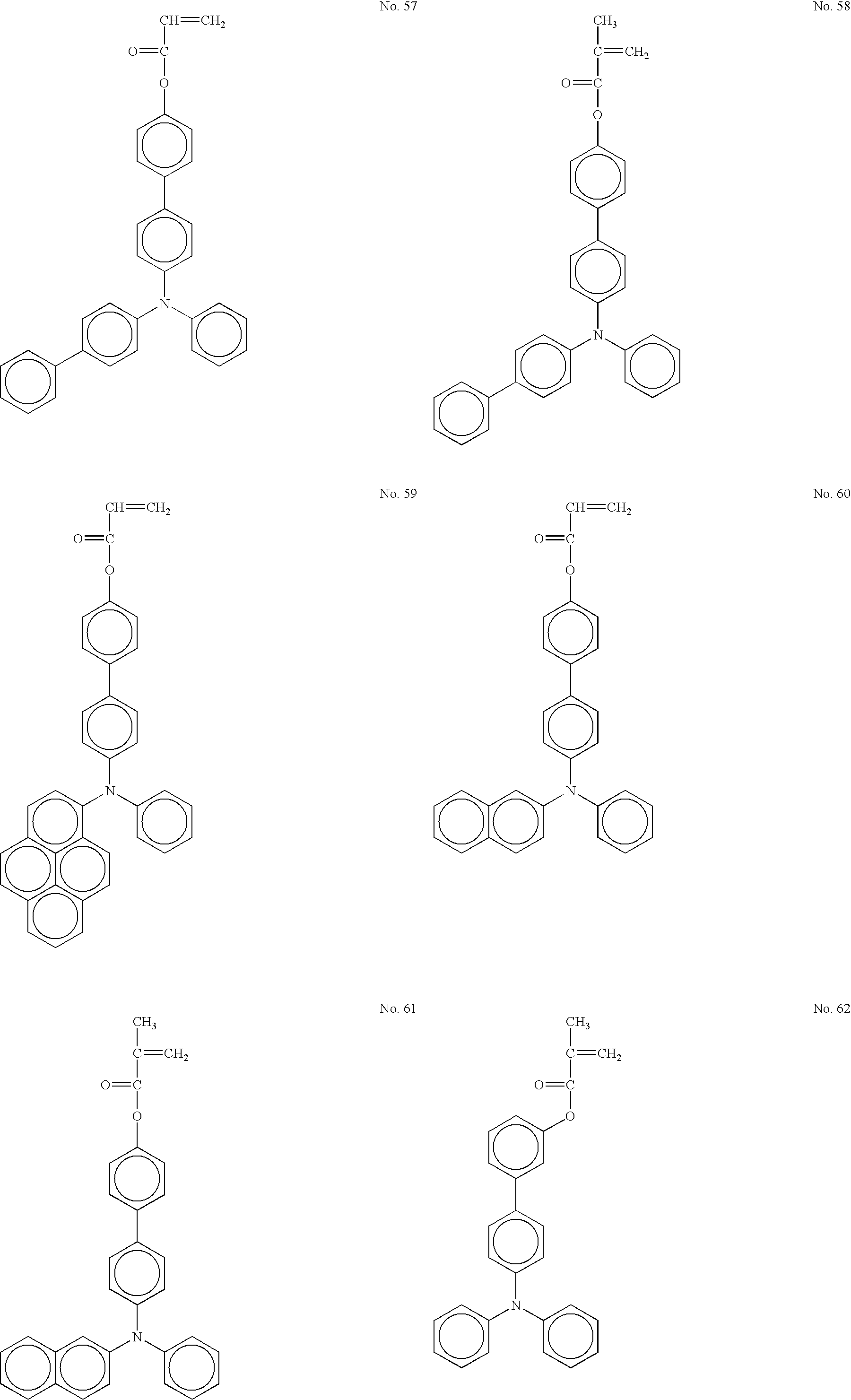

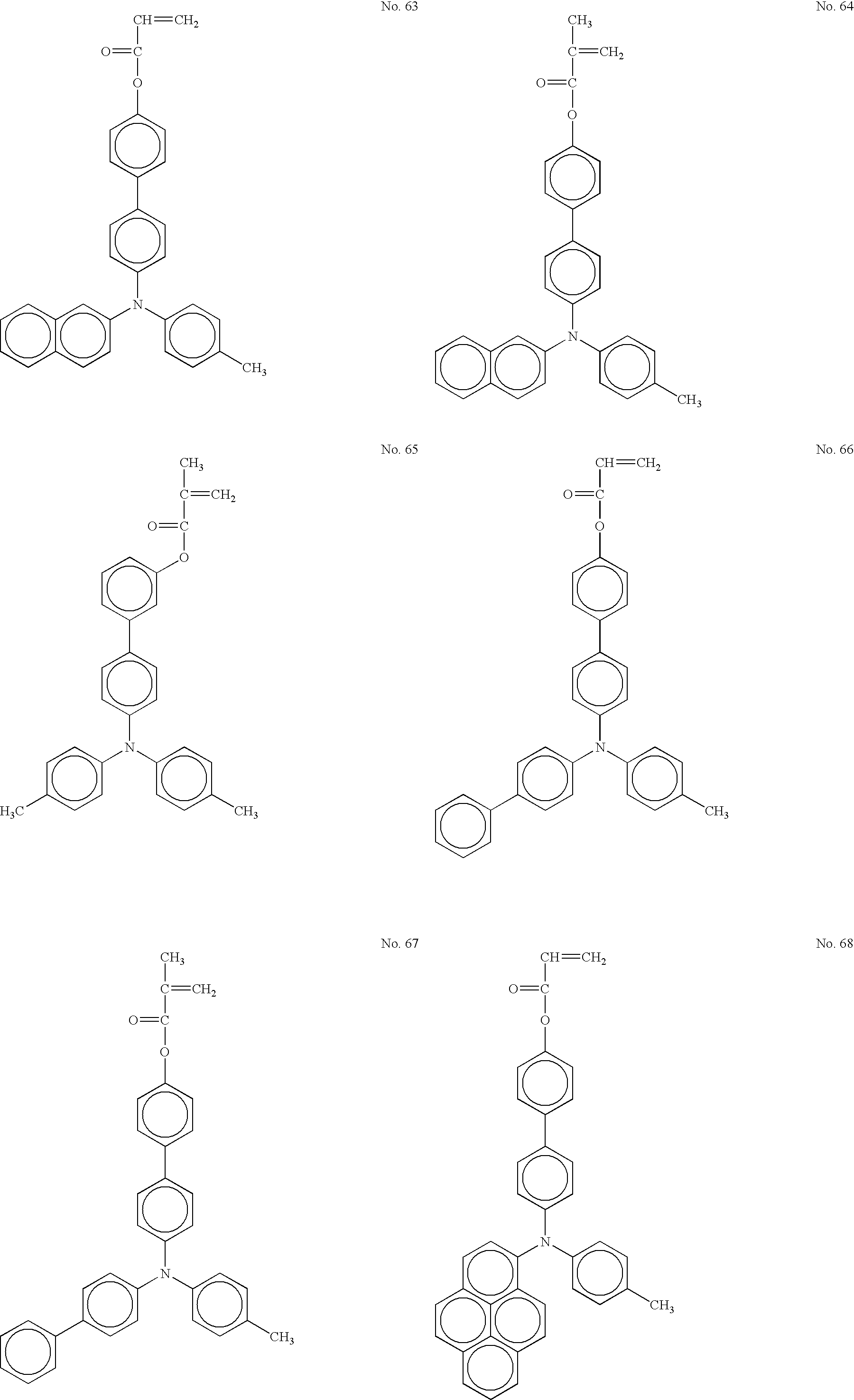

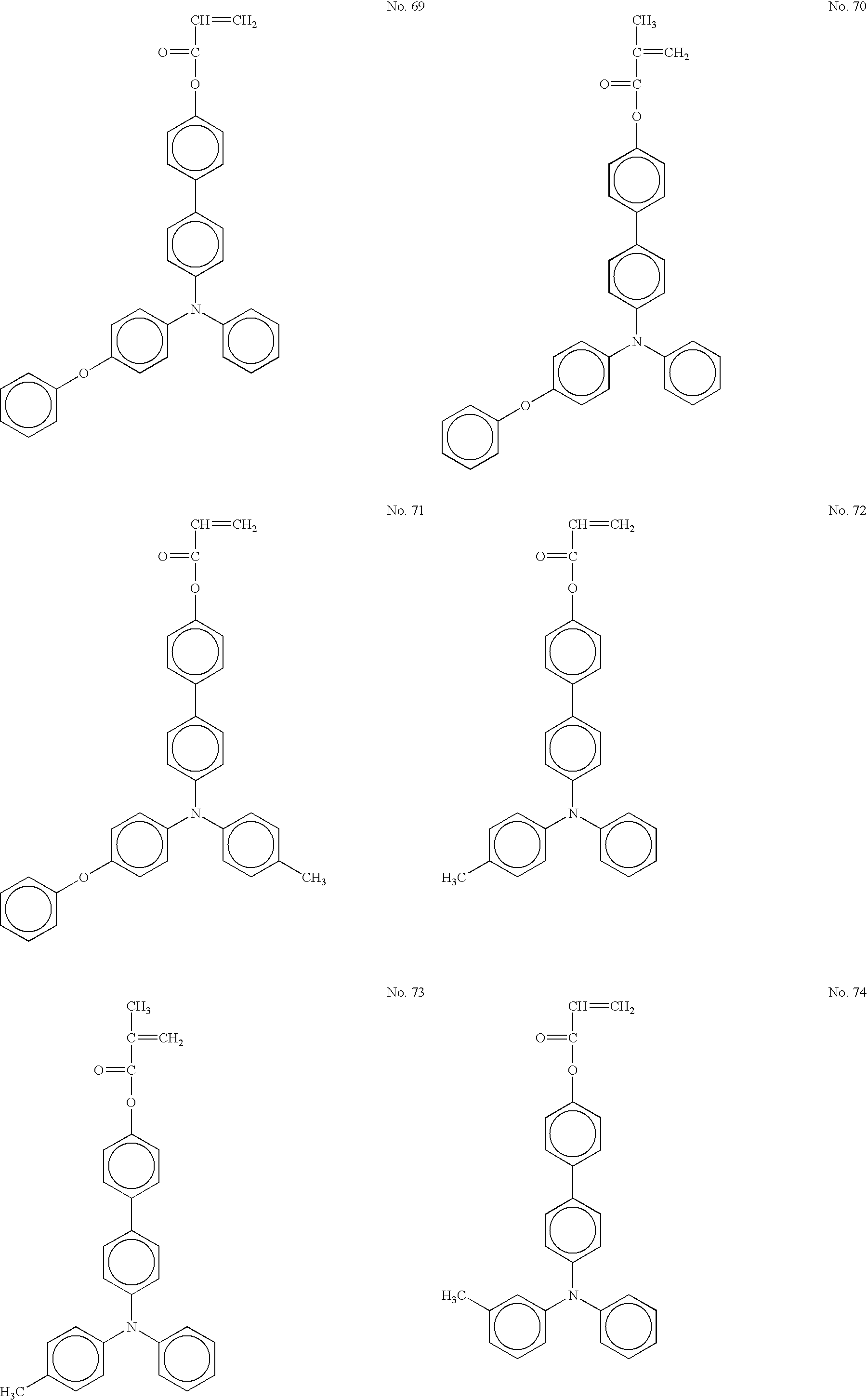

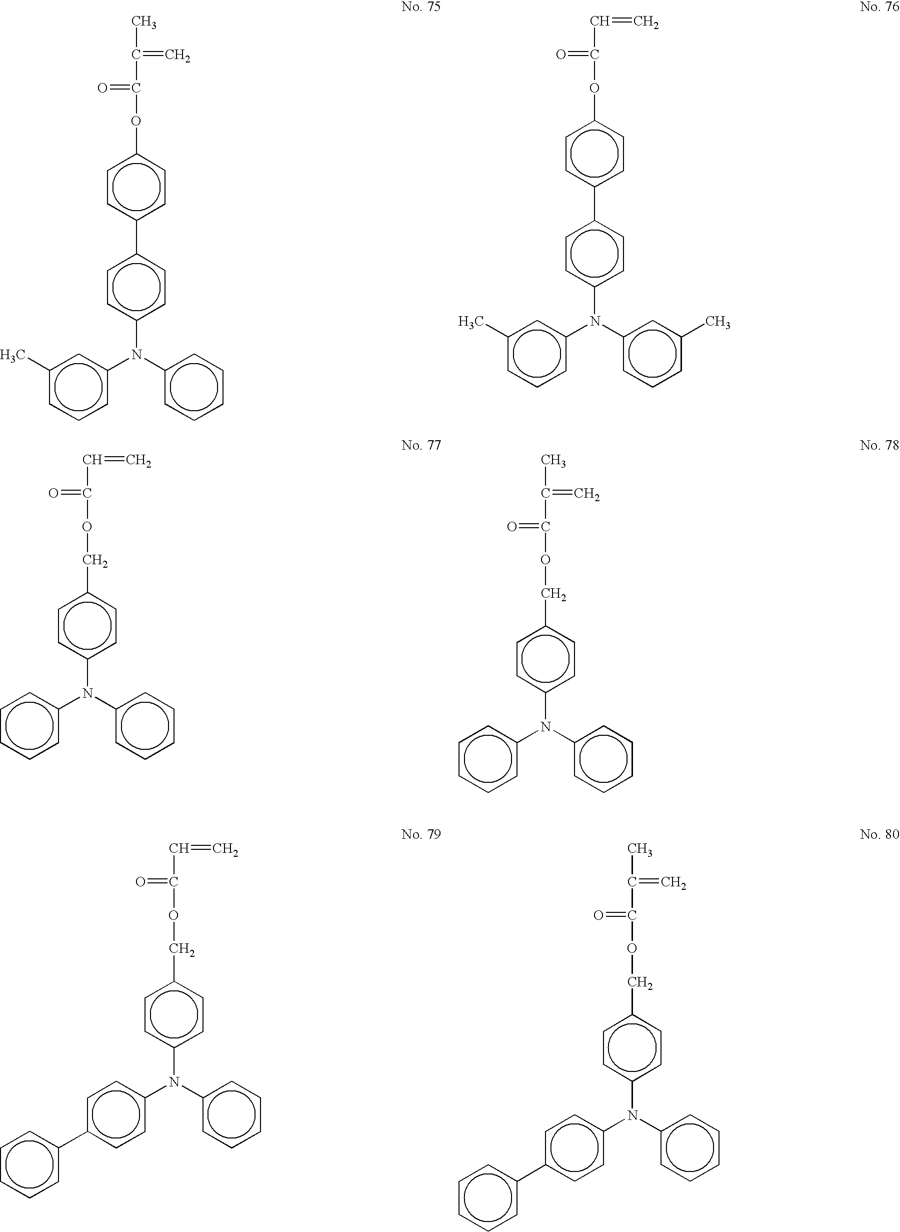

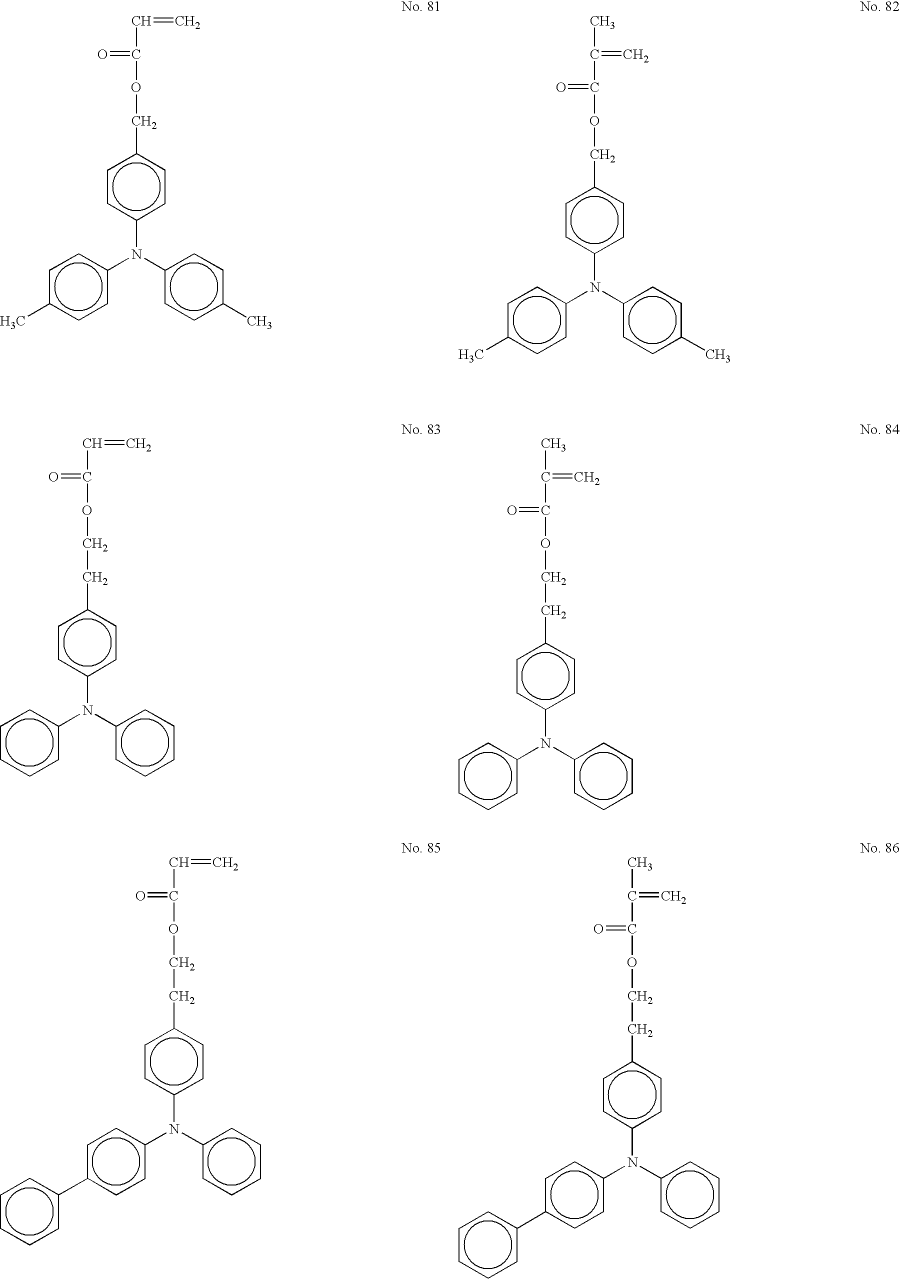

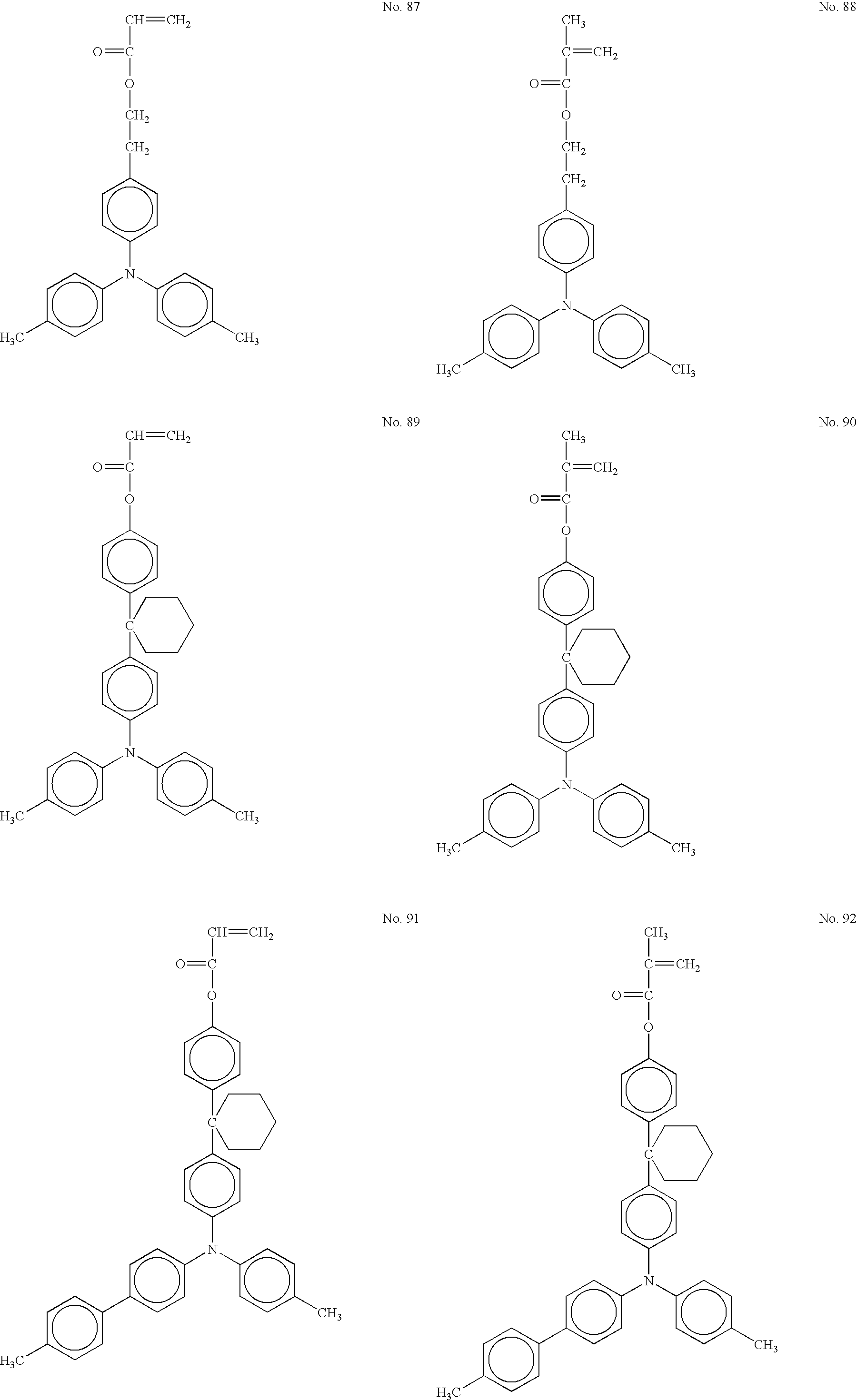

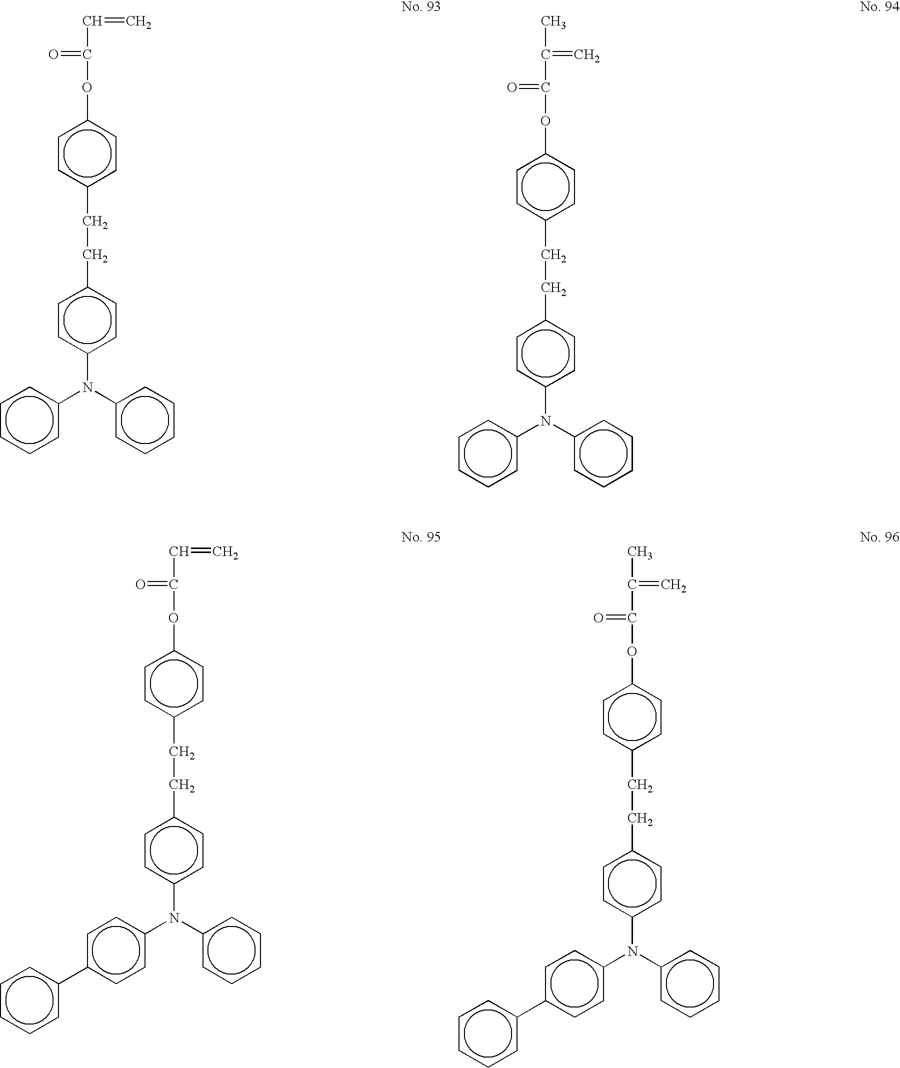

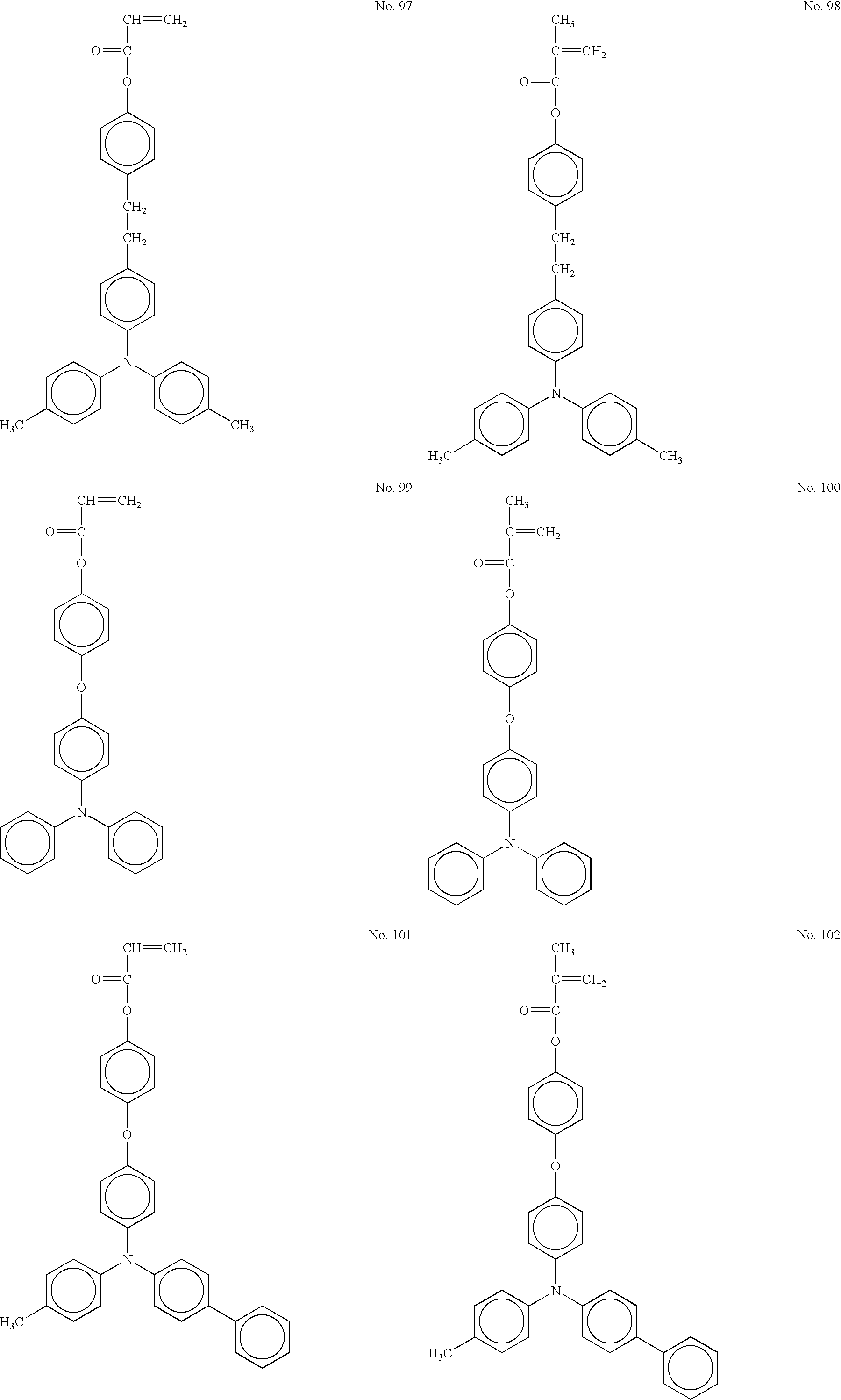

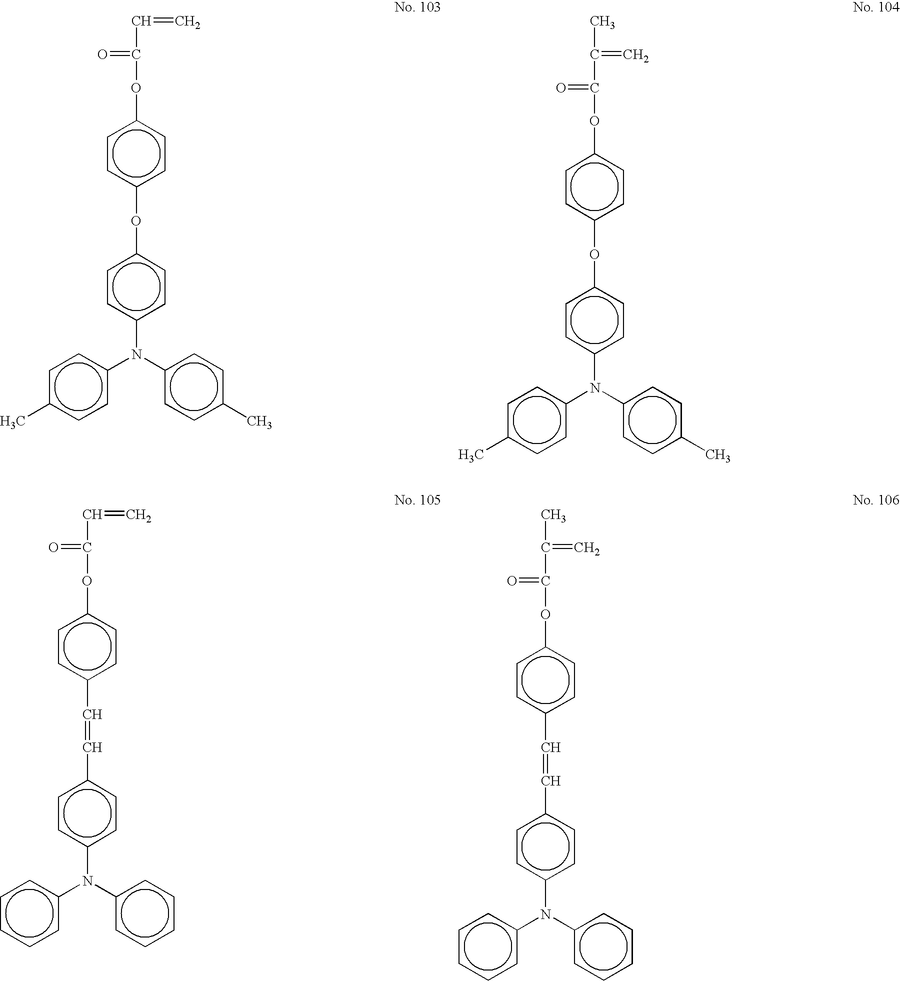

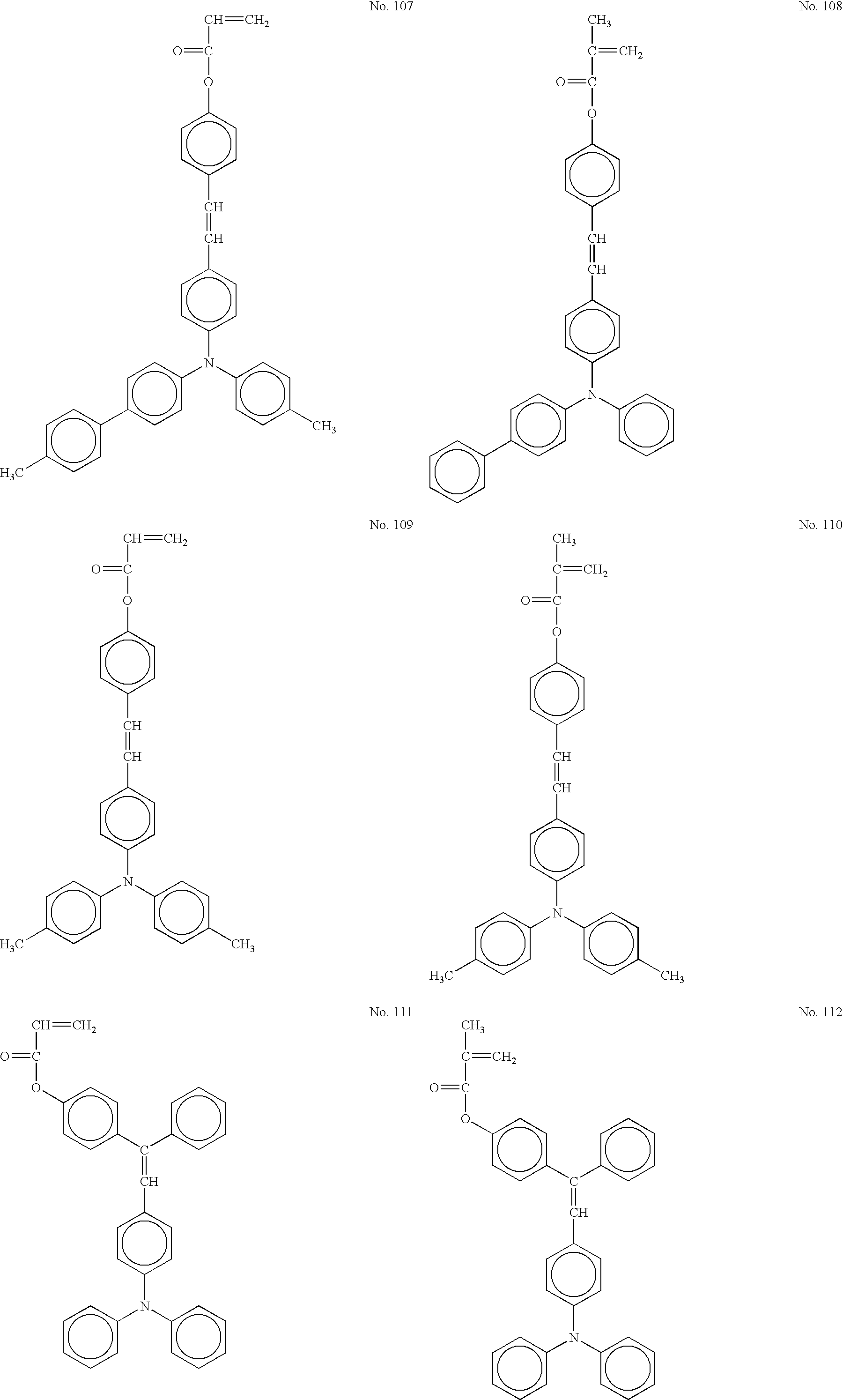

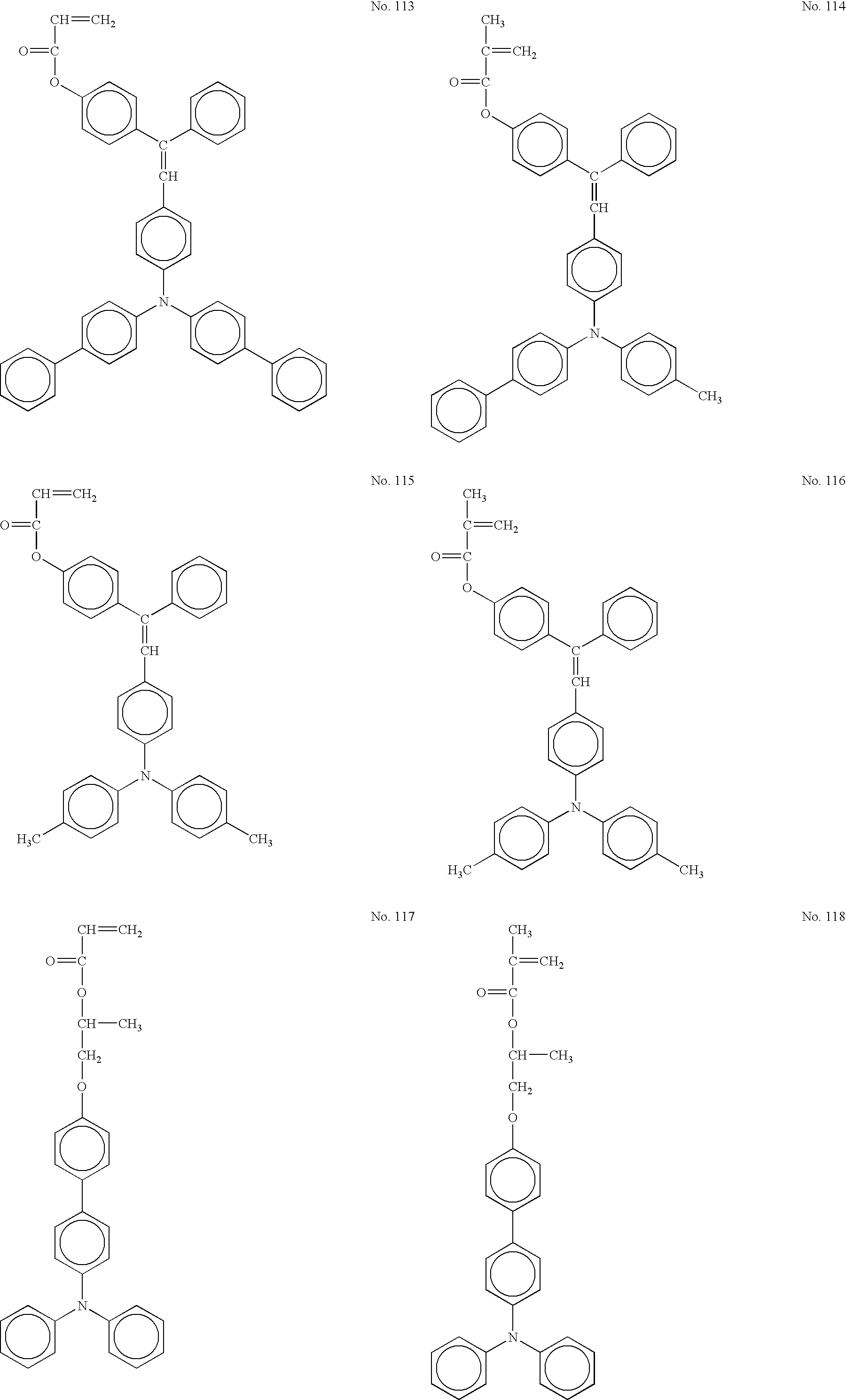

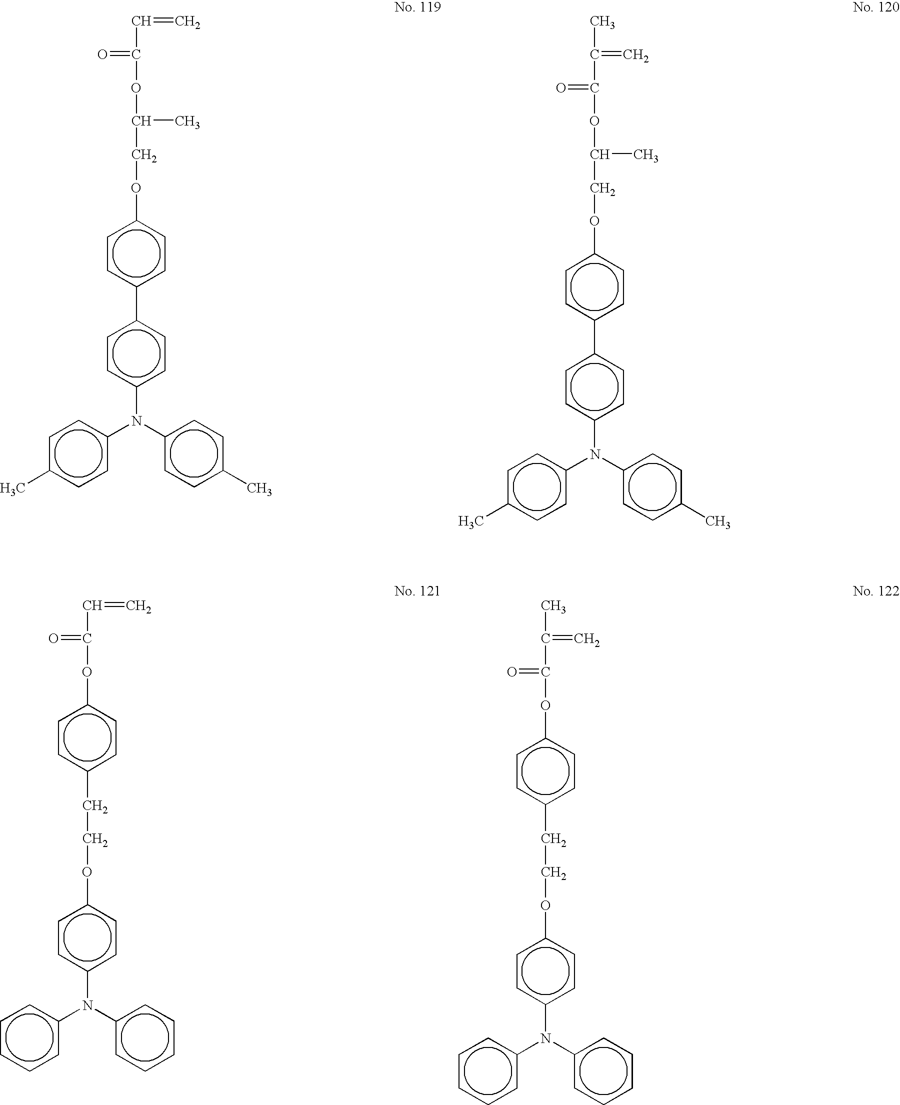

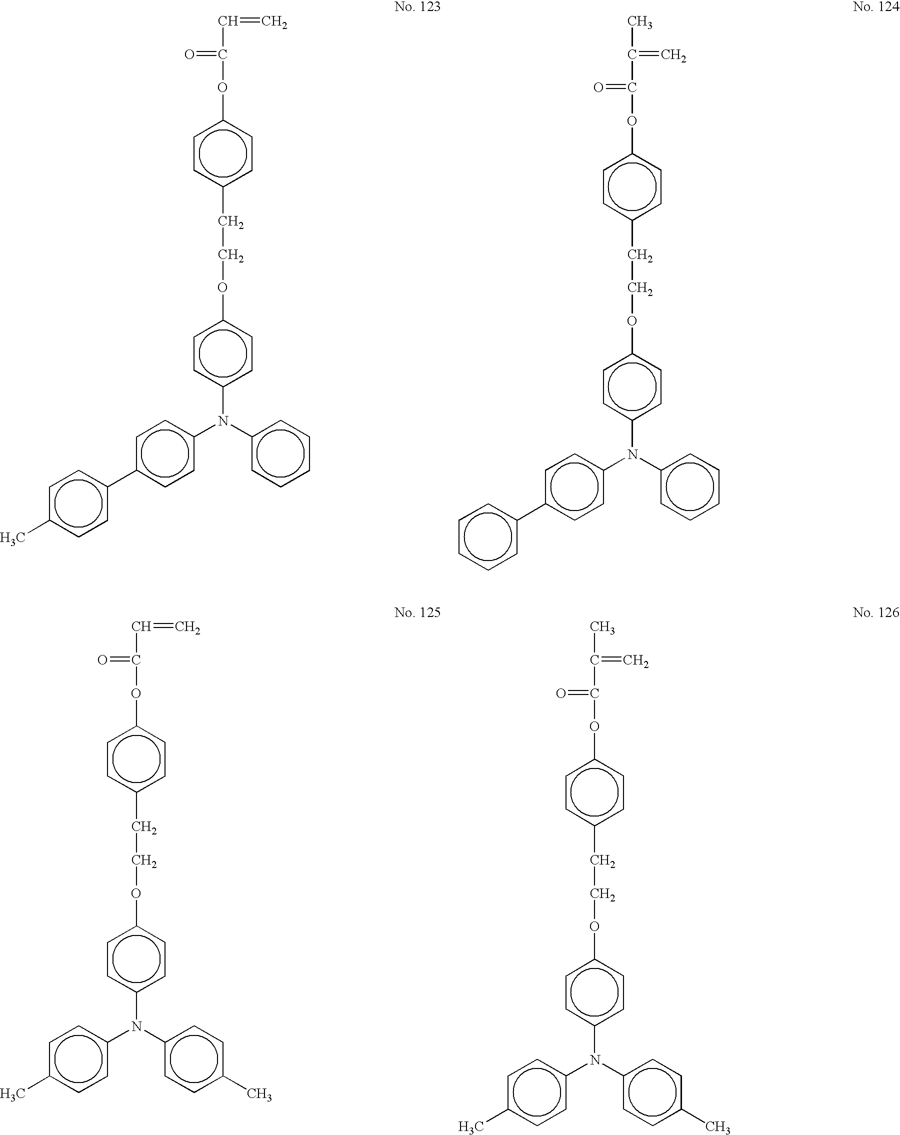

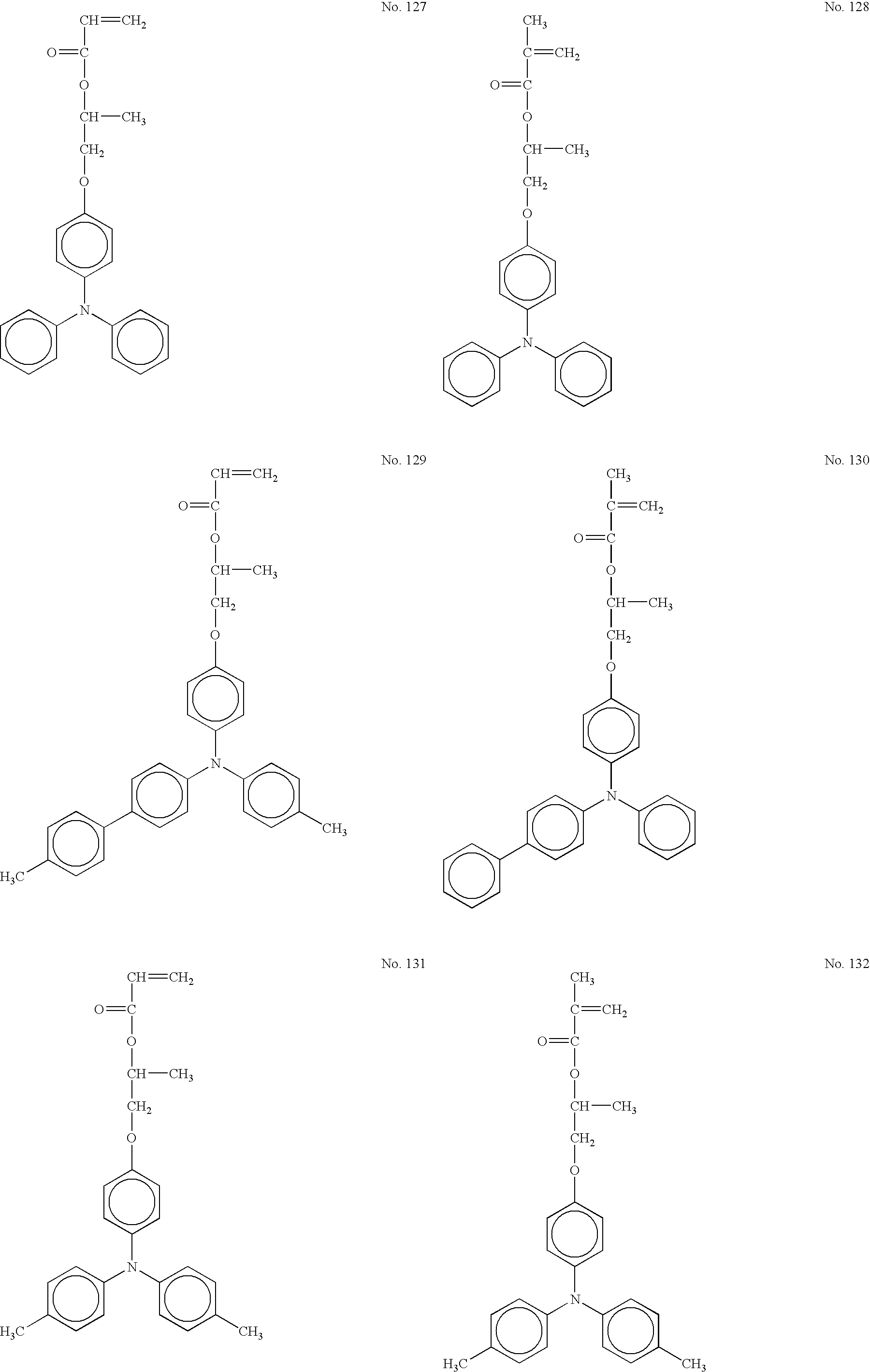

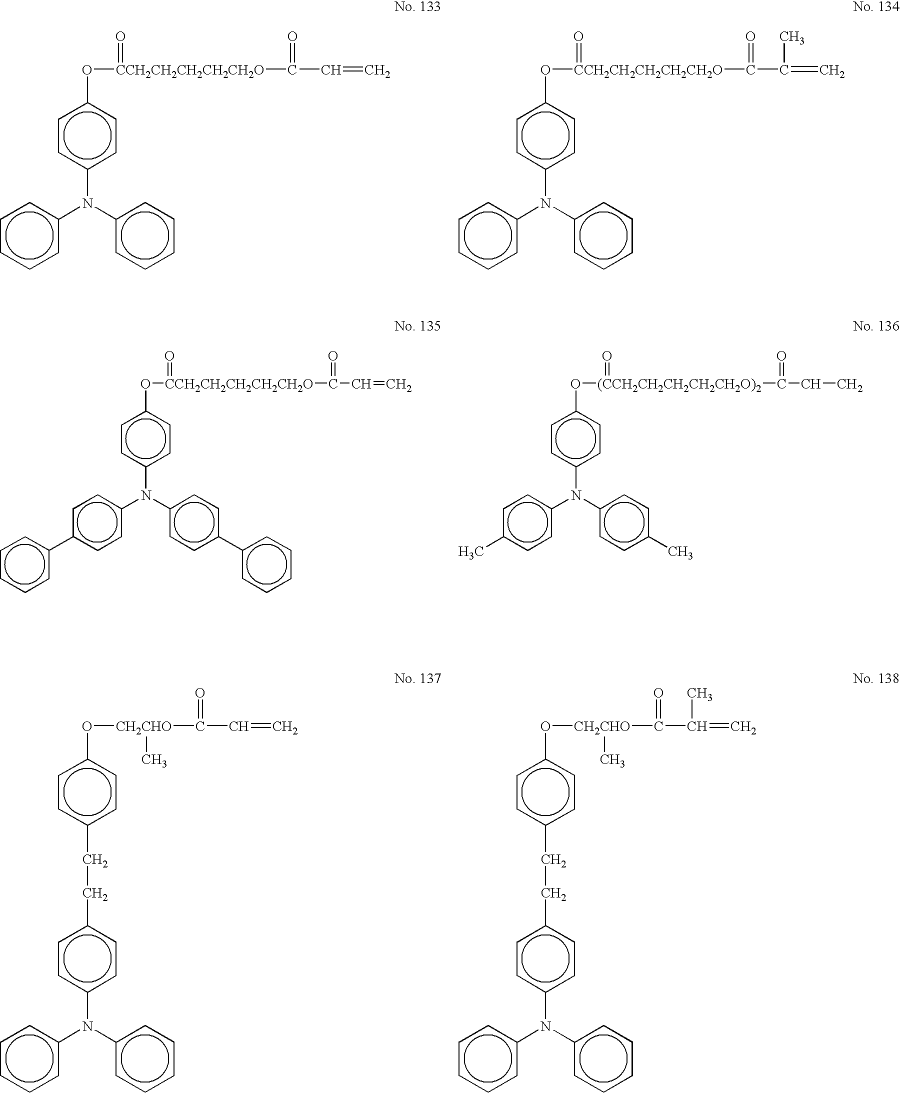

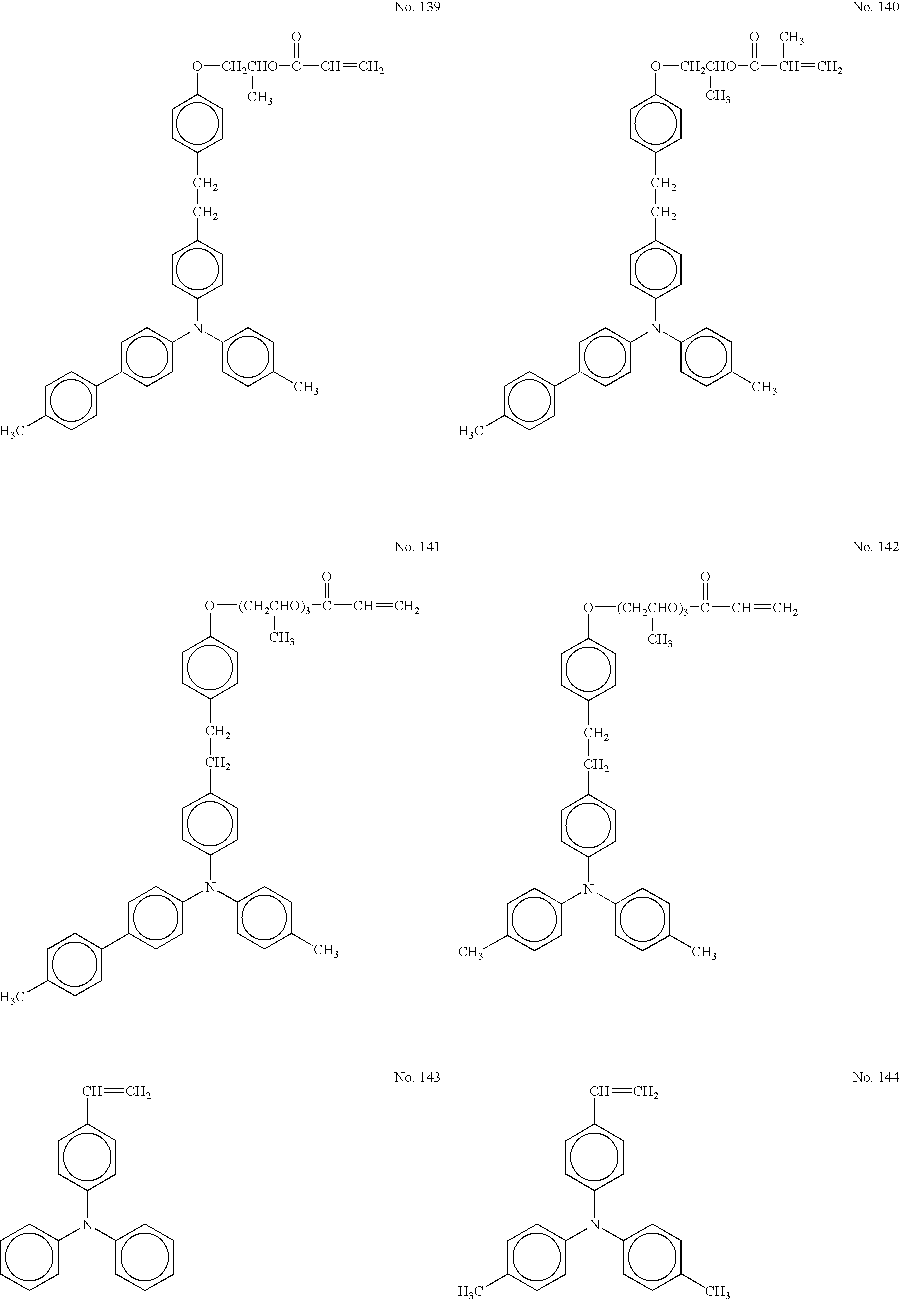

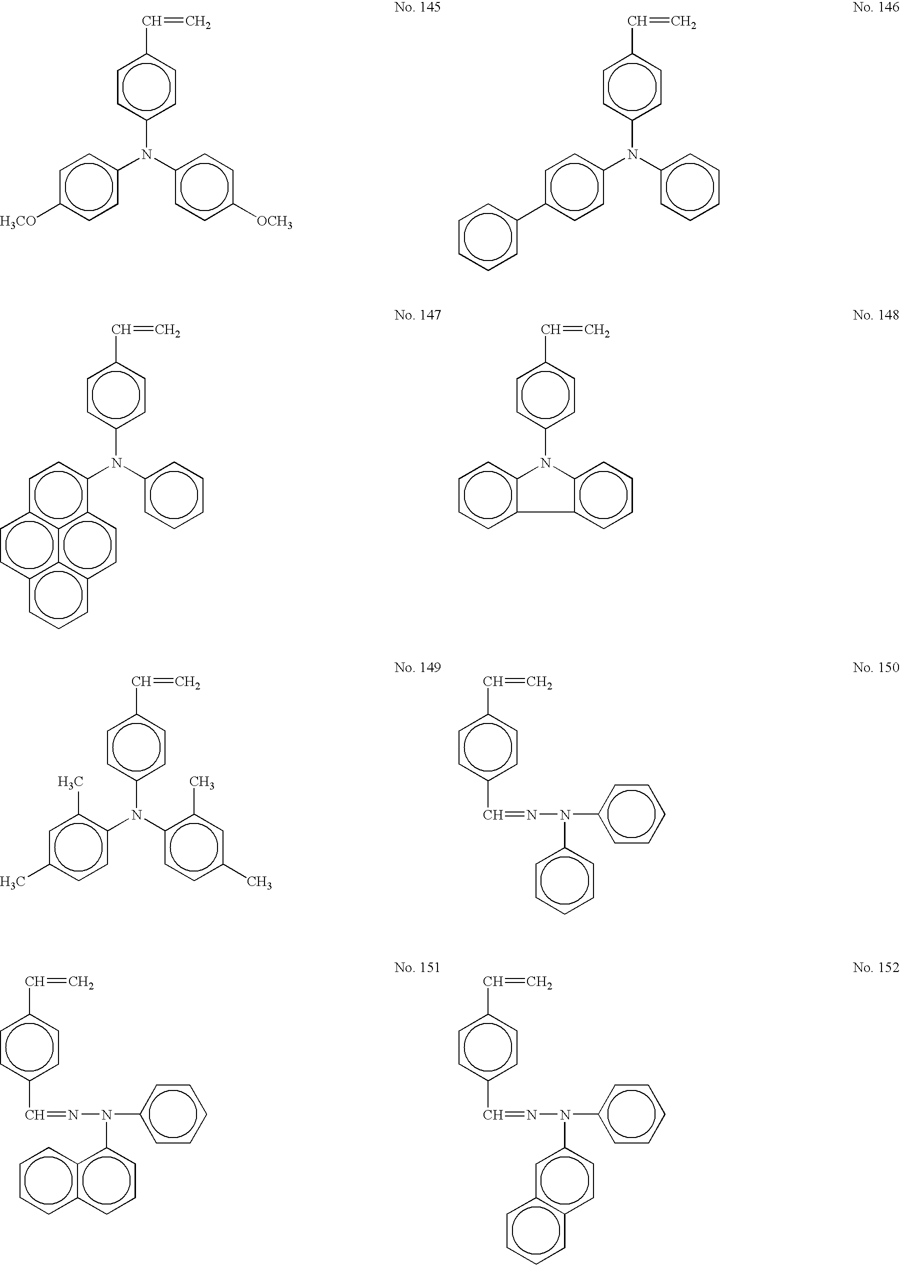

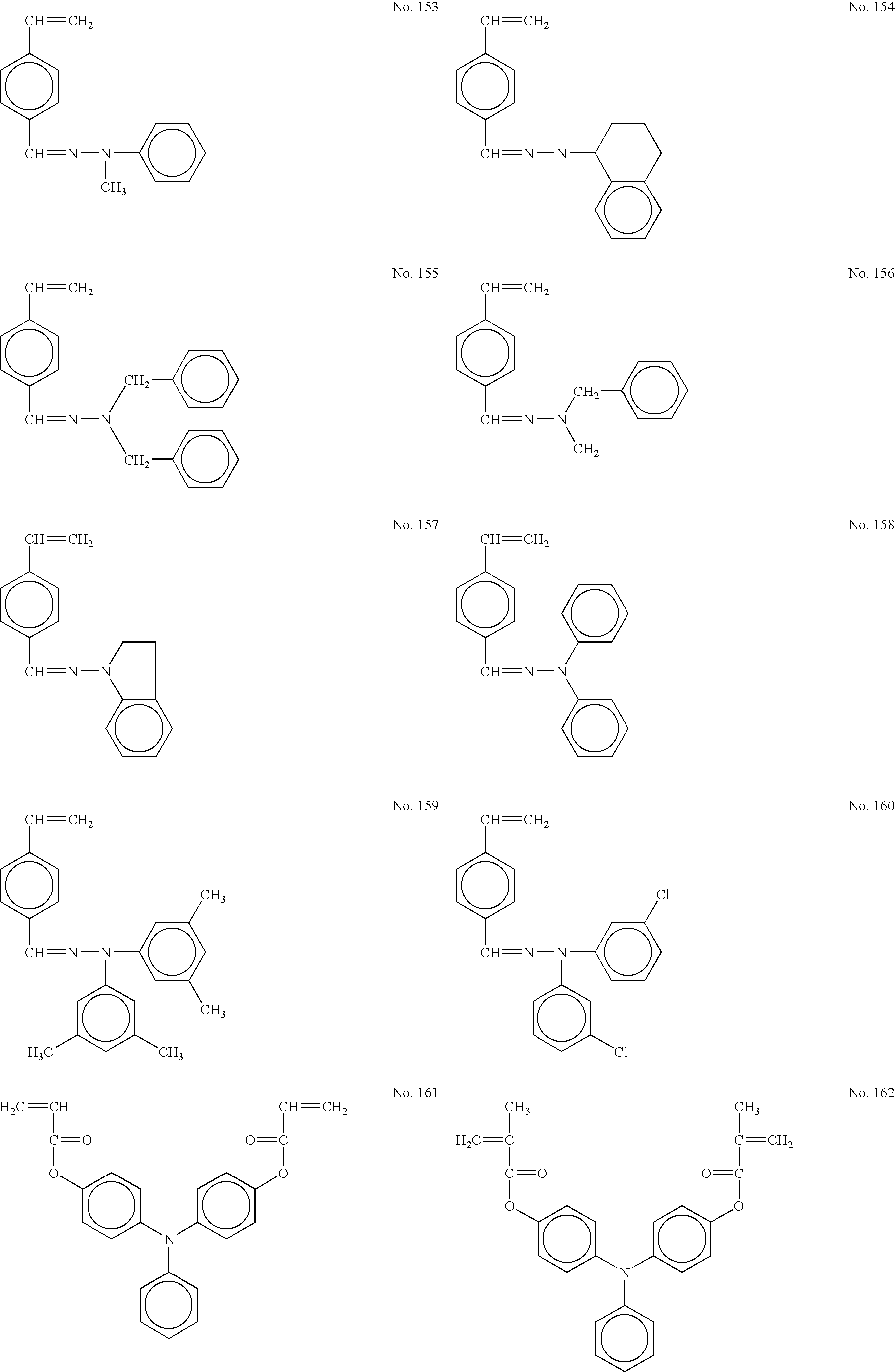

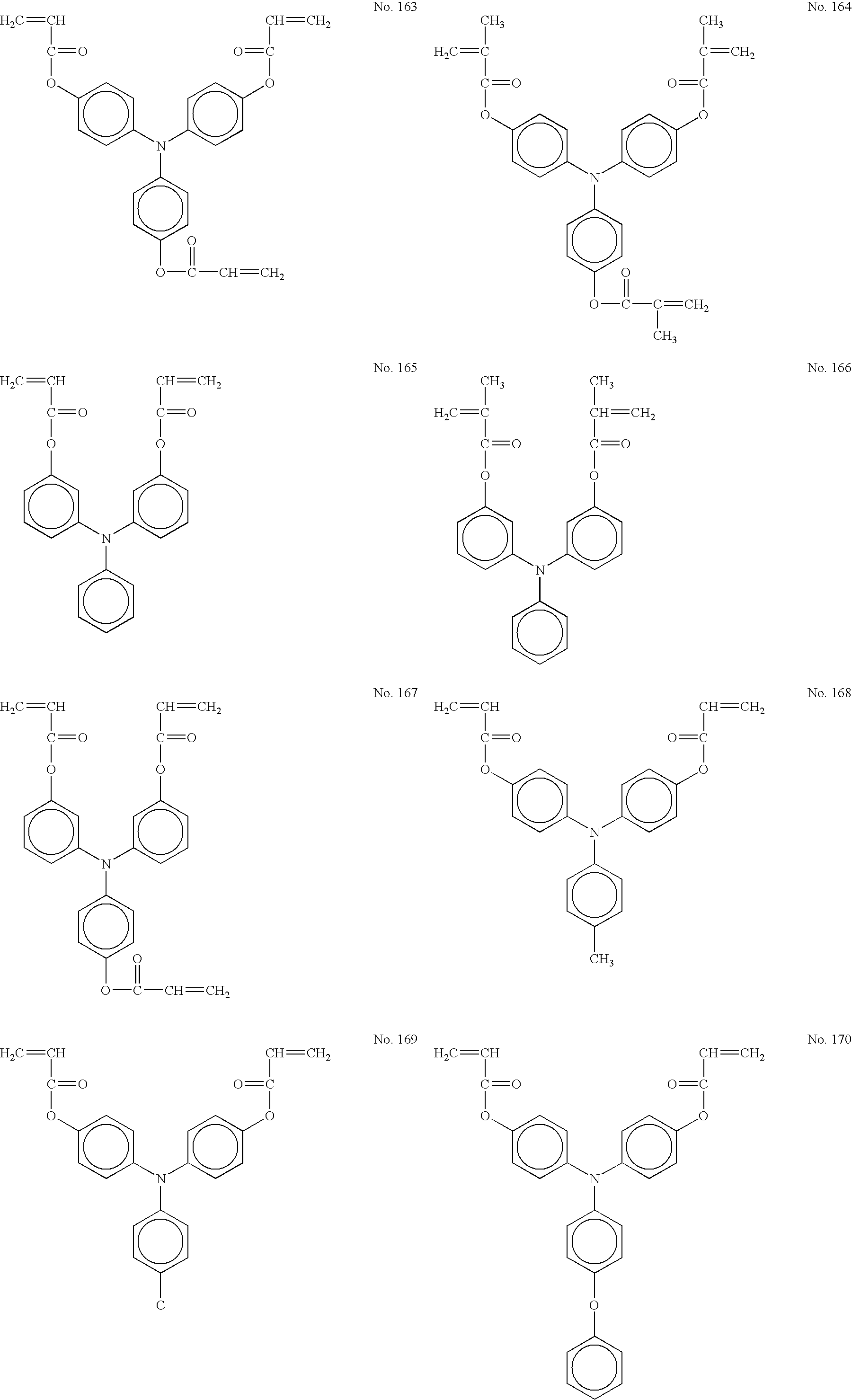

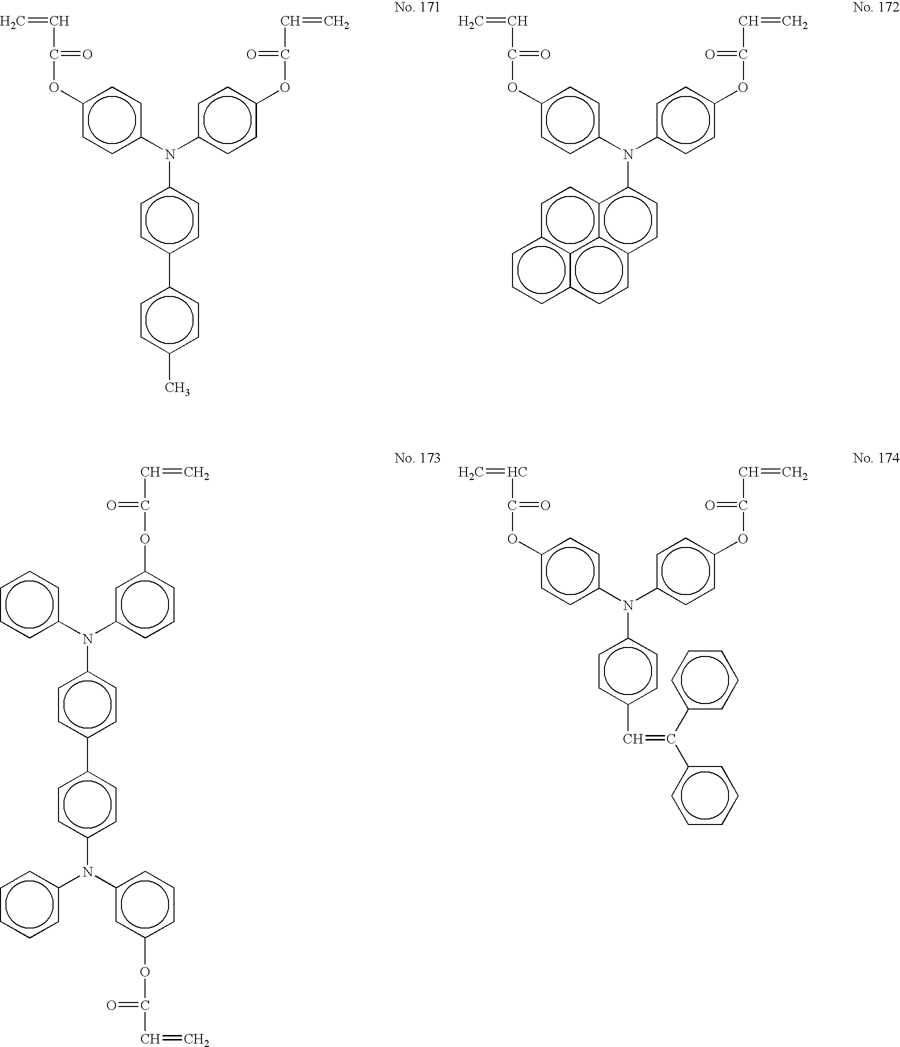

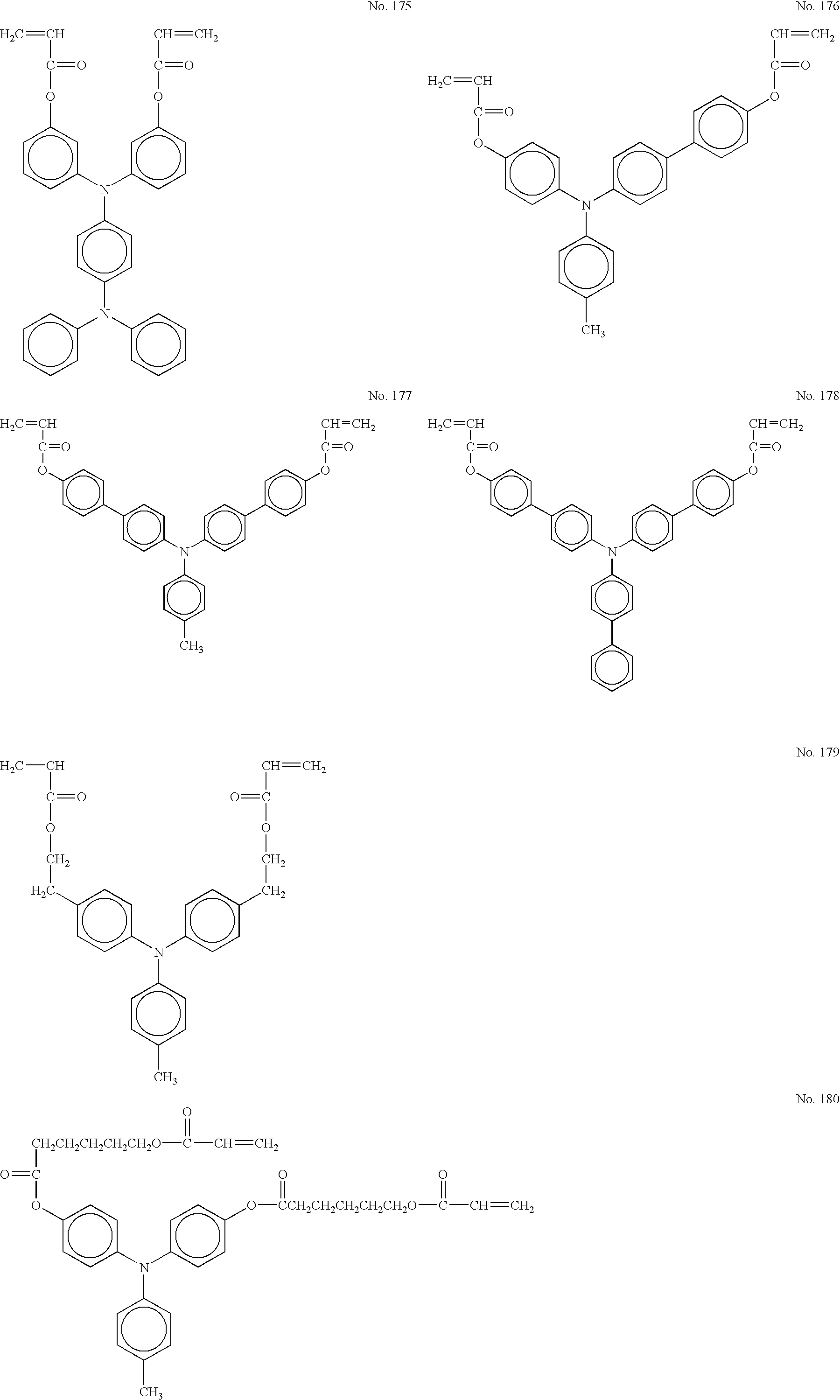

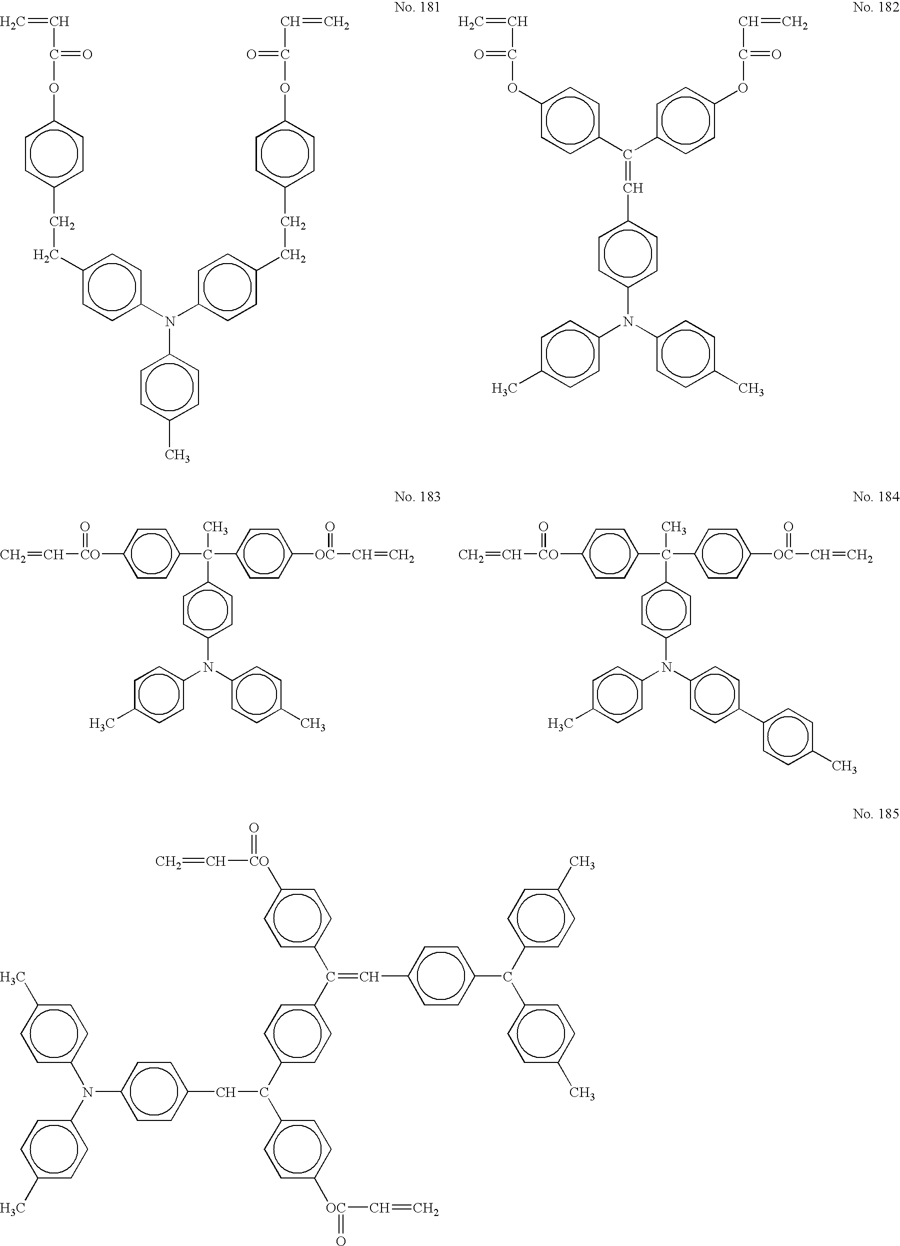

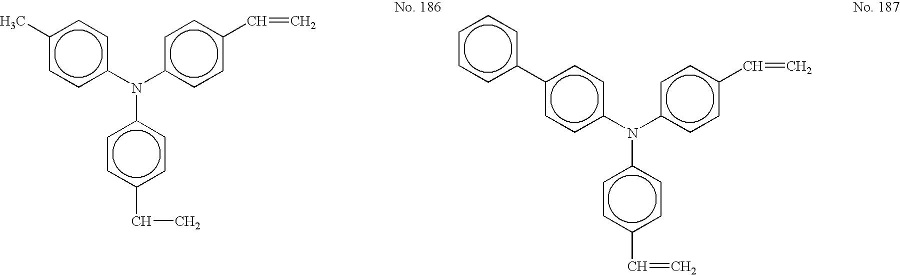

Also, the charge transportation compound having a radical-polymerizable functional group used for the present invention is important for giving charge transportation ability to the crosslinked surface layer and the content of the component in coating liquid is adjusted so that it is 20-80% by weight, preferably 30-70% by weight of the total weight of the surface layer. If the content of the component is less then 20% by weight, the charge transportation ability of the crosslinked surface layer cannot be maintained sufficiently and the degradation of the electrical characteristics such as the lowering in the photosensitivity and the elevation of the residual electric potential are caused in repeated use. On the other hand, if the content is greater than 80% by weight, the content of the three or more-functional monomer having no charge transporting structure is reduced and the lowering in the density of crosslinkage is caused and the abrasive resistance is not exerted. Although required abrasive resistance and electrostatic characteristics depend on a used process, the content is most preferably in a range of 30-70% by weight, in view of the balance of the abrasive resistance and the electrostatic characteristics.

Next, an acylphosphine oxide compound used as a photo-polymerization initiator in the present invention is explained.

The acylphosphine oxide compound used for the present invention is represented by general formula (4) or (5).

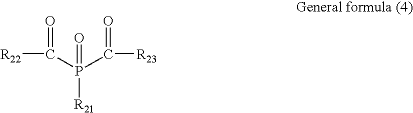

In general formula (4), each of R₂₁ through R₂₃ is independently an alkyl group, an aryl group, an aralkyl group, an alkenyl group, or an alkynyl group.

In general formula (4), each of R₂₁ and R₂₃ is independently an alkyl group, an alkenyl group, an alkynyl group, a cycloalkyl group, an aryl group, an alkoxy group, an aryloxy group, or a heterocyclic group.

Preferably, each of the alkyl group, the alkenyl group, the alkynyl group, the cycloalkyl group, and the alkoxy group is a substituent in which the number of carbon atom(s) is 1 through 30. As the aryl group, phenyl group, naphthyl group, biphenyl group, etc. can be provided. As the aryloxy group, phenoxy group, naphthoxy group, etc. can be provided. As the heterocyclic group, pyridyl group, furyl group, thienyl group, imidazolyl group, etc. can be provided.

Each of the alkyl group, the alkenyl group, the alkynyl group, the cycloalkyl group, the aryl group, the alkoxy group, the aryloxy group, and the heterocyclic group for R₂₁ through R₂₃ may be substituted with a substituent. As the substituents for R₂₁ through R₂₃, for example, alkyl groups, aryl groups, alkoxy groups, aryloxy groups, hydroxyl group, halogen atoms, nitro group, cyano group, alkylsulfonyl groups, arylsulfonyl groups, alkylthio groups, arylthio groups, alkyl-substituted amino groups, acylamino groups, carbamoyl group, alkoxycarbonyl groups, aryloxycarbonyl groups, and acyl groups can be provided.

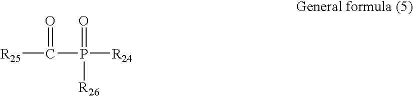

In general formula (5), each of R₂₄ through R₂₆ is independently an alkyl group, an aryl group, an aralkyl group, an alkenyl group, or an alkynyl group.

In general formula (5), each of R₂₄ and R₂₆ is independently an alkyl group, an alkenyl group, an alkynyl group, a cycloalkyl group, an aryl group, an alkoxy group, an aryloxy group, or a heterocyclic group and R₂₅ is an alkyl group, an alkenyl group, an alkynyl group, a cycloalkyl group, an aralkyl group, an aryl group, or a heterocyclic group.

Preferably, each of the alkyl group, the alkenyl group, the alkynyl group, the cycloalkyl group, and the alkoxy group is a substituent in which the number of carbon atom(s) is 1 through 30. As the aryl group, phenyl group, naphthyl group, biphenyl group, etc. can be provided. As the aryloxy group, phenoxy group, naphthoxy group, etc. can be provided. As the heterocyclic group, pyridyl group, furyl group, thienyl group, imidazolyl group, etc. can be provided.

Each of the alkyl group, the alkenyl group, the alkynyl group, the cycloalkyl group, the aryl group, the alkoxy group, the aryloxy group, and the heterocyclic group for R₂₄ through R₂₆ may be substituted with a substituent. As the substituents for R₂₄ through R₂₆, substituents for the alkyl group, the alkenyl group, the alkynyl group, the cycloalkyl group, the aryl group, the alkoxy group, the aryloxy group, and the heterocyclic group for R₂₁ through R₂₃ can be provided.

Since these polymerization initiator has photosensitivity in a wavelength region longer than a conventionally used UV initiator (visible light region equal to or longer than 400 nm) and excellent light transparency and is cleaved to generate an acyl radical and a phosphino radical under light irradiation, the efficiency of polymerization initiation of them is higher than of the conventionally used UV initiators.

As the specific examples of an acylphosphine oxide compound represented by general formula (4) used for the present invention, bis(2,6-dichlorobenzoyl)phenylphosphine oxide, bis(2,6-dichlorobenzoyl)-2,5-dimethylphenylphosphine oxide, bis(2,6-dichlorobenzoyl)-4-ethoxyphenylphosphine oxide, bis(2,6-dichlorobenzoyl)-4-biphenylphosphine oxide, bis(2,6-dichlorobenzoyl)-4-propylphenylphosphine oxide, bis(2,6-dichlorobenzoyl)-2-naphthylphosphine oxide, bis(2,6-dichlorobenzoyl)-1-naphthylphosphine oxide, bis(2,6-dichlorobenzoyl)-4-chlorophenylphosphine oxide, bis(2,6-dichlorobenzoyl)-2,2-dimethoxyphenylphosphine oxide, bis(2,6-dichlorobenzoyl)-dodecylphosphine oxide, bis(2,6-dichlorobenzoyl)-4-octylphenylphosphine oxide, bis(2,4,6-trimethylbenzoyl)-dimethylphenylphosphine oxide, bis(2,6-dichloro-3,4,5-trimethoxybenzoyl)-2,5-dimethylphenylphosphine oxide, bis(2,6-dichloro-3,4,5-trimethoxybenzoyl)-4-ethoxyphenylphosphine oxide, bis(2-methyl-1-naphthoyl)-2,5-phenylphosphine oxide, bis(2-methyl-1-naphthoyl)-4-biphenylphosphine oxide, bis(2-methyl-1-naphthoyl)-4-ethoxybiphenylphosphine oxide, bis(2-methyl-1-naphthoyl)-2-ethoxybiphenylphosphine oxide, bis(2-methyl-1-naphthoyl)-4-propylphenylphosphine oxide, bis(2-methyl-1-naphthoyl)-2,5-dimethylphenylphosphine oxide, bis(2-methyl-1-naphthoyl)-4-methoxyphenylphosphine oxide, bis(2,6-dimethoxybanzoyl)-2,4,4-trimethylpentylphosphine oxide, etc. can be provided.

As the specific examples of an acylphosphine oxide compound represented by general formula (5) used for the present invention, 2,4,6-trimethylbenzoyl-diphenylphosphine oxide, 2,6-diphenylbenzoyl-diphenylphosphine oxide, 2,6-dimethoxybenzoyl-diphenylphosphine oxide, 2,3,5,6-tetramethylbenzoyl-diphenylphosphine oxide, 2,6-dichlorobenzoyl-diphenylphosphine oxide, 2,3,6-trimethylbenzoyl-diphenylphosphine oxide, 2-phenyl-6-methylbenzoyl-diphenylphosphine oxide, 2,6-dibromobenzoyl-diphenylphosphine oxide, 2,8-dimethylnaphthalene-1-carbonyl-diphenylphosphine oxide, 1,3-dimethoxynaphthalene-2-carbonyl-diphenylphosphine oxide, methyl ester of 2,4,6-trimethylbenzoyl-phenylphosphinic acid, methyl ester of 2,6-dimethylbenzoyl-phenylphosphinic acid, methyl ester of 2,6-dichlorobenzoyl-phenylphosphinic acid, etc. can be provided.

Among the acylphosphine compounds used as the photo-polymerization initiator in the present invention, compounds represented by the following structural formula P-1, P-2, or P-3 are particularly useful.

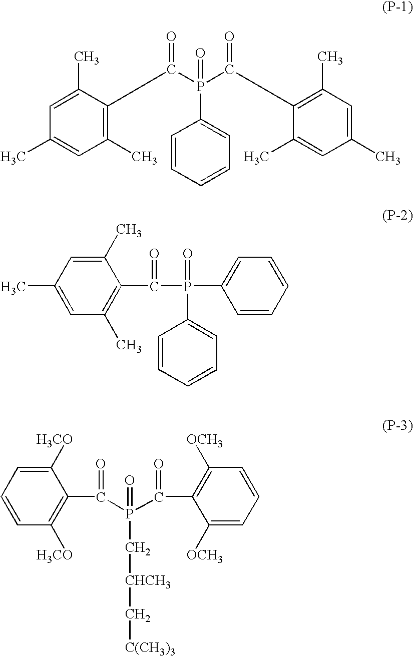

The acylphosphine compound used for the present invention can be used singularly or in combination as a mixture and the content of it is 0.5-40 parts by weight, preferably 0.5-10 parts by weight, per 100 parts by weight of the total content of radical-polymerizable components in a solid content of coating liquid.

The crosslinked surface layer in the present invention is obtained by curing at least the three or more-functional radical-polymerizable monomer having no charge transporting structure and a charge transportation compound having a radical-polymerizable functional group and using the acylphosphine oxide compound as a photo-polymerization initiator. However, a one-functional or two functional radical-polymerizable monomer or radical-polymerizable oligomer can be also used in combination for the purpose of giving a function such as viscosity control at the time of coating liquid preparation, stress relaxation for the crosslinked surface layer, the decrease of surface energy, and the decrease of a friction coefficient. Then, a well-known radical-polymerizable monomer or oligomer can be used.

As the one-functional radical monomer, for example, 2-ethylhexyl acrylate, 2-hydroxyethyl acrylate, 2-hydroxypropyl acrylate, tetrahydrofurfuryl acrylate, 2-ethylhexylCarbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate, styrene monomer, etc, can be provided.

As two functional radical polymerizable monomer, for example, 1,3-butanediol diacrylate, 1,4-butanediol diacrylate, 1,4-butanediol dimethacrylate, 1,6-hexanediol diacrylate, 1,6-hexanediol dimethacrylate, diethyleneglycol diacrylate, neopentylglycol diacrylate, bisphenol A-EO-modified diacrylate, bisphenol F-EO-modified diacrylate, neopentylglycol diacrylate, etc, can be provided.

As the functional monomer, for example, monomers substituted with a fluorine atom such as octafluoropentyl acrylate, 2-perfluorooctylethyl acrylate, 2-perfluorooctylethyl methacrylate, and 2-perfluoroisononylethyl acrylate, and vinyl monomer, acrylates and methacrylates which have a polysiloxane group, such as acryloyl poly(dimethylsiloxane)ethyl, methacryloyl poly(dimethylsiloxane)ethyl, acryloyl poly(dimethylsiloxane)propyl, acryloyl poly(dimethylsiloxane)butyl, and diacryloyl poly(dimethylsiloxane)diethyl, which have 20-70 siloxane repeated units, and are disclosed in Japanese Examined Patent Application No. 5-60503 and Japanese Examined Patent Application No. 6-45770, can be provided.

As the radical-polymerizable oligomer, for example, epoxyacrylate-type oligomer, urethane acrylate-type oligomer, and polyester acrylate-type oligomer can be provided. Herein, if much one-functional or two-functional radical-polymerizable monomer or radical-polymerizable oligomer is contained, the three-dimensional crosslink density of the crosslinked surface layer substantially lowers, so that the abrasive resistance degrades. Therefore, the content of the monomer or oligomer is regulated to be equal to or less than 50 parts by weight, preferably equal to or less than 30 parts by weight, per 100 parts by weight of the three or more-functional radical-polymerizable monomer.

Although the acylphosphine oxide compound is used as a photo-polymerization initiator, another photo-polymerization initiator or a photo-polymerization accelerator can be used singularly or in combination.

As another photo-polymerization initiator, acetophenone-based or ketal-type photo-polymerization initiators such as diethoxyacetophenone, 2,2-dimethoxy-1,2-diphenylethane-1-one, 1-hydroxycyclohexyl-phenylketone, 4-(2 -hydroxyethoxy)phenyl-(2-hydroxy-2-propyl)ketone, 2-benzyl-2-dimethylamino-1-(4-morpholinophenyl)butane-1-one, 2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime, benzoin ether-type photo-polymerization initiators such as benzoin, benzoin methyl ether, benzoin ethyl ether, benzoin isobutyl ether, and benzoin isopropyl ether, benzophenone-based photo-polymerization initiators such as benzophenone, 4-hydroxybenzophenone, methyl o-benzoylbenzoate, 2-benzoylnaphthalene, 4-benzoylbiphenyl, 4-benzoyl phenyl ether, acrylated benzophenone, and 1,4-benzoylbenzene, thioxanthone-based photo-polymerization initiators such as 2-isopropylthioxanthone, 2-chlorothioxanthone, 2,4-dimethylthioxanthone, 2,4-diethylthioxanthone, and 2,4-dichlorothioxanthone, and other photo-polymerization initiators such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methylphenylglyoxy ester, 9,10-phenanthrene, acridine-based compounds, triazine-based compounds, and imidazole-based compounds, can be provided.

In the present invention, the acylphosphine oxide compound is used singularly or in combination with the other photo-polymerization initiator as a photo-polymerization initiator, and commercially available photo-polymerization initiators can be used. Specifically, for example, “Irgacure-1700” (commercial name, produced by Ciba Specialty Chemicals) obtained by mixing 2-hydroxy-2-methyl-1-phenylpropane-1-one (commercial name: Darocur-1173 produced by Ciba Specialty Chemicals) and bis(2,6-dimethoxybenzoyl)-2,4,4-trimethylpentylphosphine oxide (produced by Ciba Specialty Chemicals) at a rate of 75%/25%, “Irgacure-1800” (commercial name, produced by Ciba Specialty Chemicals) obtained by mixing 1-hydroxy-cyclohexyl phenyl ketone (commercial name: Irgacure 184 produced by Ciba Specialty Chemicals) and bis(2,6-dimethoxybenzoyl)-2,4,4-trimethylpentylphosphine oxide (produced by Ciba Specialty Chemicals) at a rate of 75%/25%, “Irgacure-1850” (commercial name, produced by Ciba Specialty Chemicals) obtained by mixing 1-hydroxy-cyclohexyl phenyl ketone (commercial name: Irgacure 184 produced by Ciba Specialty Chemicals) and bis(2,6-dimethoxybenzoyl)-2,4,4-trimethylpentylphosphine oxide (produced by Ciba Specialty Chemicals) at a rate of 50%/50%, bis(2,4,6-trimethylbenzoyl)phenylphosphine oxide (commercial name: Irgacure 819 produced by Ciba Specialty Chemicals), 2,4,6-trimethylbenzoyl-diphenylphosphine oxide (commercial name: Lucirin TPO produced by BASF), “Darocur 4265” (commercial name) obtained by mixing 2-hydroxy-2-methyl-1-phenylpropane-1-one (commercial name: Darocur 1173 produced by Ciba Specialty Chemicals) and 2,4,6-trimethylbenzoyl-diphenylphosphine oxide (commercial name: Lucirin TPO produced by BASF) at a rate of 50%/50%, etc., can be provided.

Also, additives having photo-polymerization accelerating effect can be employed singularly or in combination with the aforementioned photo-polymerization initiator. For example, triethanolamine, methyldiethanolamine, ethyl 4-dimethylaminobenzoate, isoamyl 4-dimethylaminobenzoate, (2-dimethylamino)ethyl benzoate, 4,4′-dimethylaminobenzophenone, etc. can be provided. The content of the additive(s) is 0.5-20 parts by weight, preferably 0.5-10 parts by weight per 100 parts by weight of the total of contents having a radical-polymerization property.

Further, coating liquid used for the present invention can contain an additive such as each kind of plasticizer (for the purpose of stress relaxation or the improvement of adhesive properties), a leveling agent, and a low-molecular-weight charge transportation material having no radical reactivity according to need. For such additives, well-known additives can be used. As the plasticizer, a plasticizer used for a general resin, such as dibutyl phthalate, dioctyl phthalate, etc. can be used and the usage of the plasticizer is equal to or less than 20% by weight, preferably equal to or less than 10% by weight of total solid content contained in coating liquid. Also, as the leveling agent, silicone oils such as dimethylsilicone oil, methylphenylsilicone oil, etc. and a polymer or oligomer that contain a perfluoroalkyl group in a side chain thereof can be used and the usage of the leveling agent is appropriately equal to or less than 3% by weight of total solid content contained in coating liquid.

The crosslinked surface layer is formed by applying and photo-setting coating liquid that contains at least a three or more-functional radical-polymerizable monomer having no charge transporting structure, a charge transportation compound having a radical-polymerizable functional group and an acylphosphine oxide compound as a photo-polymerization initiator in the present invention. When the radical-polymerizable monomer is in a liquid state, such coating liquid in which another component can be dissolved can be coated but coating liquid diluted with solvent is coated according to need. Herein, as the used solvent, alcohols such as methanol, ethanol, propanol, and butanol, ketones such as acetone, ethyl methyl ketone, isobutyl methyl ketone, and cyclohexanone, esters such as ethyl acetate and butyl acetate, ethers such as tetrahydrofuran, dioxane, propylether, halogenated hydrocarbons such as dichloromethane, dichloroethane, trichloroethane, and chlorobenzene, aromatic hydrocarbons such as benzene, toluene, and xylene, and cellosolves such as methylcellosolve, ethylcellosolve, and cellosolve acetate can be provided. The solvents are used singularly or in combination as a mixture. The dilution rate of the coating liquid with the solvent is arbitrary but depends on the solubility of the composition, a coating method, and objective film thickness. The coating can be carried out by means of a dip coating method, a spray coat method, a bead coat method, or a ring coat method.

In the present invention, preferably, after such coating liquid is coated, photo-setting reaction is promoted by light energy irradiation so as to form a crosslinked surface layer. Herein, as the used light energy, an UV light source such as a high-pressure mercury-vapor lamp and a metal halide lamp, which have emission wavelength mainly in a ultraviolet region can be used but a light source having 400 nm or longer emission wavelength corresponding to the absorption wavelength of the acylphosphine oxide compound as a photo-polymerization initiator may be selected. The illuminance of irradiating light is preferably equal to or greater than 50 mW/cm² and equal to or less than 1,000 mW/cm². If the illuminance is less than 50 mW/cm², it takes a long time to complete the curing reaction. If the illuminance is greater than 1,000 mW/cm², the reaction promotes inhomogeneously, so that the irregularities of the surface layer and the degradation of the electric characteristics are enhanced.

Since the film thickness of the crosslinked surface layer used for the present invention depends on the layer structure of the photoconductor in which the crosslinked surface layer is employed, the film thickness is explained in conjunction with a description of the layer structure below.

Now, the layer structure of the photoconductor according to the present invention is described below.

<Layer Structure of an Electrophotographic Photoconductor>

An electrophotographic photocondctor according to the present invention is illustrated based on the drawings.

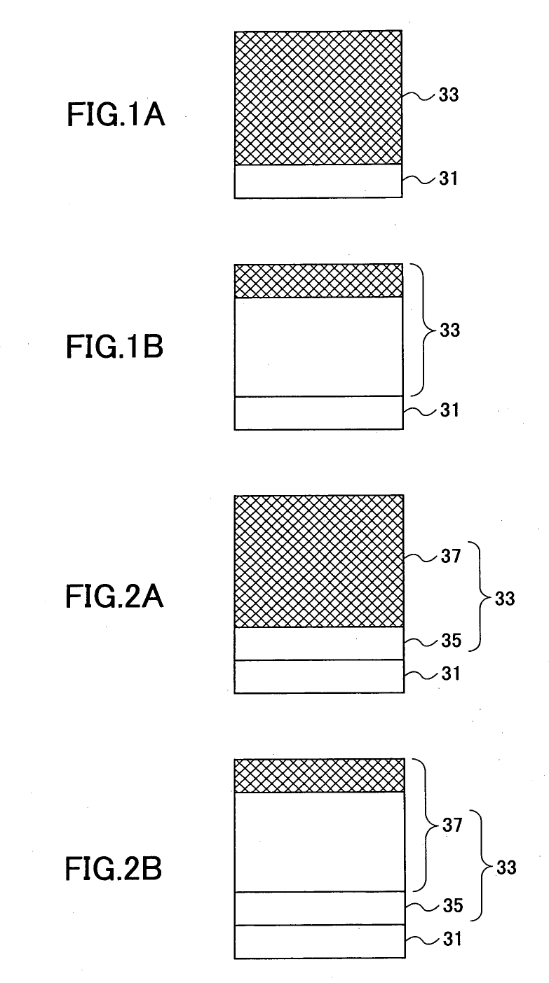

FIGS. 1A and 1B are cross-sectional diagrams illustrating electrophotographic photocondctors having a single layer structure according to the present invention, in which a photoconductive layer (33) having both a charge generation function and a charge transportation function is provided on an electrically conductive support (31). FIG. 1A illustrates a crosslinked surface layer as the whole of a photoconductive layer and FIG. 1B illustrates a crosslinked surface layer as the surface portion of a photoconductive layer.

FIGS. 2A and 2B illustrate electrophotographic photocondctors having a laminated layer structure according to the present invention, in which a charge generation layer (35) having a charge generation function and a charge transportation layer (37) having a charge transportation function are laminated on an electrically conductive support (31). FIG. 2A illustrates a crosslinked surface layer as the whole of a charge transportation layer and FIG. 2B illustrates a crosslinked surface layer as the surface portion of a charge transportation layer.

(Electrically Conductive Support)

As the electrically conductive support (31), an electrically conductive support obtained by applying to a film-shaped or cylindrical plastic or paper, an electrically conductive material with a volumetric resistivity equal to or less than 10¹⁰ Ωcm, for example, a metal such as aluminum, nickel, chromium, nichrome, copper, gold, silver, and platinum, and a metal oxide such as tin oxide and indium oxide by means of vapor-depositing or sputtering, an electrically conductive plate made of aluminum, aluminum alloy, nickel, or stainless, and an electrically conductive pipe produced by applying surface treatment such as cutting, super finishing, and polishing to an unfinished pipe obtained by extruding or drawing aluminum, aluminum alloy, nickel, or stainless can be used. Furthermore, an endless nickel belt and an endless stainless belt can be used as the electrically conductive support (31).

In addition, an electrically conductive support obtained by applying a liquid dispersion that contains electrically conductive powder in a proper binder resin on the aforementioned electrically conductive support can be also used as the electrically conductive support (31) in the present invention.

As the electrically conductive powder, carbon black powder, acetylene black powder, metal powder such as aluminum powder, nickel powder, iron powder, nichrome powder, copper powder, zinc powder, and silver powder, and metal oxide powders such as electrically conductive tin oxide powder and ITO (indium tin oxide) powder, etc. can be provided.

As a binder material that is simultaneously used with the electrically conductive powder, thermoplastic resins, thermosetting resins, and photo-setting resins, such as poly(styrene), styrene-acrylonitrile copolymer, styrene-butadiene copolymer, styrene-maleic anhydride copolymer, polyester, poly(vinyl chloride), vinyl chloride-vinyl acetate copolymer, poly(vinyl acetate), poly(vinylidene chloride), polyallylate resin, phenoxy resin, polycarbonate, cellulose acetate resin, ethylcellulose resin, poly(vinyl butyral), poly(vinyl formal), poly(vinyltoluene), poly(N-vinylcarbazole), acrylic resin, silicone resin, epoxy resin, melamine resin, urethane resin, phenol resin, and alkyd resin can be provided. Such electrically conductive layer can be provided by applying the dispersion liquid obtained by dispersing the electrically conductive powder and the binder resin in a proper solvent such as tetrahydrofuran, dichloromethane, ethyl methyl ketone, and toluene, onto the aforementioned electrically conductive support.

Further, an electrically conductive support obtained by providing an electrically conductive layer made of a heat-shrinkable tubing that contains the aforementioned electrically conductive powder in a material such as poly(vinyl chloride), poly(propylene), polyester, poly(styrene), poly(vinylidene chloride), poly(ethylene), chlorinated rubber, and a polytetrafluoroethylene-based fluorinated resin on a proper cylindrical substrate can be used advantageously as the electrically conductive support (31) in the present invention.

(Photoconductive Layer)

Next, a photoconductive layer is described. The photoconductive layer may have either the laminated structure or the single layer structure.

When the photoconductive layer has a laminated structure, the photoconductive layer includes a charge generation layer having a charge generation function and a charge transportation layer having a charge transportation function. On the other hand, when the photoconductive layer has a single layer structure, the photoconductive layer is a layer having both a charge generation function and a charge transportation function.

Both the photoconductive layer having a laminated layer structure and the photoconductive layer having a single-layer-structure are described below.

<Photoconductive Layer Including a Charge Generation Layer and a Charge Transportation Layer>

(Charge Generation Layer)

A charge generation layer (35) is a layer based on a charge generation material having a charge generation function, for which a binder resin can be used in combination according to need. As the charge generation material, an inorganic charge generation material and an organic charge generation material can be provided.

As the inorganic charge generation material, crystalline selenium, amorphous selenium, selenium-tellurium, a selenium-tellurium-halogen, a selenium-arsenic compound, and amorphous silicon can be provided. Advantageously, the dangling bond of the amorphous silicon may be terminated with a hydrogen atom or a halogen atom and the amorphous silicon may be doped with a boron atom, phosphorus atom, or the like.

On the other hand, as the organic charge generation material, well-known materials can be used. For example, a phthalocyanine-based pigment such as metal phthalocyanine and an azo pigment containing a triphenylamine skeleton, no-metal phthalocyanine, an azulenium salt pigment, a methyl squarate pigment, an azo pigment containing a carbazole skeleton, an azo pigment containing a triphenylamine skeleton, an azo pigment containing a diphenylamine skeleton, an azo pigment containing a dibenzothiophene skeleton, an azo pigment containing a fluorenone skeleton, an azo pigment containing an oxadiazole skeleton, an azo pigment containing a bis(stilbene) skeleton, an azo pigment containing an distyryloxadiazole skeleton, an azo pigment containing an distyrylcarbazole skeleton, a perylene-based pigment, a polycyclic quinone-based pigment such as an anthraquinone-based pigment, a quinoneimine-based pigment, a diphenylmethane-based pigment, a triphenylmethane-based pigement, a benzoquinone-based pigment, a naphthoquinone-based pigment, a cyanine-based pigment, an azomethyne-based pigment, an indigoid-based pigment, and a bis(benzimidazole)-based pigment can be provided. The charge generation materials can be used singularly or in combination as a mixture.

As the binder resin used for the charge generation layer according to need, polyamide, polyurethane, epoxy resin, polyketone, polycarbonate, silicone resin, acrylic resin, poly(vinyl butyral), poly(vinyl formal), poly(vinyl ketone), polystyrene, poly(N-vinylcarbazole), and polyacrylamide can be provided. The binder resins can be used singularly or in combination as a mixture.

In addition, as a binder resin for the charge generation layer, beside the aforementioned binder resin, a polymeric charge transportation material having a charge transportation function, for example, a polymer material such as polycarbonate, polyester, polyurethane, polyether, polysiloxane, and an acrylic resin, all of which have an arylamine skeleton, a benzidine skeleton, a hydrazone skeleton, a carbazole skeleton, a stilbene skeleton, or a pyrazoline skeleton, and a polymer material conatining a polysilane skeleton, can be also used.

Provided as the specific examples of the former are, for example, polymeric charge transportation materials disclosed in Japanese Laid-Open Patent Application No. 01-001728, Japanese Laid-Open Patent Application No. 01-009964, Japanese Laid-Open Patent Application No. 01-013061, Japanese Laid-Open Patent Application No. 01-019049, Japanese Laid-Open Patent Application No. 01-241559, Japanese Laid-Open Patent Application No. 04-011627, Japanese Laid-Open Patent Application No. 04-175337, Japanese Laid-Open Patent Application No. 04-183719, Japanese Laid-Open Patent Application No. 04-225014, Japanese Laid-Open Patent Application No. 04-230767, Japanese Laid-Open Patent Application No. 04-320420, Japanese Laid-Open Patent Application No. 05-232727, Japanese Laid-Open Patent Application No. 05-310904, Japanese Laid-Open Patent Application No. 06-234836, Japanese Laid-Open Patent Application No. 06-234837, Japanese Laid-Open Patent Application No. 06-234838, Japanese Laid-Open Patent Application No. 06-234839, Japanese Laid-Open Patent Application No. 06-234840, Japanese Laid-Open Patent Application No. 06-234841, Japanese Laid-Open Patent Application No. 06-236050, Japanese Laid-Open Patent Application No. 06-236051, Japanese Laid-Open Patent Application No. 06-295077, Japanese Laid-Open Patent Application No. 07-056374, Japanese Laid-Open Patent Application No. 08-176293, Japanese Laid-Open Patent Application No. 08-208820, Japanese Laid-Open Patent Application No. 08-211640, Japanese Laid-Open Patent Application No. 08-253568, Japanese Laid-Open Patent Application No. 08-269183, Japanese Laid-Open Patent Application No. 09-062019, Japanese Laid-Open Patent Application No. 09-043883, Japanese Laid-Open Patent Application No. 09-71642, Japanese Laid-Open Patent Application No. 09-87376, Japanese Laid-Open Patent Application No. 09-104746, Japanese Laid-Open Patent Application No. 09-110974, Japanese Laid-Open Patent Application No. 09-110976, Japanese Laid-Open Patent Application No. 09-157378, Japanese Laid-Open Patent Application No. 09-221544, Japanese Laid-Open Patent Application No. 09-227669, Japanese Laid-Open Patent Application No. 09-235367, Japanese Laid-Open Patent Application No. 09-241369, Japanese Laid-Open Patent Application No. 09-268226, Japanese Laid-Open Patent Application No. 09-272735, Japanese Laid-Open Patent Application No. 09-302084, Japanese Laid-Open Patent Application No. 09-302085, and Japanese Laid-Open Patent Application No. 09-328539.

Also, provided as the specific examples of the latter are, for example, polysilylenes disclosed in Japanese Laid-Open Patent Application No. 63-285552, Japanese Laid-Open Patent Application No. 05-19497, Japanese Laid-Open Patent Application No. 05-70595, and Japanese Laid-Open Patent Application No. 10-73944.

Additionally, a low-molecular-weight charge transportation material can be contained in the charge generation layer (35). As the low-molecular-weight charge transportation material used for the charge generation layer (35), a hole transportation material and an electron transportation material can be provided.

As the electron transportation material, an electron accepting material such as chloroanil, bromoanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and diphenoquinone derivatives can be provided. The electron transportation materials can be used singularly or in combination as a mixture.

As the hole transportation material, an electron donating material as described below can be provided and preferably used. As the hole transportation material, oxazole derivatives, oxadiaxole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bis(stilbene) derivatives, enamine derivatives, and other well-known materials can be provided. The hole transportation materials can be used singularly or in combination as a mixture.

As a representative method for forming the charge generation layer (35), a method of producing a thin film in vacuum and a method of casting from solution or liquid dispersion can be provided.

As the former method, a vapor deposition method, a glow discharge decomposition method, an ion plating method, a sputtering method, a reactive sputtering method, a CVD method can be provided and a charge generation layer that contains either the inorganic charge generation material or the organic charge generation material can be formed well.

When a charge generation layer is formed by the latter casting method, the charge generation layer can be formed by dispersing the inorganic or organic charge generation material, if necessary, with the binder resin, into a solvent such as tetrahydrofuran, dioxane, dioxoran, toluene, dichloromethane, monochlorobenzene, dichloroethane, cyclohexanone, cyclopentanone, anisole, xylene, ethyl methyl ketone, acetone, ethyl acetate, and butyl acetate, by means of ball-mill, AttrIter, sand mill, or beads mill, then moderately diluting the obtained liquid dispersion and applying the appropriately diluted dispersion. Additionally, a leveling agent such as dimethylsilicone oil and methylphenylsilicone oil can be added according to need. Application of coating liquid can be carried out by means of dip coating, spray coating, beads coating, or ring coating.

The film thickness of the charge generation layer provided as described above is appropriately 0.01-5 μm, preferably 0.05-2 μm.

(Charge Transportation Layer)

A charge transportation layer (37) is a layer having a charge transportation function and a crosslinked surface layer having a charge transporting structure is used as the charge transportation layer in the present invention. When the crosslinked surface layer is the whole of a charge transportation layer (37), as described in the aforementioned method of producing a crosslinked surface layer, the crosslinked surface layer is formed by applying coating liquid that contains a radical-polymerizable composition for the present invention (the radical polymerizable monomer having no charge transporting structure and the charge transportation compound having a radical-polymerizable functional group) onto the charge generation layer (35), drying the coating liquid according to need, and initiating a curing reaction due to external energy. Herein, the film thickness of the crosslinked surface layer is 10-30 μm, preferably 10-25 μm. If the film thickness is less than 10 μm, a sufficient charging electrical potential cannot be maintained. On the other hand, if the film thickness is over 30 μm, the crosslinked surface layer easily separates from an under layer due to the volume shrinkage at the time of curing.

When the crosslinked surface layer is formed as the surface portion of a charge transportation layer (37) and the charge transportation layer (37) has a laminated structure, the lower portion of the charge transportation layer can be formed by dissolving or dispersing a charge transportation material having a charge transportation function and a binder resin into a proper solvent, applying the obtained solution or dispersion liquid onto a charge generation layer (35) and drying the applied solution or dispersion liquid. Subsequently, the coating liquid that contains a radical-polymerizable composition for the present invention is applied on the lower portion of a charge transportation layer portion and crosslinked or cured by using external energy so as to obtain a crosslinked surface layer.

As the charge transportation material, the electron transportation materials, the hole transportation materials, and the polymeric charge transportation materials, which are described for the charge generation layer (35), can be used. As described above, the use of the polymeric charge transportation material is particularly useful since the solubility of the lower portion of the charge transportation layer at the time of applying the coating liquid for the crosslinked surface layer can be reduced.

As the binder resin used in combination with the charge transportation material, a thermoplastic resin and a thermosetting resin, such as poly(styrene), styrene-acrylonitrile copolymer, styrene-butadiene copolymer, styrene-maleic anhydride copolymer, polyester, poly(vinyl chloride), vinyl chloride-vinyl acetate copolymer, poly(vinyl acetate), poly(vinylidene chloride), polyallylate resin, phenoxy resin, polycarbonate, cellulose acetate resin, ethylcellulose resin, poly(vinyl butyral), poly(vinyl formal), poly(vinyltoluene), poly(N-vinylcarbazole), acrylic resin, silicone resin, epoxy resin, melamine resin, urethane resin, phenol resin, and alkyd resin can be provided.

The content of the charge transportation material is appropriately 20-300 parts by weight, preferably 40-150 parts by weight per 100 parts by weight of the binder resin. Additionally, when the polymeric charge transportation material is used, the polymeric charge transportation materials can be used singularly or in combination with the binder resin.

As a solvent used in the coating liquid for the lower portion of the charge transportation layer, a solvent for the charge generation layer can be similarly used but a solvent that can dissolve the charge transportation material and the binder resin well is preferable. The solvents may be used singularly or in combination as a mixture. Also, in order to form the lower portion of the charge transportation layer, the coating methods for the charge generation layer (35) can be used similarly.

Additionally, a plasticizer or a leveling agent can be added according to need.

As the palsticizer used for the lower portion of the charge transportation layer, a plasticizer used for a general resin, such as dibutyl phthalate and dioctyl phthalate, can be directly used and the usage of the plasticizer is appropriately 0-30 parts by weight per 100 parts by weight of the binder resin.

As the leveling agent used for the lower portion of the charge transportation layer, silicone oils such as dimethylsilicone oil and methylphenylsilicone oil and a polymer or oligomer containing a perfluoroalkyl group in a side chain thereof can be provided and the usage of the leveling agent is appropriately 0-1 parts by weight per 100 parts by weight of the binder resin.

The film thickness of the lower portion of the charge transportation layer is approximately 5-40 μm, preferably 10-30 μm.

When the crosslinked surface layer is a surface portion of charge transportation layer (37), as described in the aforementioned method of producing a crosslinked surface layer, the crosslinked surface layer is formed by applying the coating liquid that contains a radical-polymerizable composition for the present invention onto the lower portion of the charge transportation layer, drying the applied coating liquid according to need, and initiating a curing reaction due to external thermal or light energy. In this case, the film thickness of the crosslinked surface layer is 1-20 μm, preferably 2-10 μm. If the film thickness is less than 1 μm, the durability of the crosslinked surface layer is variable dependent on the ununiformity of the film thickness. On the other hand, if the film thickness is greater than 20 μm, the film thickness of the whole of a charge transportation layer becomes large, whereby the diffusion of charges increases and the reproducibility of an image decreases.

<Single-Layer Photoconductive Layer>

A single-layer-structure photoconductive layer is a layer having both a charge generation function and a charge transportation function. The crosslinked surface layer having a charge transporting structure used for the present invention contains a charge generation material having a charge generation function and is usefully used as a single-layer-structure photoconductive layer. As described in the method for forming the charge generation layer by means of casting, the crosslinked surface layer is formed by dispersing the charge generation material into coating liquid that contains the radical-polymerizable composition, applying the coating liquid onto a electrically conductive support, drying the applied coating liquid according to need, and initiating a curing reaction by external energy. Herein, liquid dispersion in which the charge generation material is previously dispersed in a solvent may be added into the coating liquid for crosslinked surface layer. In this case, the film thickness of the crosslinked surface layer is 10-30 μm, preferably 10-25 μm. If the film thickness is less than 10 μm, a sufficient charging electrical potential cannot be maintained. On the other hand, if the film thickness is greater 30 μm, the crosslinked surface layer easily separates from an electrically conductive substrate or an underlying layer due to the volume shrinkage at the time of curing.

Also, when the crosslinked surface layer is a surface portion of single-layer-structure photoconductive layer, a lower portion of the photoconductive layer can be formed by dissolving or dispersing a charge generation material having a charge generation function, a charge transportation material having a charge transportation function, and a binder resin into a proper solvent, applying the obtained solution or dispersion liquid onto an electrically conductive support or an underlying layer, and drying the applied solution or dispersion liquid. Additionally, a plasticizer and a leveling agent can be added according to need. For the method of dispersing a charge generation material, the charge generation material, the charge transportation material, a plasticizer, and a leveling agent, those provided for the charge generation layer (35) and the charge transportation layer (37) can be similarly used. As the binder resin, beside the binder resin provided for the charge transportation layer (37), the binder resin provided for the charge generation layer (35) may be used in combination. Also, the aforementioned polymeric charge transportation material can be used and is useful in that mixing of the composition contained in the lower portion of the photoconductive layer into the crosslinked surface layer can be reduced. The film thickness of the lower portion of the photoconductive layer is approximately 5-30 μm, preferably 10-25 μm.

When the crosslinked surface layer is a surface portion of the single-layer-structure photoconductive layer, as described above, the crosslinked surface layer is formed by applying the coating liquid that contains a radical-polymerizable composition for the present invention and the charge generation material onto the lower portion of the photoconductive layer, drying the applied coating liquid according to need, and curing the dried coating liquid due to external thermal or light energy. In this case, the film thickness of the crosslinked surface layer is 1-20 μm, preferably 2-10 μm. If the film thickness is less than 1 μm, the durability of the crosslinked surface layer is variable dependent on the ununiformity of the film thickness. On the other hand, if the film thickness is over 20 μm, the film thickness of the whole of charge transportation layer becomes large, whereby the diffusion of charges increases and the reproducibility of an image decreases.

The content of the charge generation material contained in the single-layer-structure photoconductive layer is preferably 1-30% by weight of the total weight of the photoconductive layer. Also, the content of the binder resin contained in the lower portion of the photoconductive layer is preferably 20-80% by weight of the total weight of the photoconductive layer. Further, the content of the charge transportation material is preferably 10-70% by weight of the total quantity of the photoconductive layer.

<Intermediate Layer>

In the photoconductor according to the present invention, the crosslinked surface layer is a surface portion of photoconductive layer, an intermediate layer can be provided between the crosslinked surface layer and the lower portion of the photoconductive layer for the purpose of suppressing the mixing of a component of the lower portion into the crosslinked surface layer or improving the adhesive property of the crosslinked surface layer to the lower portion. The intermediate layer prevents the inhibition of the curing reaction and the generation of irregularities of the crosslinked surface layer, which are caused by the mixing of the composition contained in the lower portion of the photoconductive layer into the outermost surface layer that contains the radical-polymerizable composition. Also, the adhesive property of the crosslinked surface layer to the lower portion of the photoconductive layer can be improved.

The intermediate layer is generally based on a binder resin. As such binder resin, polyamide, alcohol-soluble nylon, water-soluble poly(vinyl butyral), poly(vinyl butyral), and poly(vinyl alcohol) can be provided. As a method for forming an intermediate layer, a commonly used coating method is employed as described above. Additionally, the thickness of the intermediate layer is appropriately 0.05-2 μm.

<Underlying Layer>

In the photoconductor according to the present invention, an underlying layer can be provided between the electrically conductive support (31) and the photoconductive layer. Although the underlying layer is generally based on a resin, such resin is desirably a resin having a high solvent resistance against a general organic solvent, taking the application of coating liquid for photoconductive layer in a solvent on the underlying layer into consideration. As such resin, a water-soluble resin such as poly(vinyl alcohol), casein, and poly(sodium acrylate), an alcohol-soluble resin such as copolymerized nylon and methoxymethylated nylon, and a curing-type resin in which a three-dimensional network structure such as polyurethane, melamine resin, phenol resin, alkyd-melamine resin, and epoxy resin can be provided. In addition, a fine powder pigment of a metal oxide such as titanium oxide, silica, alumina, zirconium oxide, tin oxide, indium oxide, etc., may be added into the underlying layer for preventing the generation of a moire pattern and reducing the residual electric potential.

The underlying layer can be formed be using a proper solvent and a coating method as used for the aforementioned photoconductive layer. Further, a silane coupling agent, titanium coupling agent, chromium coupling agent, etc. can be used for the underlying layer in the present invention. Beside the aforementioned underlying layer, Al₂O₃ provided by anodic oxidation, an underlying layer made of an organic material such as poly(para-xylylene) (parylene) or an inorganic material such as SiO₂, SnO₂, TiO₂, ITO, and CeO₂, by using a method of producing a thin film in vacuum, and a well-known underlying layer can be used well as the underlying layer in the present invention. The thickness of the underlying layer is appropriately 0-5 μm.

<Addition of Antioxidant Into Each Layer>

In the present invention, an antioxidant can be added into each of the layers such as the crosslinked surface layer, the charge generation layer, the charge transportation layer, the underlying layer, and the intermediate layer, for improving an environmental resistance and, particularly, the preventing the degradation of the photosensitivity and the elevation of the residual electric potential.

As the antioxidant used for the present invention, the following antioxidants can be provided.

(Phenol-Based Compounds)
2,6-di-t-butyl-p-crezol, butylated hydroxyanisole, 2,6-di-t-butyl-4-ethylphenol, stearyl β-(3,5-di-t-butyl-4-hydroxyphenyl)propionate, 2,2′-methylene-bis(4-methyl-6-t-butylphenol), 2,2′-methylene-bis(4-ethyl-6-t-butylphenol), 4,4′-thiobis(3-methyl-6-t-butylphenol), 4,4′-butylidene-bis(3-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis[methylene-3-(3′,5′-di-t-butyl4′-hydroxyphenyl)propionate]methane, bis[3,3′-bis(4′-hydroxy-3′-t-butylphenyl)butyric acid] glycol ester, tocopherols, etc.

(Paraphenylenediamines)
N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

(Hydroquinones)
2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone, etc.

(Organic Sulfur Compounds)
dilauryl-3,3′-thiodipropionate, distearyl-3,3′-thiodipropionate, ditetradecyl-3,3′-thiodipropionate, etc.

(Organic Phosphorus Compounds)
triphenylphosphine, tri(nonylphenyl)phosphine, tri(dinonylphenyl)phosphine, tricresylphosphine, tri(2,4-dibutylphenoxy)phosphine, etc.

These compounds are well known as antioxidants for rubbers, plastics, fats and fatty oils and a commercially available product thereof can be easily obtained.

In the present invention, the content of the antioxidant is 0.01-10% by weight of the total weight of a layer to which the antioxidant is added.

<Image Formation Method and Apparatus>

Next, an image formation method and an image formation apparatus according to the present invention are illustrated in detail based on the drawings.

The image formation method and the image formation apparatus according to the present invention involve the use of a photoconductor having a smooth charge-transporting crosslinked surface layer and a process including, for example, at least, a charging step, an image-wise light exposure step, and a developing step for the photoconductor, and subsequently, a transcription step and a fixing step, which transcribes and fixes a toner image to an image supporter (a transcription paper), respectively, and a cleaning step of cleaning the surface of the photoconductor. However, in an image formation method in which an electrostatic latent mage is directly transcribed onto and developed on a transcription medium, not all the steps in the process for the photoconductor is required.

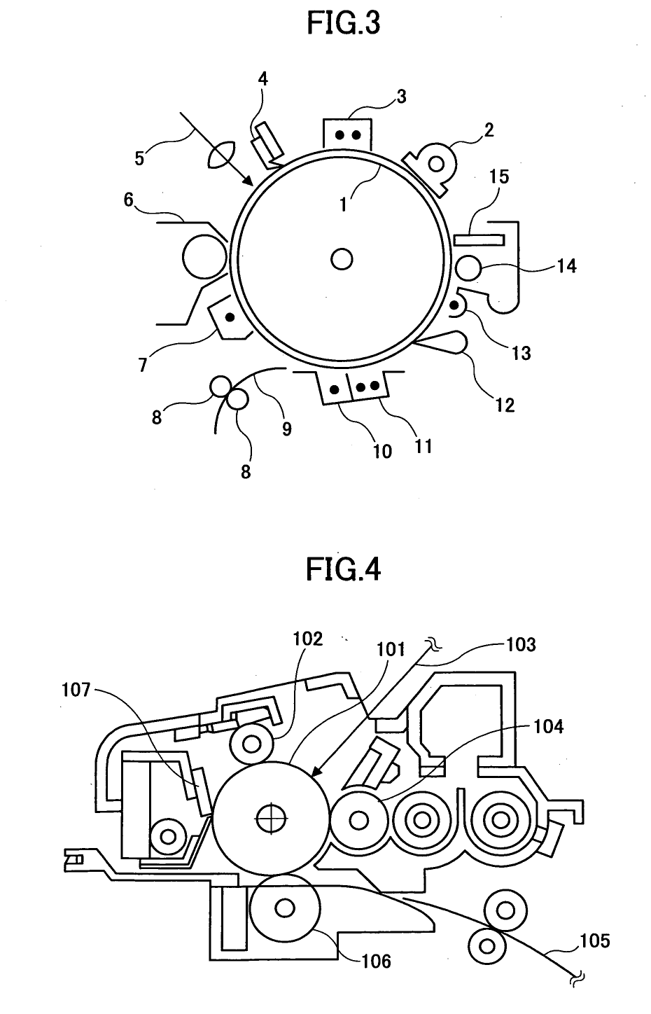

FIG. 3 is a schematic diagram illustrating an example of the image formation apparatus. An electrically charging charger (3) is employed as means for uniformly charging the photoconductor. As the charging means, a corotron device, a scorotron device, a solid discharge device, a needle electrode device, a roller charging device, and an electrically conductive brush device can be employed and well-known charging methods can be used.

Particularly, the present invention is useful when charging means are used such that the composition of the photoconductor is decomposed by means of proximity discharge caused by the charging means that uses a contact charging process or a non-contact proximity charging process. Herein, the contact charging process is a charging process such that a charging roller, charging brush, charging blade, or the like directly contacts a photoconductor. On the other hand, the proximity charging process is, for example, a charging process using a charging roller configured proximally or in a non-contacting state so that an air gap of 200 μm or less is provided between the charging means and a photoconductor surface. If the air gap is too large, the charging tends to be unstable. If the air gap is too small, the surface of a charging member may be contaminated when toner remains on a photoconductor. Therefore, the air gap is appropriately in a range of 10-200 μm, preferably in a range of 10-100 μm.

Next, an image-wise light exposure part (5) is employed for forming an electrostatic latent image on the uniformly charged photoconductor (1). As a light source of the image-wise light exposure part, all light emitters such as a fluorescent lamp, a tungsten lamp, a halogen lamp, a mercury vapor lamp, a sodium vapor lamp, a light-emitting diode (LED), a semiconductor laser diode (LD), and an electroluminescent (EL) device can be used. Additionally, in order to irradiate the photoconductor with light of a desired wavelength region, each kind of filters such as a sharp cut filter, a bandpass filter, a near-infrared cut filter, a dichroic filter, an interference filter, and a color conversion filter can be employed.

Next, a development unit (6) is used for visualizing the electrostatic latent image formed on the photoconductor (1). As a development method, a one-component development method and a two-component development method, which use dry-type toner, and a wet-process development method, which uses wet-type toner, can be provided. When positive (negative) charging is applied on the photoconductor and image-wise light exposure is performed, a positive (negative) electrostatic latent image is formed on the surface of the photoconductor. When the electrostatic latent image is developed with negatively (positively)-charged toner (charge detecting fine particles), a positive image can be obtained. On the contrary, when the electrostatic latent image is developed with positively (negatively)-charged toner, a negative image can be obtained.

Next, a transcription charger 10 is used for transcribing the visualized toner image on the photoconductor to a transcription medium (9). In addition, a pre-transcription charger (7) may be used in order to perform better transcription. As these transcription means, electrostatic transcription means such as a transcription charger and a bias roller, mechanical transcription means such as adhesion transcription means and pressure transcription means, and magnetic transcription means can be used. As the electrostatic transcription means, the aforementioned charging means can be also used.

Next, as means for separating the transcription medium (9) from the photoconductor (1), a separation charger (11) and a separation claw (12) can be used. As other separation means, an electrostatic adsorption induced separation means, side end belt separation means, a tip grip conveyor, and curvature separation means, etc., can be used. As the separation charger (11), the aforementioned charging means can be also used.

Next, a fur brush (14) and a cleaning blade (15) can be used for cleaning the photoconductor on which the toner remains after the transcription. In addition, a pre-cleaning charger (13) can be employed in order to perform more efficient cleaning. As other cleaning means, web cleaning means, magnetic brush means, etc., can be used. The cleaning means can be used singularly or in combination.

Next, a charge elimination means may be used for eliminating the latent image remaining on the photoconductor according to need. As the charge elimination means, a charge elimination lamp (2) and a charge elimination charger can be used, and the aforementioned light source for light exposure and the aforementioned charging means can be used, correspondingly.

Otherwise, as original copy reading means, paper feeding means, fixing means, and paper delivering means, which are not adjacent to the photoconductor, well-known means can be used for each means.

The image formation method and the image formation apparatus according to the present invention use the electrophotographic photoconductor according to the present invention in an image formation means as mentioned above.

The image formation means may be incorporated and fixed in a copying machine, a facsimile machine, or a printer. However, the image formation means may be incorporated in the aforementioned apparatus as a process cartridge, which are attachable and detachable from the main body of the apparatus. An example of the process cartridge is illustrated in FIG. 4.

A process cartridge for image formation apparatus incorporates a photoconductor (101), and at least one of charging means (102), developing means (104), transcription means (106), cleaning means (107), and charge elimination means (not illustrated in the drawings) and a unit (a component) that is attachable and detachable from the main body of an image formation apparatus.

In an image formation process using a unit illustrated in FIG. 4, the photoconductor (101) rotates along a direction denoted by an arrow and an electrostatic latent image is formed on the surface of the photoconductor by charging with charging means (102) and light exposure with light exposure means (103), which electrostatic latent image corresponds to a light exposure image. The electrostatic latent image is developed by the develop means (104) and the toner-developed image is transcribed onto a transcription medium (105) by using transcription means (106) and printed out. Subsequently, the surface of the photoconductor after the image transcription is cleaned by cleaning means 107 and is charge-eliminated by charge elimination means (not illustrated in the drawings). Again, the process as described above is repeated.

The present invention also provides a process cartridge for image formation apparatus, in which a photoconductor having a smooth charge transporting crosslinked surface layer and at least one of charging means, developing means, transcription means, cleaning means, and charge elimination means are integrated.

As apparent from the above description, an electrophotographic photoconductor according to the present invention is not only utilized in an electrophotographic copying machine but also can be widely used in the field of an electrophotograhic application such as a laser beam printer, a CRT printer, a LED printer, a liquid crystal printer, a laser plate making, etc.

(Synthesis Example of a Charge Transportation Compound Having a Radical-Polymerizable Functional Group)

For example, a compound having a charge transporting structure used for the present invention can be synthesized by a method disclosed in Japanese Patent No. 3164426, one example of which is described below.

(1) The Synthesis of a Hydroxyl-Group-Substituted Triarylamine Compound (Represented by the Following Structural Formula B)

A 240 ml of sulfolane was added into a 113.85 g (0.3 mol) of a methoxy-group-substituted triarylamine compound (represented by the following structural formula A) and a 138 g (0.92 mol) of sodium iodide and the mixture was heated to 60° C. in nitrogen stream. A 99 g (0.91 mol) of chlorotrimethylsilane was dropped into the liquid for 1 hour and stirring for 4 and half hours was performed at the temperature of approximately 60° C. so as to complete the reaction. An approximately 1.5 L of toluene was added into the reaction liquid, which was cooled to the room temperature and washed with water or an aqueous solution of sodium carbonate repeatedly. Then, solvent was removed from the toluene solution and the purification by a column chromatographic treatment (adhesion medium; silica gel, developing solvent; toluene:ethyl acetate=20:1) was carried out. Cyclohexane was added into an obtained pale-yellow oil so as to precipitate a crystal. Thus, an 88.1 g (yield=80.4%) of white crystal represented by the following structural formula B was obtained.

Melting point: 64.0° C.-66.0° C.

TABLE 1
Results of elemental analysis (%)

| | C | H | N |
|---|---|---|---|
| Found value | 85.06 | 6.41 | 3.73 |
| Calculated value | 85.44 | 6.34 | 3.83 |

Structural formula A

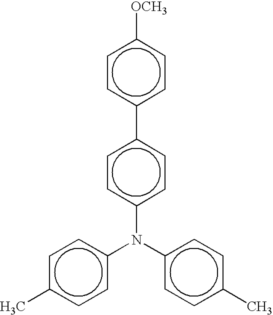

Structural formula B

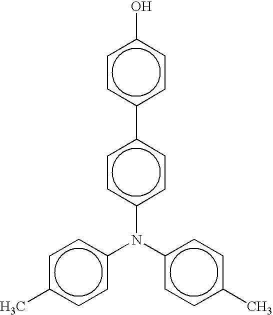

(2) Triarylamino-Group-Substituted Acrylate Compound (Illustrated Compound No. 54)

An 82.9 g (0.227 mol) of the hydroxyl-group-substituted triarylamine compound (structural formula B) obtained in (1) above was dissolved in a 400 ml of tetrahydrofuran and an aqueous solution of sodium hydroxide (NaOH: 12.4 g, water: 100 ml) was dropped into the terahydrofuran solution in nitrogen stream. The obtained solution was cooled to 5° C. and a 25.2 g (0.272 mol) of acryloyl chloride was dropped into the solution for 40 minutes. Then, stirring for 3 hours was performed at 5° C. to complete the reaction. Water was poured into the reaction liquid and extraction with toluene was performed. The extracted liquid was washed with an aqueous solution of sodium bicarbonate or water repeatedly. Then, solvent was removed from the toluene solution and the purification by a column chromatographic treatment (adhesion medium; silica gel, developing solvent; toluene) was carried out. n-hexane was added into an obtained colorless oil so as to precipitate a crystal. Thus, an 80.73 g (yield=84.8%) of a white crystal of illustrated compound No. 54 was obtained.

Melting point: 117.5° C.-119.0° C.

TABLE 2
Results of elemental analysis (%)

| | C | H | N |
|---|---|---|---|
| Found value | 83.13 | 6.01 | 3.16 |
| Calculated value | 83.02 | 6.00 | 3.33 |

Next, the present invention is further explained by examples in detail but the present invention is not limited to the following examples. Herein, all “part” used in the examples mean “part by weight”.

### EXAMPLE 1

Coating liquid for underlying layer, coating liquid for charge generation layer, and coating liquid for charge transportation layer, which had the following compositions, were applied on an aluminum cylinder with φ 30 mm in order and dried so as to form an underlying layer with 3.5 μm, a charge generation layer with 0.2 μm, and a charge transportation layer with 18 μm. Then, coating liquid for crosslinked surface layer that had the following composition was spray-coated on the charge transportation layer and light irradiation was performed by using a metal halide lamp 120 W/cm under the conditions of an illuminance of 350 mW/cm², and an irradiation time of 15 seconds. Further, the drying was performed at 130° C. for 20 minutes so as to form a crosslinked surface layer with 6 μm. Thus, an electrophotographic photoconductor according to the present invention was obtained.

[Coating Liquid for Underlying Layer]
Alkyd resin: 6 parts
(Beckosol 1307-60-EL produced by DAINIPPON INK AND CHEMICALS, INCORPORATED)
Melamine resin: 4 parts
(Superbeckamine G-821-60 produced by DAINIPPON INK AND CHEMICALS, INCORPORATED)
Titanium oxide: 40 parts
Ethyl methyl ketone: 50 parts

[Coating Liquid for Charge Generation Layer]
Bisazo pigment having the following structure (I): 2.5 parts 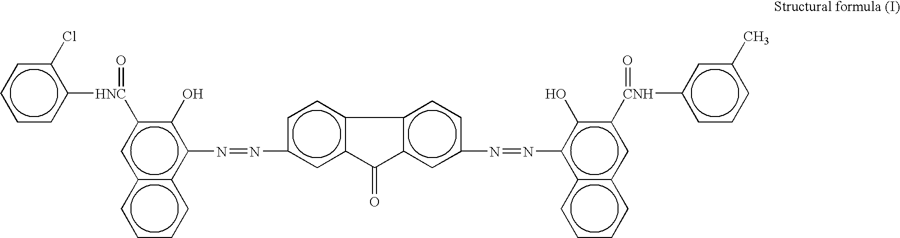
Polyvinyl butyral: 0.5 parts
(XYHL produced by UCC)
Cyclohexanone: 200 parts
Ethyl methyl ketone: 80 parts

[Coating Liquid for Charge Transportation Layer]
Bisphenol Z polycarbonate: 10 parts
(Panlite TS-2050 produced by TEIJIN CHEMICALS LTD.)
Low-molecular-weight charge transportation material (D-1) having the following structure (II): 7 parts 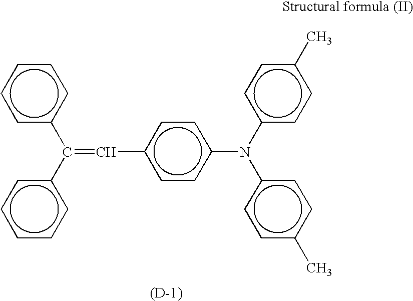
Tetrahydrofuran: 100 parts
Tetrahydrofuran solution with 1% of silicone oil: 0.2 parts
(KF50-100CS produced by Shin-Etsu Chemical Co., Ltd.)

[Coating Liquid for Crosslinked Surface Layer]
Three or more-functional radical-polymerizable monomer having no charge transporting structure: 10 parts
Trimethylolpropane triacrylate
(KAYARAD TMPTA produced by NIPPON KAYAKU CO., LTD.)
Molecular weight: 296
Number of functional groups: 3 functionalities
Charge transportation compound having a radical-polymerizable functional group: 7.5 parts

(Illustrated Compound No. 54)
Photo-polymerization initiator: 0.6 parts
Irgacure 819 (produced by Ciba Specialty Chemicals)

(Acylphosphine Oxide Compound)
bis(2,4,6-trimethylbenzoyl)-phenylphosphine oxide 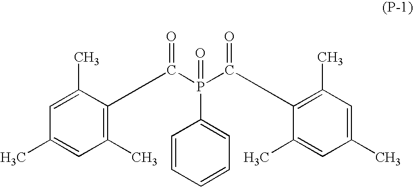
Tetrahydrofuran: 100 parts

### EXAMPLE 2

An electrophotographic photoconductor was manufactured similar to example 1 except that the photo-polymerization initiator in example 1 was changed to an acylphosphine oxide compound having the following structure.
Photo-polymerization initiator: 0.6 parts
Lucirin TPO (produced by BASF)

(Acylphosphine Oxide Compound)
2,4,6-trimethylbenzoyl-diphenylphosphine oxide

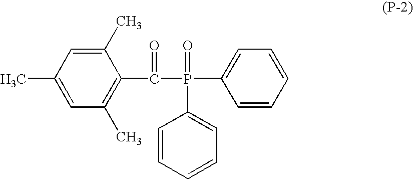

### EXAMPLE 3

An electrophotographic photoconductor was manufactured similar to example 1 except that the photo-polymerization initiator in example 1 was changed to a mixture of photo-polymerization initiators that contain an acylphosphine oxide compound having the following structure.
Mixed photo-polymerization initiators: 0.6 parts
Irgacure-1700 (produced by Ciba Specialty Chemicals)

(Acylphosphine Oxide Compound)
bis(2,6-dimethoxybenzoyl)-2,4,4,-trimethylpentylphosphine oxide: 25%

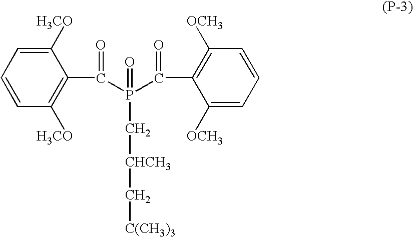

(Another Photo-Polymerization Initiator)
2-hydroxy-2-methyl-1-phenylpropane-1-one: 75%

### EXAMPLE 4

An electrophotographic photoconductor was manufactured similar to example 1 except that the photo-polymerization initiator in example 1 was changed to a mixture of photo-polymerization initiators that contain an acylphosphine oxide compound having the following structure.
Mixed photo-polymerization initiators: 0.6 parts
Irgacure-1800 (produced by Ciba Specialty Chemicals)

(Acylphosphine Oxide Compound)
bis(2,6-dimethoxybenzoyl)-2,4,4,-trimethylpentylphosphine oxide: 25% 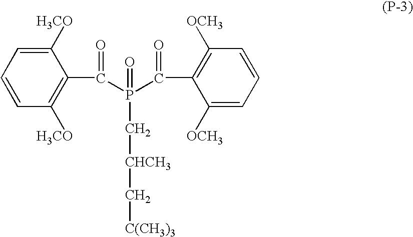
(Another Photo-Polymerization Initiator)
1-hydroxy-cyclohexyl-phenylketone: 75%<

### EXAMPLE 5

An electrophotographic photoconductor was manufactured similar to example 1 except that the photo-polymerization initiator in example 1 was changed to a mixture of photo-polymerization initiators that contain an acylphosphine oxide compound having the following structure.
Mixed photo-polymerization initiators: 0.6 parts
Irgacure-1850 (produced by Ciba Specialty Chemicals)

(Acylphosphine Oxide Compound)
bis(2,6-dimethoxybenzoyl)-2,4,4,-trimethylpentylphosphine oxide: 50%

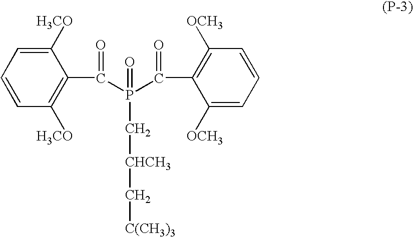

(Another Photo-Polymerization Initiator)
1-hydroxy-cyclohexyl-phenylketone: 50%<

### EXAMPLE 6

An electrophotographic photoconductor was manufactured similar to example 1 except that the three or more-functional radical-polymerizable monomer having no charge transporting structure contained in the coating liquid for crosslinked surface layer in example 1 was changed to the following monomer.
Three or more-functional radical-polymerizable monomer having no charge transporting structure: 10 parts
di-penta-erythritol hexaacrylate
(KAYARAD DPHA produced by NIPPON KAYAKU CO., LTD.)
Average molecular weight: 536
Number of functional groups: 5.5 functionalities

### EXAMPLE 7

An electrophotographic photoconductor was manufactured similar to example 1 except that the three or more-functional radical-polymerizable monomer having no charge transporting structure contained in the coating liquid for crosslinked surface layer in example 1 was changed to a mixture of the following two kinds of monomers.
Three or more-functional radical-polymerizable monomer having no charge transporting structure: 5 parts
Trimethylolpropane triacrylate
(KAYARAD TMPTA produced by NIPPON KAYAKU CO., LTD.)
Molecular weight: 296
Number of functional groups: 3 functionalities
Three or more-functional radical-polymerizable monomer having no charge transporting structure: 5 parts
Caprolactone-modified di-penta-erythritol hexaacrylate
(KAYARAD DPCA-120 produced by NIPPON KAYAKU CO., LTD.)
Molecular weight: 1947
Number of functional groups: 6

### EXAMPLE 8

An electrophotographic photoconductor was manufactured similar to example 1 except that the charge transportation compound having a radical-polymerizable functional group contained in the coating liquid for crosslinked surface layer in example 1 was changed to 7.5 parts of illustrated compound No. 25.

### EXAMPLE 9

An electrophotographic photoconductor was manufactured similar to example 1 except that the charge transportation compound having a radical-polymerizable functional group contained in the coating liquid for crosslinked surface layer in example 1 was changed to 7.5 parts of illustrated compound No. 184.

<Comparison 1>

An electrophotographic photoconductor was manufactured similar to example 1 except that the photo-polymerization initiator in example 1 was changed to a compound having the following structure (I-1).
Photo-polymerization initiator: 0.6 parts
4,4′-bis(dimethylamino)benzophenone [Michler's ketone] (produced by Tokyo Kasei Kogyo Co., Ltd.)

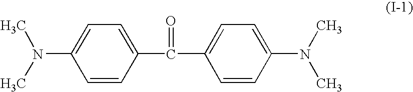

<Comparison 2>

An electrophotographic photoconductor was manufactured similar to example 1 except that the photo-polymerization initiator in example 1 was changed to a compound having the following structure (I-2).
Photo-polymerization initiator: 0.6 parts
Carbazole-phenone-based initiator
Adeka Optomer N-1414 (produced by ASAHI DENKA Co., Ltd.)

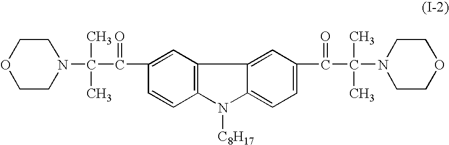

<Comparison 3>

An electrophotographic photoconductor was manufactured similar to example 1 except that the photo-polymerization initiator in example 1 was changed to a compound having the following structure (I-3).
Photo-polymerization initiator: 0.6 parts
2-methyl-1-[4-(methylthio)phenyl]-2-morpholinopropane-1-one
Irgacure-907 (produced by Ciba Specialty Chemicals)

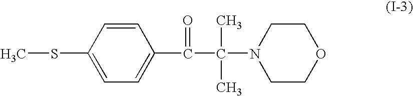

<Comparison 4>

An electrophotographic photoconductor was manufactured similar to example 1 except that the photo-polymerization initiator in example 1 was changed to a compound having the following structure (I-4).
Photo-polymerization initiator: 0.6 parts
2-benzyl-2-dimethylamino-1-(4-morpholinophenyl)-butane-1-one
Irgacure-369 (produced by Ciba Specialty Chemicals)

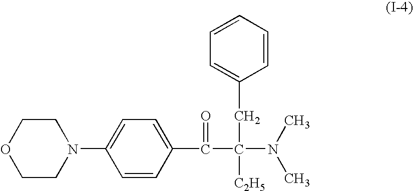

<Comparison 5>

An electrophotographic photoconductor was manufactured similar to example 1 except that the photo-polymerization initiator in example 1 was changed to a compound having the following structure (I-5).
Photo-polymerization initiator: 0.6 parts
2-hydroxy-2-methyl-1-phenyl-1-propane-1-one
Darocure 1173 (produced by Ciba Specialty Chemicals)

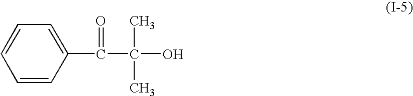

<Comparison 6>

An electrophotographic photoconductor was manufactured similar to example 1 except that the photo-polymerization initiator in example 1 was changed to a compound having the following structure (I-6).
Photo-polymerization initiator: 0.6 parts
benzoin
(produced by Tokyo Kasei Kogyo Co., Ltd.)

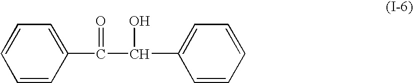

<Comparison 7>

An electrophotographic photoconductor was manufactured similar to example 1 except that the photo-polymerization initiator in example 1 was changed to the compound (I-5) in comparison 5 and the conditions of light irradiation were changed to a metal halide lamp 160 W/cm, an illuminance of 700 mW/cm², and an irradiation time of 120 seconds.

<Comparison 8>

An electrophotographic photoconductor was manufactured similar to example 1 except that the three or more-functional radical-polymerizable monomer having no charge transporting structure contained in the coating liquid for crosslinked surface layer in example 1 was changed to the following two-functional radical-polymerizable monomer having no charge transporting structure.
Two-functional radical-polymerizable monomer having no charge transporting structure: 10 parts
1,6-hexanediol diacrylate (produced by Wako Pure Chemical Industries, Ltd.)
Molecular weight: 226
Number of functional groups: 2 functionalities

<Comparison 9>

An electrophotographic photoconductor was manufactured similar to example 1 except that the three or more-functional radical-polymerizable monomer having no charge transporting structure as a component of the coating liquid for crosslinked surface layer in example 1 was not contained and the content of the charge transportation compound having a radical-polymerizable functional group was changed to 17.5 parts.

<Comparison 10>

An electrophotographic photoconductor was manufactured similar to example 1 except that the charge transportation compound having a radical-polymerizable functional group as a component of the coating liquid for crosslinked surface layer in example 1 was not contained and the content of the three or more-functional radical-polymerizable monomer having no charge transporting structure was changed to 17.5 parts.

<Comparison 11>

An electrophotographic photoconductor was manufactured similar to example 1 except that the charge transportation compound having a radical-polymerizable functional group as a component of the coating liquid for crosslinked surface layer in example 1 was not contained and, instead, 7.5 parts of low-molecular-weight charge transportation material (D-1) represented by structural formula (II) used for the coating liquid for charge transportation layer was contained in of the coating liquid for crosslinked surface layer.

<Comparison 12>

An electrophotographic photoconductor was manufactured similar to example 1 except that the crosslinked surface layer in example 1 was not provided and the thickness of the charge transportation layer was changed to 24 μm.

<Surface Smoothness Test>

For the measurement of the smoothness of a photoconductor surface, surface roughness Rz (ten point height of irregularities, JIS B0601-1994 standard) of the samples and the comparisons was measured under the conditions of a evaluation length of 2.5 mm and a gage length of 0.5 mm by using SURFCOM 1400D (produced by TOKYO SEIMITSU Co., Ltd.). The measurement was made at three points that were at 50 mm from both edges of the photoconductor drum and at the center of the drum along the axial direction thereof, for each of four radial directions of the drum which directions were perpendicular or parallel to each other. That is, the measurement for the example or the comparison was made at 12 points in total and the surface roughness Rz of the example or the comparison was an average of the measurement values at the 12 points.

<Curing Test>

As an index of the promotion of curing in the closslinked surface layer on the example or the comparison, a solubility test against an organic solvent was performed. A drop of tetrahydrofuran (referred to as THF, below) or dichloromethane (referred to as MDC, below) was dropped onto the photoconductor of the example or the comparison. Then, the deformation of the surface of the photoconductor after air-drying was visually observed. A portion of the surface in which the curing was not promoted was dissolved so that a ring-shaped irregularity or a haze was created.

<Durability Test>

The photoconductor of the example or the comparison was inserted on a process cartridge for image formation apparatus and an initial electric potential at a dark portion of the photoconductor was set to −700 V in a remodeled imagio Neo 270 produced by Ricoh Company, Ltd. using a semiconductor laser of 655 nm as a light source for image-wise light exposure. Then, a continuous printing test was carried out using A4 size papers up to 30,000 printings if possible and image evaluations were performed initially and every 5,000 printings. However, if image quality degraded significantly, the continuous printings were stopped so as to end the test. As electric characteristics of the photoconductor, electric potentials at a dark portion and a light-exposed portion were measured initially and at the end of the continuous printings. Also, film thickness of the photoconductor was measured initially and at the end of the continuous printings and a decrement of the film thickness was calculated from the difference of the initial film thickness and the film thickness at the end of the printings.

For the photoconductors of examples 1-9 and comparisons 1-10, the values of surface roughness Rz of the photoconductor were measured at the time of manufacturing and after continuous printings for durability test was stopped or ended. The obtained results are shown in Table 3-1.

The results of the solubility tests against the organic solvents for the photoconductors of examples 1-9 and comparisons 1-10 are also shown in Table 3-2.

TABLE 3-1

| | Surface | Surface roughness |
|---|---|---|
| | roughness Rz at | Rz after continuous |
| | the time of | printings for |
| | manufacturing | durability test |
| Photoconductor | (μm) | (μm) |
| Example 1 | 0.18 | 0.35 |
| Example 2 | 0.27 | 0.42 |
| Example 3 | 0.35 | 0.50 |
| Example 4 | 0.33 | 0.45 |
| Example 5 | 0.31 | 0.42 |
| Example 6 | 0.36 | 0.43 |
| Example 7 | 0.25 | 0.33 |
| Example 8 | 0.22 | 0.39 |
| Example 9 | 0.56 | 0.74 |
| Comparison 1 | 0.20 | Initially stopped |
| Comparison 2 | 0.24 | 0.28 |
| Comparison 3 | 0.21 | 0.33 |
| Comparison 4 | 0.23 | 0.31 |
| Comparison 5 | 1.26 | 1.85 |
| Comparison 6 | 1.18 | 1.66 |
| Comparison 7 | 0.24 | 0.40 |
| Comparison 8 | 0.21 | 1.23 |
| Comparison 9 | 0.35 | 3.52 |
| Comparison 10 | 0.26 | 0.30 |
| Comparison 11 | 1.64 | 2.28 |
| Comparison 12 | <0.10 | 1.43 |

TABLE 3-2

Solubility tests

| Photoconductor | THF | MDC |
|---|---|---|
| Example 1 | Insoluble | Insoluble |
| Example 2 | Insoluble | Insoluble |
| Example 3 | Insoluble | Insoluble |
| Example 4 | Insoluble | Insoluble |
| Example 5 | Insoluble | Insoluble |
| Example 6 | Insoluble | Insoluble |
| Example 7 | Insoluble | Insoluble |
| Example 8 | Insoluble | Insoluble |
| Example 9 | Insoluble | Insoluble |
| Comparison 1 | Insoluble | Insoluble |
| Comparison 2 | Insoluble | Insoluble |
| Comparison 3 | Insoluble | Insoluble |
| Comparison 4 | Insoluble | Insoluble |
| Comparison 5 | Soluble | Soluble |
| Comparison 6 | Soluble | Soluble |
| Comparison 7 | Insoluble | Insoluble |
| Comparison 8 | Slightly soluble | Slightly soluble |
| Comparison 9 | Soluble | Soluble |
| Comparison 10 | Insoluble | Insoluble |
| Comparison 11 | Soluble | Soluble |
| Comparison 12 | Soluble | Soluble |

It is found that the photoconductors of examples 1-9 according to the present invention had good surface smoothness before or after the durability test and high durability against damages. Also, photoconductors of examples 1-9 according to the present invention were insoluble to the organic solvents and a dense three-dimensional network structure was formed by the promotion of curing. On the contrary, the photoconductors of comparisons 5 and 6 in which a general initiator with a short absorption wavelength was used for the crosslinked surface layer, the photoconductor of comparison 8 in which a two-functional monomer was used for the crosslinked surface layer, the photoconductor of comparison 9 in which only a charge transportation compound having a radical-polymerizable functional group was used for the crosslinked surface layer, and the photoconductor of comparison 11 in which a low-molecular-weight charge transportation material was used for the crosslinked surface layer, were insoluble against the organic solvents and the curing of the crosslinked surface layer was insufficient. Also, the photoconductors of comparisons 5 and 6 had a bad surface smoothness due to slow curing, and the photoconductor of comparison 11 had a bad surface smoothness due to the precipitation of a low-molecular-weight charge transportation material. Also, the photoconductors of comparisons 5, 6, 8, 9, and 11 with a crosslinked surface layer containing an insufficient network structure and the photoconductor of comparison 12 in which no crosslinked surface layer was provided had a bad surface smoothness after the durability test.

The durability test for the electrophotographic photoconductors of examples 1-9 and comparisons 1-10 were carried out and the results of the test are shown in Tables 4-1 and 4-2 and Tables 5-1 and 5-2.

TABLE 4-1

Initial surface electric potential
(−V)

| | | Light-exposed |
|---|---|---|
| | Dark portion | portion |
| Example 1 | 700 | 70 |
| Example 2 | 700 | 80 |
| Example 3 | 700 | 80 |
| Example 4 | 700 | 75 |
| Example 5 | 700 | 70 |
| Example 6 | 700 | 70 |
| Example 7 | 700 | 60 |
| Example 8 | 700 | 80 |
| Example 9 | 700 | 90 |
| Comparison 1 | 700 | 350 |
| Comparison 2 | 700 | 135 |
| Comparison 3 | 700 | 140 |
| Comparison 4 | 700 | 160 |
| Comparison 5 | 700 | 85 |
| Comparison 6 | 700 | 85 |
| Comparison 7 | 700 | 160 |
| Comparison 8 | 700 | 70 |
| Comparison 9 | 700 | 50 |
| Comparison 10 | 700 | 190 |
| Comparison 11 | 700 | 90 |
| Comparison 12 | 700 | 40 |

TABLE 4-2

| | |
|---|---|
| | Surface electric |
| | potential at the end |
| Number of | of continuous |
| printings at | printings (−V) |

| | the end of | | Light- |
|---|---|---|---|
| | continuous | Dark | exposed |
| | printings | portion | portion |
| Example 1 | 30,000 | 670 | 70 |
| Example 2 | 30,000 | 690 | 100 |
| Example 3 | 30,000 | 690 | 110 |
| Example 4 | 30,000 | 700 | 100 |
| Example 5 | 30,000 | 685 | 95 |
| Example 6 | 30,000 | 670 | 90 |
| Example 7 | 30,000 | 675 | 70 |
| Example 8 | 30,000 | 670 | 80 |
| Example 9 | 30,000 | 685 | 120 |
| Comparison 1 | Initially | — | — |
| | stopped | | |
| Comparison 2 | 10,000 | 715 | 280 |
| Comparison 3 | 5,000 | 720 | 330 |
| Comparison 4 | 5,000 | 720 | 360 |
| Comparison 5 | 30,000 | 690 | 100 |
| Comparison 6 | 30,000 | 700 | 110 |
| Comparison 7 | 30,000 | 680 | 185 |
| Comparison 8 | 30,000 | 700 | 95 |
| Comparison 9 | 5,000 | 660 | 60 |
| Comparison 10 | 10,000 | 715 | 300 |
| Comparison 11 | 20,000 | 705 | 130 |
| Comparison 12 | 30,000 | 720 | 50 |

The photoconductors of examples 1-9 according to the present invention exhibited a low electric potential at light-exposed portion initially or before or after the durability test with respect to 30,000 printings and had good electric characteristics. On the contrary, the photoconductors of comparisons 1-4 in which a photo-polymerization initiator with a long absorption wavelength except an acylphosphine oxide compound was used for the crosslinked surface layer, the photoconductor of comparisons 7 having a crosslinked surface layer, for which the content of a photo-polymerization initiator increased and light irradiation energy was higher, and the photocoductor of comparison 10 in which only a radical-polymerization monomer having no charge transporting structure was used for the crosslinked surface layer, each indicated the degradation of electric property significantly.

TABLE 5-1

| | Number of | |
|---|---|---|
| | printings at the | Decrement of |
| | end of continuous | film thickness |
| | printings (papers) | (μm) |
| Example 1 | 30,000 | 1.1 |
| Example 2 | 30,000 | 1.2 |
| Example 3 | 30,000 | 1.4 |
| Example 4 | 30,000 | 1.4 |
| Example 5 | 30,000 | 1.2 |
| Example 6 | 30,000 | 1.1 |
| Example 7 | 30,000 | 1.0 |
| Example 8 | 30,000 | 1.2 |
| Example 9 | 30,000 | 1.7 |
| Comparison 1 | Initially stopped | — |
| Comparison 2 | 10,000 | 1.0 |
| Comparison 3 | 5,000 | 0.6 |
| Comparison 4 | 5,000 | 0.7 |
| Comparison 5 | 30,000 | 4.2 |
| Comparison 6 | 30,000 | 4.6 |
| Comparison 7 | 30,000 | 0.8 |
| Comparison 8 | 30,000 | 5.1 |
| Comparison 9 | 5,000 | 3.6 |
| Comparison 10 | 10,000 | 0.2 |
| Comparison 11 | 20,000 | 3.4 |
| Comparison 12 | 30,000 | 3.8 |

TABLE 5-2

| | Result of image evaluation |
|---|---|
| Example 1 | Good |
| Example 2 | Good |
| Example 3 | Good |
| Example 4 | Good |
| Example 5 | Good |
| Example 6 | Good |
| Example 7 | Good |
| Example 8 | Good |
| Example 9 | Good |
| Comparison 1 | Image density was initially very low |
| | and test was stopped. |
| Comparison 2 | Image density significantly decreased |
| | at 10,000 printings and test was |
| | stopped. |
| Comparison 3 | Image density significantly decreased |
| | at 5,000 printings and test was |
| | stopped. |
| Comparison 4 | Image density significantly decreased |
| | at 5,000 printings and test was |
| | stopped. |
| Comparison 5 | Stripe-like contamination occurred |
| | partially from 15,000 printings and |
| | background contamination occurred |
| | slightly from 20,000 printings. |
| Comparison 6 | Stripe-like contamination occurred |
| | partially from 15,000 printings and |
| | background contamination occurred |
| | slightly from 20,000 printings. |
| Comparison 7 | Image density was slightly low from |
| | an initial printing to 30,000 |
| | printings. |
| Comparison 8 | Stripe-like contamination occurred |
| | partially from 10,000 printings and |
| | background contamination occurred |
| | slightly from 20,000 printings. |
| Comparison 9 | Stripe-like contamination occurred |
| | significantly at 5,000 printings and |
| | test was stopped. |
| Comparison 10 | Image density significantly decreased |
| | at 10,000 printings and test was |
| | stopped. |
| Comparison 11 | Stripe-like contamination occurred |
| | from an initial printing, Stripe-like |
| | contamination was significant at |
| | 20,000 printings, and test was |
| | stopped. |
| Comparison 12 | Background contamination occurred |
| | slightly at 30,000 printings. |

In the durability test with respect to 30,000 printings for the photoconductors of examples 1-9 according to the present invention, the decrements of film thickness were small and good images were obtained. On the contrary, the photoconductors of comparisons 1-4 in which a photo-polymerization initiator with a long absorption wavelength except an acylphosphine oxide compound was used for the crosslinked surface layer, and the photocoductor of comparison 10 in which only a radical-polymerization monomer having no charge transporting structure was used for the crosslinked surface layer, each exhibited significant degradation of image density, and the durability test was stopped initially or in process of the printings. Also, the photoconductor of comparisons 7 having a crosslinked surface layer, for which the content of a photo-polymerization initiator increased and light irradiation energy was higher, initially exhibited the degradation of image density. The photoconductors of comparisons 5 and 6 in which a general initiator with a short absorption wavelength was used for the crosslinked surface layer, the photoconductor of comparison 8 in which a two-functional monomer was used for the crosslinked surface layer, the photoconductor of comparison 9 in which only a charge transportation compound having a radical-polymerizable functional group was used for the crosslinked surface layer, and the photoconductor of comparison 11 in which a low-molecular-weight charge transportation material was used for the crosslinked surface layer, had an ununiform and insufficient three-dimensional network structure of the crosslinked surface layer, exhibited high abrasion loss and the increase of surface irregularities, which were caused by abrasion, and caused background contamination and/or strip-like contamination. The photoconductor of comparison 12 in which no crosslinked surface layer was provided exhibited high abrasion loss and the generation of background contamination and had lower durability compared to the photoconductor having a crosslinked surface layer according to the present invention.

Accordingly, it was demonstrated that a photoconductor having more excellent surface smoothness, lower electric potential at a light-exposed portion, higher durability, and longer operating life could be provided by employing a crosslinked layer which was obtained by curing at least a three or more-functional radical-polymerizable monomer having no charge transporting structure and a charge transportation compound having a radical-polymerizable functional group by using an acylphosphine oxide compound as a photo-polymerization initiator under light energy irradiation. Also, it was demonstrated that an image formation method, an image formation apparatus, and a process cartridge for image formation apparatus, in which a photoconductor according to the present invention was used, had higher performance and higher reliability.

Further, the present invention is not limited to the embodiment, but various variations and modifications may be made without departing from the scope of the present invention.

The present application is based on Japanese priority applications No. 2004-080851 filed on Mar. 19, 2004, the entire contents of which are hereby incorporated by reference.

1. An electrophotographic photoconductor having at least a photoconductive layer on an electrically conductive support; wherein a surface layer of the photoconductive layer is a crosslinked layer obtainable by curing at least a three or more-functional radical-polymerizable monomer having no charge transporting structure and a charge transportation compound having a radical-polymerizable functional group by using an acylphosphine oxide compound as a photo-polymerization initiator under light energy irradiation.

2. The electrophotographic photoconductor as claimed in claim 1, wherein a number of the radical-polymerizable functional group(s) of the charge transportation compound used for the surface layer is one.

3. The electrophotographic photoconductor as claimed in claim 1, wherein each of the radical-polymerizable functional group(s) of the charge transportation compound used for the surface layer is an acryloyloxy group or a methacryloyloxy group.

4. The electrophotographic photoconductor as claimed in claim 1, wherein functional groups of the three or more-functional radical-polymerizable monomer having no charge transporting structure used for the surface layer are an acryloyloxy group(s) and/or a methacryloyloxy group(s).

5. The electrophotographic photoconductor as claimed in claim 1, wherein a ratio of a molecular weight to a functional group number (molecular weight/functional group number) for the three or more-functional radical-polymerizable monomer having no charge transporting structure used for the surface layer is equal to or less than 250.

6. The electrophotographic photoconductor as claimed in claim 1, wherein a charge transporting structure of the charge transportation compound having a radical-polymerizable functional group used for the surface layer is a triarylamine structure.

7. The electrophotographic photoconductor as claimed in claim 1, wherein the charge transportation compound(s) having a radical-polymerizable functional group used for the surface layer is/are at least one of compounds represented by general formula (1) 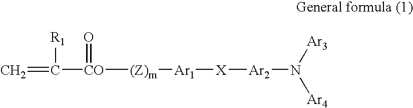
and general formula (2) 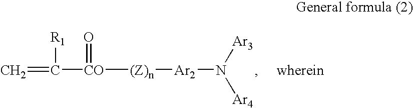
R₁ is a hydrogen atom, a halogen atom, an alkyl group which may have a substituent, an aralkyl group which may have a substituent, an aryl group which may have a substituent, a cyano group, a nitro group, an alkoxy group, —COOR₇, a carbonyl halide group, or CONR₈R₉,
R₇ is a hydrogen atom, an alkyl group which may have a substituent, an aralkyl group which may have a substituent, or an aryl group which may have a substituent,
each of R₈ and R₉ is a hydrogen atom, a halogen atom, an alkyl group which may have a substituent, an aralkyl group which may have a substituent, or an aryl group which may have a substituent, which may be identical to or different from each other,
each of Ar₁ and Ar₂ is a substituted or non-substituted arylene group, which may be identical to or different from each other,
each of Ar₃ and Ar₄ is a substituted or non-substituted aryl group, which may be identical to or different from each other,
X is a single bond, a substituted or non-substituted alkylene group, a substituted or non-substituted cycloalkylene group, a substituted or non-substituted alkylene ether group, an oxygen atom, a sulfur atom, or a vinylene group,
Z is a substituted or non-substituted alkylene group, a substituted or non-substituted alkylene ether group, or an alkyleneoxycarbonyl group, and
each of m and n is an integer of 0 through 3.

8. The electrophotographic photoconductor as claimed in claim 1, wherein the charge transportation compound(s) having a radical-polymerizable functional group used for the surface layer is/are at least one of compounds represented by general formula (3) 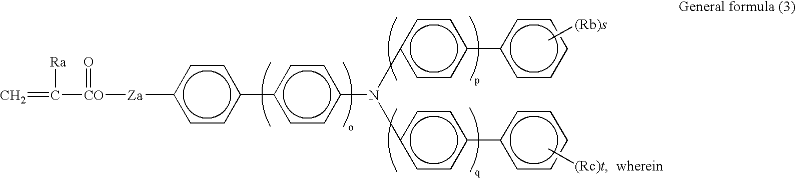
each of o, p, and q is an integer of 0 or 1,
Ra is a hydrogen atom or a methyl group,
each of Rb and Rc is a alkyl group in which the number of carbons is 1 through 6, where if the number of Rb or Rc is a plural number, the plural Rbs or Rcs may be different from each other,
each of s and t is an integer of 0 through 3, and
Za is a single bond, a methylene group, an ethylene group,

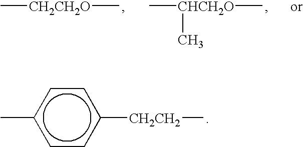

9. The electrophotographic photoconductor as claimed in claim 1, wherein the acylphosphine oxide compound used for the surface layer is a compound represented by the following formula (P-1)

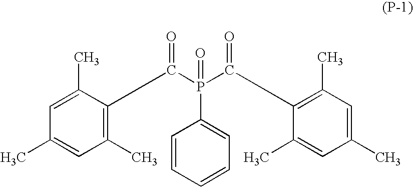

10. The electrophotographic photoconductor as claimed in claim 1, wherein the acylphosphine oxide compound used for the surface layer is a compound represented by the following formula (P-2)

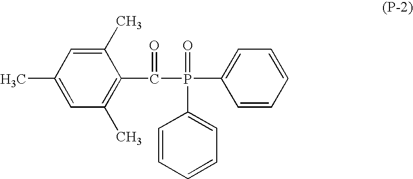

11. The electrophotographic photoconductor as claimed in claim 1, wherein the acylphosphine oxide compound used for the surface layer is a compound represented by the following formula (P-3)

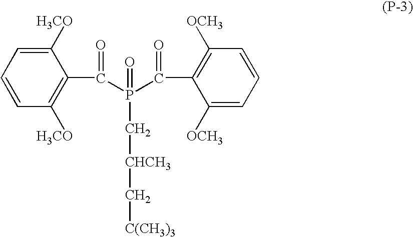

12. The electrophotographic photoconductor as claimed in claim 1, wherein the photoconductive layer has a structure such that a charge generation layer, a charge transportation layer, and the charge transporting crosslinked surface layer are stacked in order from the side of an electrically conductive support.

13. An image formation method, wherein at least charging, image exposure, developing, and transcription are repeated using the electrophotographic photoconductor as claimed in claim 1.

14. An image formation apparatus comprising the electrophotographic photoconductor as claimed in claim 1.

15. A process cartridge for image formation apparatus attachable to and detachable from a body of an image formation apparatus, comprising the electrophotographic photoconductor as claimed in claim 1 and at least one device selected from the group consisting of a charging device, a development device, a transcription device, a cleaning device and a charge elimination device.
